(19) United States
(12) Patent Application Publication
(10) Pub. No.: US 2016/0012397 A1
(43) Pub. Date: Jan. 14, 2016

(54) CONTROL METHOD, INFORMATION PROVISION METHOD, AND COMPUTER-READABLE RECORDING MEDIUM

(71) Applicant: PANASONIC INTELLECTUAL PROPERTY CORPORATION OF AMERICA, Torrance, CA (US)

(72) Inventor: Takamitsu SASAKI, Kanagawa (JP)

(73) Assignee: PANASONIC INTELLECTUAL PROPERTY CORPORATION OF AMERICA, Torrance, CA (US)

(21) Appl. No.: 14/860,982

(22) Filed: Sep. 22, 2015

Related U.S. Application Data
(63) Continuation of application No. PCT/JP2014/002350, filed on Apr. 25, 2014.
(60) Provisional application No. 61/931,121, filed on Jan. 24, 2014.

(51) Int. Cl. G06Q 10/00; G06Q 10/10

(52) U.S. Cl. CPC G06Q 10/20; G06Q 10/1095

(57) ABSTRACT

A method is disclosed for a communication device connectable to an information management system that makes a visit appointment with a service person. The communication device stores schedule information of a user of the communication device. The method causes a computer of the communication device to: display data which is generated using the schedule information and which includes a calendar; access the information management system to acquire candidate data indicating possible visit dates/times of the service person; determine candidate visit dates/times of the service person by excluding dates on which plans of the user are included in the schedule information, from the possible visit dates/times of the service person; display each display representing each of candidate visit times/times within each region corresponding to each day in the calendar; and display an appointment screen which sets one candidate visit date/time as a visit date/time of the service person.

The present disclosure relates to a control method of a communication device used, for example, in an information management system that performs a process of making an appointment with a service person who performs maintenance, inspections, or the like of electric appliances, and an information provision method in the information management system that performs the process of making an appointment with a service person.

Conventional examples of a system that performs a process of making an appointment related to maintenance, inspections, or the like of electric appliances include a technique disclosed in Patent Literature 1. Patent Literature 1 relates to a repair request system using a computer system.

When a repair requester (user) instructs a repair request using a terminal of the repair requester, a screen for making a repair request is displayed on the terminal. According to instructions on the screen, the repair requester inputs a serial number of a product as well as answers to questions corresponding to the serial number of the product. In response to the answers, the repair request system causes a repair period and an estimate of costs to be displayed on the terminal. The repair requester inputs personal information such as a name and an address of the repair requester to the terminal. In addition, the repair requester inputs a desirable pick-up date and a time slot for a repair article. Subsequently, the repair requester confirms the input information and makes a repair request using the terminal (for example, refer to Patent Literature 1).

However, the conventional art described above requires further improvements.

### CITATION LIST

### Patent Literature

Patent Literature 1: Japanese Unexamined Patent Publication No. 2002-352022

### SUMMARY OF INVENTION

In one general aspect, the technique disclosed here futures a method for a communication device connectable to an information management system that makes a visit appointment with a service person. The communication device stores schedule information of a user of the communication device. The method causes a computer of the communication device to: display data which is generated using the schedule information and which includes a calendar; access the information management system to acquire candidate data indicating possible visit dates/times of the service person; determine candidate visit dates/times of the service person by excluding dates/times on which plans of the user are included in the schedule information, from the acquired possible visit dates/times of the service person; display each display representing each of the candidate visit dates/times within each region corresponding to each day in the calendar; and display an appointment screen which sets one candidate visit date/time as a visit date/time of the service person.

Accordingly, further improvements can be achieved. These general and specific aspects may be implemented using a system, a method, and a computer program, and any combination of systems, methods, and computer programs.

### BRIEF DESCRIPTION OF DRAWINGS

FIG. 1 is a diagram showing a first example of an overall configuration of an appointment system according to the present disclosure.

FIG. 2 is a diagram showing a second example of an overall configuration of an appointment system according to the present disclosure.

FIG. 3 is a diagram showing a third example of an overall configuration of an appointment system according to the present disclosure.

FIG. 4 is a diagram showing a fourth example of an overall configuration of an appointment system according to the present disclosure.

FIG. 5 is a block diagram showing a configuration pattern of an appointment system according to a first example.

FIG. 6 is a block diagram showing a configuration pattern of the appointment system according to the first example.

FIG. 7 is a block diagram showing a configuration pattern of the appointment system according to the first example.

FIG. 8 is a block diagram showing a configuration pattern of the appointment system according to the first example.

FIG. 9 is a block diagram showing a configuration pattern of an appointment system according to a second example.

FIG. 10 is a block diagram showing a configuration pattern of an appointment system according to a third example.

FIG. 11 is a block diagram showing a configuration pattern of the appointment system according to the third example.

FIG. 12 is a block diagram showing a configuration pattern of an appointment system according to a fourth example.

FIG. 13 is a diagram showing an example of a basic screen.

FIG. 14 is a diagram showing an example of an appointment guide notification screen.

FIG. 15 is a diagram showing an example of a symptom confirmation screen.

FIG. 16 is a diagram showing a first example of an inspection date selection screen.

FIG. 17 is a diagram showing a second example of an inspection date selection screen.

FIG. 18 is a diagram showing an example of an inspection date selection screen for a month following the inspection date selection screen shown in FIG. 17.

FIG. 19 is a diagram showing a third example of an inspection date selection screen.

FIG. 20 is a diagram showing a fourth example of an inspection date selection screen.

FIG. 21 is a diagram showing an example of an inspection time selection screen.

FIG. 22 is a diagram showing an inspection time selection screen in a state where a candidate appointment time is selected.

FIG. 23 is a diagram showing an example of an appointment content confirmation screen.

FIG. 24 is a diagram showing a first example of an inspection appointment completion screen.

FIG. 25 is a diagram showing a second example of an inspection appointment completion screen.

FIG. 26 is a diagram showing an example of an inspection detail confirmation screen.

FIG. 27 is a diagram showing an example of a symptom selection screen.

FIG. 28 is a diagram showing a symptom selection screen on which a pull down menu is displayed.

FIG. 29 is a diagram showing an example of an inspection estimation screen.

FIG. 30 is a diagram showing an example of a top screen.

FIG. 31 is a diagram showing an example of a symptom selection screen of a refrigerator.

FIG. 32 is a diagram showing a symptom selection screen of a refrigerator on which a pull down menu is displayed.

FIG. 33 is a diagram showing an example of an inspection estimation screen of a refrigerator.

FIG. 34 is a diagram showing a screen flow according to the present disclosure.

FIG. 35 is a diagram showing an example of a data configuration of a device state.

FIG. 36 is a diagram showing an example of a data configuration of an analysis result of a state of a device.

FIG. 37 is a diagram showing an example of a data configuration of a device list table that is managed by an appointment terminal.

FIG. 38 is a diagram showing an example of a data configuration of a device list table that is managed by a device management server.

FIG. 39 is a diagram showing an example of a data configuration of a symptom table.

FIG. 40 is a diagram showing an example of a data configuration of a calendar plan list.

FIG. 41 is a diagram showing an example of a data configuration of an appointment available date list.

FIG. 42 is a diagram showing an example of a data configuration of a candidate appointment date list.

FIG. 43 is a sequence diagram showing a first example of an automatic startup process of an appointment application.

FIG. 44 is a sequence diagram showing a second example of an automatic startup process of an appointment application.

FIG. 45 is a sequence diagram showing a startup process of an appointment application when the appointment application is an embedded application.

FIG. 46 is a sequence diagram showing a startup process of an appointment application when the appointment application is an HTML application.

FIG. 47 is a sequence diagram of an overall process sequence of a first example of an appointment system according to the present disclosure.

FIG. 48 is a sequence diagram of an overall process sequence of a second example of an appointment system according to the present disclosure.

FIG. 49 is a sequence diagram of an overall process sequence of a third example of an appointment system according to the present disclosure.

FIG. 50 is a sequence diagram of an overall process sequence of a fourth example of an appointment system according to the present disclosure.

FIG. 51 is a sequence diagram of an overall process sequence of a fifth example of an appointment system according to the present disclosure.

FIG. 52 is a sequence diagram of an overall process sequence of a sixth example of an appointment system according to the present disclosure.

FIG. 53 is a sequence diagram showing a startup process of a calendar application when the calendar application is an embedded application.

FIG. 54 is a sequence diagram showing a startup process of a calendar application when the calendar application is an HTML application.

FIG. 55 is a flow chart showing a first example of an automatic startup process of an appointment application.

FIG. 56 is a flow chart showing a second example of an automatic startup process of an appointment application.

FIG. 57 is a flow chart showing an example of an overall process of an appointment application.

FIG. 58 is a flow chart showing details of a display process of a top screen (S5707 in FIG. 57, S5910 in FIG. 59, and S6409 in FIG. 64).

FIG. 59 is a flow chart showing an example of a display process of a symptom confirmation screen (S5702 in FIG. 57, S5812 in FIGS. 58, and S6307 in FIG. 63).

FIG. 60 is a flow chart showing a first example of a display process of an inspection date selection screen (S5703 in FIG. 57 and S5908 in FIG. 59).

FIG. 61 is a flow chart showing a second example of a display process of an inspection date selection screen (S5703 in FIG. 57 and S5908 in FIG. 59).

FIG. 62 is a flow chart showing a third example of a display process of an inspection date selection screen (S5703 in FIG. 57 and S5908 in FIG. 59).

FIG. 63 is a flow chart representing a continuation of FIGS. 60 to 62.

FIG. 64 is a flow chart showing a display process of an inspection appointment completion screen (S5706 in FIG. 57).

FIG. 65 is a flow chart showing a process of a first example of an appointment server.

FIG. 66 is a flow chart showing a process of a second example of an appointment server.

FIG. 67 is a flow chart showing a process of a third example of an appointment server.

FIG. 68 is a flow chart showing an example of a process of calculating a fee for each appointment available date/time in S6503.

FIG. 69 is a flow chart showing a first example of an extraction process of a candidate appointment date by an appointment server or an appointment terminal.

FIG. 70 is a flow chart showing a second example of an extraction process of a candidate appointment date by an appointment server or an appointment terminal.

FIG. 71 is a flow chart showing a third example of an extraction process of a candidate appointment date by an appointment server or an appointment terminal.

FIG. 72 is a flow chart showing a fourth example of an extraction process of a candidate appointment date by an appointment server or an appointment terminal.

FIG. 73 is a flow chart showing a fifth example of an extraction process of a candidate appointment date by an appointment server or an appointment terminal.

### DESCRIPTION OF EMBODIMENTS

### Circumstances Leading to the Invention of an Aspect of the Present Disclosure

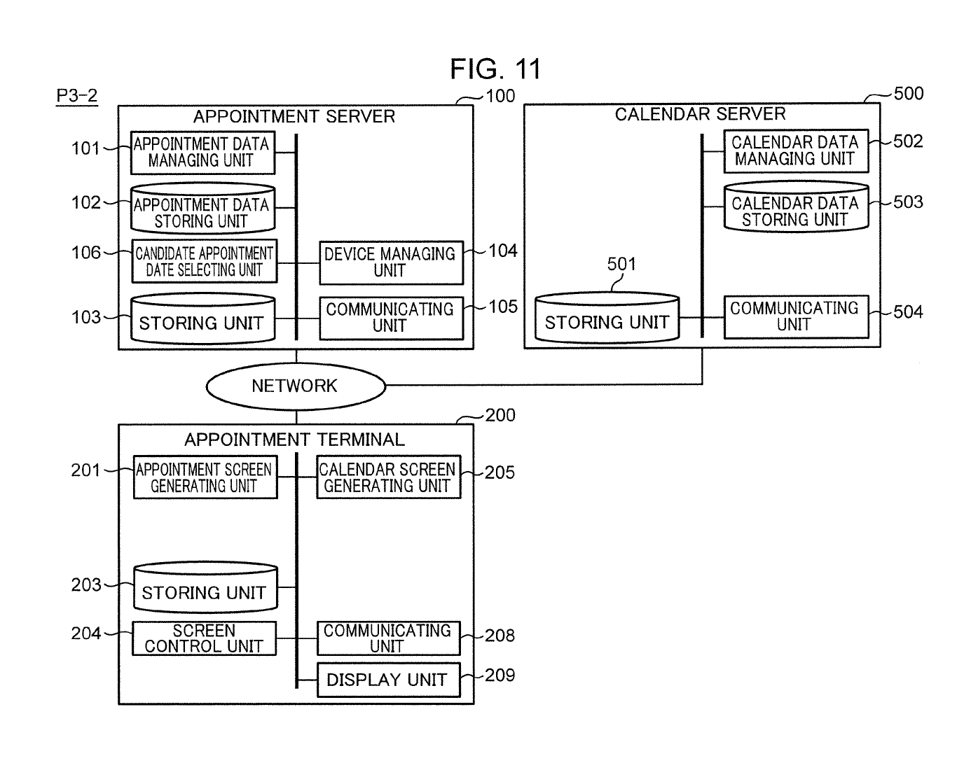

In the repair request system disclosed in Patent Literature 1 described earlier, on a screen (FIG. 11 in Patent Literature 1) for selecting a desired pick-up date and time slot for a repair article, even if a repair requester (user) inputs a desired date and time slot, there may be cases where the repair article cannot be picked up at the input time slot due to circumstances of a transport section of a manufacturer who is to perform the repair. In this case, according to Patent Literature 1 described earlier, information to the effect that the repair article cannot be picked up as desired is displayed and the repair requester is asked to once again input an alternative date and time slot (paragraph [0039] in Patent Literature 1). Therefore, with the technique disclosed in Patent Literature 1, there is a hassle of repeating similar processes until a schedule of the repair requester meets a schedule of a transportation company of the manufacturer who is to perform the repair. However, techniques for efficiently matching the schedule of the repair requester with the schedule of the transportation company of the manufacturer who is to perform the repair are not disclosed in Patent Literature 1 described earlier.

Meanwhile, service operators recently provide a communication device of a user with a calendar function via a network. However, a process of making an appointment with a service person by the repair request system described above is not linked with calendar data that is handled by the calendar function.

Therefore, when the user is already using the calendar function to manage the user's schedule, for example, in order to confirm whether a date and a time slot to be input do not overlap with other schedules of the user, the user must cause calendar data that is handled by the calendar function to be displayed on the communication device of the user separately from a display screen of the repair request system and, subsequently, input a desired pick-up date and time slot for the repair article while confirming the schedules of the user. As a result, since convenience of the calendar data that is handled by the calendar function cannot be utilized and, contrarily, the process of making a repair request becomes complicated, there is a risk that the user may make an erroneous input and may register an incorrect repair request.

In addition, for example even on a same day on which the user has a plan to go out, there may be cases where some time slots do not overlap with the user's plan to go out and enable the user to make a repair request. However, since confirmation of a time slot for which a repair request can be made is performed by separately viewing the display screen of the repair request system and the calendar data that is handled by the calendar function, operations involving comparing and confirming both the display screen and the calendar data occur repetitively and may cause processing efficiency of a repair request to decline. Therefore, even when there is a date/time for which the user can make a request, the user may overlook the date/time. As a result, due to the process of making a repair request being more complicated, even when there is a date/time for which the user can make a request, the user may be unable to register a repair process for the date/time or the user may make an input error and end up registering an erroneous repair request.

In order to solve the problems listed above, the present inventors arrived at an invention represented by the respective aspects described below.

(1) A method for controlling a communication device which includes a display and which is connectable to an information management system that makes, via a network, a visit appointment with a service person who performs maintenance or an inspection of an electric appliance,

the communication device storing manages schedule information of a user of the communication device,

the method causing a computer of the communication device to:

display display data which is generated using the stored schedule information and which includes a calendar representing each day on a per month or per week basis on the display;

access the information management system via the network to acquire candidate data indicating possible visit dates/times of the service person from the information management system, for a visit appointment with the service person;

determine candidate visit dates/times of the service person by excluding dates/times on which plans of the user included in the schedule information, from the acquired possible visit dates/times of the service person wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;

display each display representing each of the determined candidate visit times within each region corresponding to each day in the calendar; and

when selection of one region which corresponds to one candidate visit time is detected in the calendar, display on the display an appointment screen which sets one candidate visit date/time as a visit date/time of the service person.

According to the present aspect, the calendar is displayed on a display of a communication device of the user. Using the calendar which is a shared medium, the user's plans are confirmed and candidate visit dates/times of the service person are displayed on the communication device at the same time. Accordingly, since the calendar which is a shared medium is used as described above, the candidate visit dates/times of the service person can be presented to the user on a same screen which displays the plans of the user. Therefore, for example, when a day after returning from a trip is one of the candidate visit dates/times, since fatigue from the trip may still remain, a determination such as selecting another candidate visit date/time that is not the day following the return from the trip can be readily made. In addition, for example, by referring to the candidate visit time and another plan of the user before or after the candidate visit time on a same day, determinations such as whether the user's home can be reached by the candidate visit time on the same day may be readily made while considering a location where the other plan is to take place or considering a travel time for returning to the user's home from the location of the other plan. As a result, both the plans of the user and the plans of the service person can be confirmed at the same time and the process of making an appointment for a visit by the service person can be smoothly performed.

In addition, according to the present aspect, the user can use the calendar to cause an appointment screen for making an appointment for a visit date/time of the service person to be displayed. In other words, the calendar doubles as an instruction screen for causing an appointment screen of the service person to be displayed. Therefore, since the user can avoid the hassle of separately starting up and displaying the calendar and the appointment screen and collating the separately displayed calendar and appointment screen with each other, efficiency of the process of making an appointment with the service person can be improved.

Furthermore, according to the present aspect, candidate visit dates/times of the service person are displayed in each region corresponding to each day that is represented in the calendar after excluding dates/times on which plans of the user are registered. Accordingly, since dates/times on which the user plans to go out have already been excluded from the candidate visit dates/times of the service person at a stage where the candidate visit dates/times of the service person are displayed in the calendar, the candidate visit dates/times that are likely to be selected by the user can be presented in an efficient manner. As a result, since the hassle of the user of having to exclude dates/times on which the user is unavailable and the like from the candidate visit dates/times due to the inclusion of such dates/times on which the user is unavailable and the like in the candidate visit dates/times can be avoided and the hassle of the user of having to change the user's plans to make room for the candidate visit dates/times can be avoided, the process of making an appointment for a visit by the service person can be performed in a smooth manner.

In addition, according to the present aspect, the calendar includes not only a display representing a visit date of the service person but also a display representing a visit date/time of the service person. Accordingly, the calendar enables not only a visit date of the service person but also a time slot to be specified by one selection instruction. Therefore, since the number of operations by the user can be reduced and a step for separately displaying a screen that enables the user to specify a time slot can be omitted, efficiency of a process of making an appointment can be improved.

(2) In addition, in the aspect described above, the method may further cause the computer of the communication device to transmit an appointment request indicating the one candidate visit date/time to the information management system via the network based on the appointment screen, to register the one candidate visit date/time as the visit date/time of the service person in the information management system.

Accordingly, a process of registering a visit date/time of the service person in the information management system is completed.

(3) Furthermore, in the aspect described above, the method may further cause the computer of the communication device to display in the calendar the visit date/time of the service person for which the registration in the information management system has been completed.

For example, when an operation for registering a visit date/time of the service person in the calendar occurs separately after performing a process of making an appointment with the service person, since a registration operation in the calendar is to be performed separately from the process of making an appointment with the service person, the processes become a hassle. If the user forgets to register a visit date/time of the service person in the calendar, the user may misunderstand that the service person has made a sudden visit without an appointment on a date/time that is not registered in the calendar even though an appointment with the service person had actually been made.

According to the present aspect, the method causes the computer of the communication device to display a visit date/time of the service person for which registration in the information management system has been completed in the calendar. Accordingly, the calendar is to include the visit date/time of the service person. As a result, a situation can be avoided where, after performing a process of making an appointment for a visit by the service person, the user misunderstands that the service person has made a sudden visit without an appointment because the user forgot to register the visit date/time of the service person in the calendar.

(4) In addition, in the aspect described above, the method may further cause the computer of the communication device to display on the display information indicating that the registration has been completed, in association with the display of the calendar.

According to the present aspect, the fact that the registration has been completed is displayed on the display in association with the display of the calendar. Accordingly, the user can be effectively reminded using existing display resources as to for what purpose an appointment had been made and when the appointment was made.

(5) Furthermore, in the aspect described above, the information management system may collect and manage log information of the electric appliance associated with the user of the communication device via the network, and

when the information management system determines that the maintenance or the inspection is required for the electric appliance based on the log information, the computer of the communication device is caused to receive a notice indicating that the maintenance or the inspection is required for the electric appliance from the information management system via the network.

According to the present aspect, when it is determined based on the log information that any of the electric appliances requires maintenance or an inspection, a notification to that effect is arranged to be received from the information management system via the network. Accordingly, even when the user is unaware of the fact that the electric appliance is in a state of requiring maintenance or an inspection, candidate visit dates/times of a service person who is to perform maintenance or an inspection of the electric appliance can be presented based on the log information. Therefore, for example, since maintenance or an inspection of the electric appliance can be performed in a stage prior to the electric appliance breaking down or the like, the user can continuously use the electric appliance at a stable quality.

(6) In addition, in the aspect described above, the information management system may collect and manage log information of the electric appliance associated with the user of the communication device via the network, and

in a case which the information management system receives an inquiry signal for the visit appointment with the service person from the communication device, the computer of the communication device is caused to receive, from the information management system via the network, state information which indicates whether or not the maintenance or the inspection is required for the electric appliance based on the log information, and to display the state information on the display.

According to the present aspect, when the information management system receives a notice of an intention to make a visit appointment with the service person from the communication device, the communication device receives state information which indicates whether or not each of the electric appliances requires maintenance or an inspection from the information management system via the network and displays display data including the state information on the display. Accordingly, by issuing an instruction for making a visit appointment with the service person on the communication device, the user of the communication device can confirm state information indicating whether or not each of the electric appliances requires maintenance or an inspection on the display of the communication device. Since the state information is generated by the information management system based on the log information, a state of each of the electric appliances which is accurate at that time point can be obtained. Therefore, when the user makes a determination that maintenance or an inspection by a service person is required by confirming the state information, the user can proceed to a process of making an appointment with the service person. As a result, since the user can determine whether an electric appliance for which the user is considering requesting a service person to perform maintenance or an inspection has really broken down or not before a process of making a visit appointment with the service person, unnecessary processes of making an appointment can be reduced. In other words, a situation where an appointment with the service person is made inadvertently can be prevented based on accurate information.

(7) Furthermore, in the aspect described above, when, using the display data including the calendar that represents each day of a concerned month, displaying each display representing each of the candidate visit times of the service person within each corresponding region in the calendar, and

when the display representing the candidate visit times are included in respective displays of the concerned month and a following month,

the computer of the communication device is caused to display information indicating that the display representing the candidate visit times is displayed in a region corresponding to any of the days included in the display of the following month, in the display data that includes calendar representing each day of the concerned month.

For example, when today is the end of a month, a display representing the candidate visit times may sometimes be included not only in the concerned month but also in a following month. In such a case, when a display representing the candidate visit times is to be selected in a region corresponding to any of days included in the concerned month that is presently displayed, for example, the user is to be asked to select a visit date/time in a constrained manner with respect to plans of the user from a range that is narrower than an original range of candidate visit dates/times. In addition, for example, when a display representing candidate visit times is not provided in a region corresponding to days included in the display of the concerned month and a display representing candidate visit times is hidden in a region corresponding to days included in a display of the following month, the user may overlook the hidden display and may fail to set a visit date/time.

According to the present aspect, information to the effect that a display representing the candidate visit times is to be provided in a region corresponding to any of days included in the display of the following month is displayed in display data including calendar representing each day of the concerned month. Accordingly, for example, when a display representing the candidate visit times is included not only in the display of the concerned month but also in the display of the following month, original candidate visit dates/times are to be presented to the user. Therefore, for example, a situation can be avoided where the user is asked to select a visit date/time in a constrained manner from a range that is narrower than an original range of candidate visit dates/times or a situation can be avoided where the user fails to notice that a display representing candidate visit times is not included in a display of the concerned month but a display representing candidate visit times is included in a display of the following month. As a result, a visit date/time that is suitable for the user with respect to plans of the user can be selected from an original range of candidate visit dates/times without omitting original candidate visit dates/times.

(8) In addition, in the aspect described above, when, using the display data including the calendar that represents each day of a concerned week, displaying each display representing each of the candidate visit times of the service person within each corresponding region in the calendar, and

when the display representing the candidate visit times are included in respective displays of the concerned week and a following week,

the computer of the communication device is caused to display information indicating that the display representing the candidate visit times is displayed in a region corresponding to any of the days included in the display of the following week, in the display data that includes calendar representing each day of the concerned week.

For example, when today is a weekend, a display representing the candidate visit times may sometimes be included not only in the concerned week but also in a following week. In such a case, when a display representing the candidate visit times is to be selected in a region corresponding to any of days included in the concerned week that is presently displayed, for example, the user is to be asked to select a visit date/time in a constrained manner with respect to plans of the user from a range that is narrower than an original range of candidate visit dates/times. In addition, for example, when a display representing candidate visit times is not provided in a region corresponding to days included in the display of the concerned week and a display representing candidate visit times is hidden in a region corresponding to days included in a display of the following week, the user may overlook the hidden display and may fail to set a visit date/time.

According to the present aspect, information to the effect that a display representing the candidate visit times is to be provided in a region corresponding to any of days included in the display of the following week is displayed in display data including calendar representing each day of the week. Accordingly, for example, when a display representing the candidate visit times is included not only in the display of the concerned week but also included in the display of the following week, original candidate visit dates/times are to be presented to the user. Therefore, for example, a situation can be avoided where the user is asked to select a visit date/time in a constrained manner from a range that is narrower than an original range of candidate visit dates/times or a situation can be avoided where the user fails to notice that a display representing candidate visit times is not included in a display of the concerned week but a display representing candidate visit times is included in a display of the following week. As a result, a visit date/time that is suitable for the user with respect to plans of the user can be selected from an original range of candidate visit dates/times without omitting original candidate visit dates/times.

(9) Furthermore, in the aspect described above, the method may further cause the computer of the communication device to: display a first region corresponding to a first day which is represented in the calendar and which includes a plan of the user, in a first display color; and

display a second region corresponding to a second day which is represented in the calendar and which includes a display representing the candidate visit times of the service person, in a second display color that differs from the first display color.

According to the present aspect, a plan of the user and a candidate visit time of the service person are distinguished by and displayed in different display colors in the calendar. Accordingly, a plan of the user and a candidate visit time of the service person can be easily distinguished from one another. Therefore, a misoperation involving overlooking candidate visit dates/times of the service person or a misoperation involving misidentifying a display representing candidate visit times of the service person for a display of a plan of the user can be prevented. As a result, the user can be made aware of candidate visit dates/times of the service person in an appropriate manner and a misoperation involving misidentifying a display representing the candidate visit times of the service person can be prevented.

(10) In addition, in the aspect described above, the method may further cause the computer of the communication device to, when displaying each display representing each of the candidate visit times within each region corresponding to each day in the calendar, display each fee related to the maintenance or the inspection of the electric appliance within each region corresponding to each day in the calendar.

For example, fees related to maintenance or an inspection of the electric appliance may differ between a busy period and an idle period. In addition, fees related to maintenance or an inspection of the electric appliance may differ between weekdays and weekends. When there are a plurality of displays representing candidate visit times of the service person, the candidate visit dates/times may sometimes be selected based on a relationship with plans of the user. However, if fees related to maintenance or an inspection of the electric appliance are to be displayed, the candidate visit dates/times can be selected based on the fees. According to the present aspect, the user can confirm the fees before selecting a visit date/time from the candidate visit dates/times and, for example, the user can select a candidate visit date/time with a lower fee after confirming the fees.

(11) Furthermore, in the aspect described above, the method may further cause the computer of the communication device to, when all of the displays representing candidate visit times corresponding to a given day cannot not be displayed in a region corresponding to the given day, display a mark indicating one candidate visit date of the service person in the region corresponding to the given day, without displaying all of the displays representing the candidate visit times corresponding to the given day.

A region corresponding to each day represented in the calendar is limited in terms of display area. For example, there may be cases where another schedule is already registered in a region corresponding to a given day represented in the calendar. In addition, there may be cases where a plurality of candidate visit times are provided in a region corresponding to a given day represented in the calendar even when no other schedules are registered in the region corresponding to the given day. In such cases, all of the displays representing candidate visit times corresponding to the given day cannot necessarily be displayed.

According to the present aspect, when all of the displays representing candidate visit times corresponding to a given day represented in the calendar cannot not be displayed in a region corresponding to the given day, a display representing candidate visit dates of the service person is displayed in the region corresponding to the given day instead of displaying a display representing candidate visit times corresponding to the given day. Accordingly, in this case, even when the candidate visit dates/times are not displayed in the region corresponding to the given day, the fact that the given day is a candidate visit date of the service person can be notified. Therefore, a situation can be prevented where only a part of displays of candidate visit times corresponding to the given day is displayed and a process of making an appointment is performed based on a misidentification that candidate visit dates/times that are not displayed do not exist.

In such a case, an aspect may be adopted in which, for example, all of the displays representing candidate visit times corresponding to the given day are separately displayed by selecting a display representing a candidate visit date of the service person.

(12) Furthermore, in the aspect described above, each of the plans of the user may be displayed within each region corresponding to each day in the calendar.

(13) In addition, a program according to an aspect of the present disclosure is a program to be executed by a communication device which includes a display and which is connectable to an information management system that makes, via a network, a visit appointment with a service person who performs maintenance or an inspection of an electric appliance,

the communication device storing schedule information of a user of the communication device,

the program causing a computer of the communication device to:

display display data which is generated using the stored schedule information and which includes a calendar representing each day on a per month or per week basis, on the display;

access the information management system via the network to acquire candidate data indicating possible visit dates/times of the service person from the information management system, for a visit appointment with the service person;

determine candidate visit dates/times of the service person by excluding dates/times on which plans of the user are included in the schedule information, from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;

display each display representing each of the determined candidate visit times within each region corresponding to each day in the calendar; and

when selection of one region which corresponds to one candidate visit time is detected in the calendar, display on the display an appointment screen which sets one candidate visit date/time as a visit date/time of the service person.

(14) Furthermore, a method of providing information according to another aspect of the present disclosure is a method of providing information in an information management system that makes, via a network, a visit appointment with a service person who performs maintenance or an inspection of an electric appliance, the method including:

receiving, from a communication device of an authenticated user via the network, i) an inquiry signal for making an appointment for a visit by the service person and ii) schedule information of the user, the schedule information of the user being stored in the communication device;

acquiring, based on the inquiry signal, first candidate data indicating possible visit dates/times of the service person from a database that stores the possible visit dates/times of the service person;

determining candidate visit dates/times of the service person by excluding dates/times on which plans of the user are included in the schedule information, from the acquired possible visit dates/times of the service person using the acquired first candidate data and the received schedule information, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;

transmitting second candidate data indicating the determined candidate visit dates/times to the communication device via the network, to display at the communication device display each display representing each of candidate visit times indicated by the second candidate data within each region corresponding to each day in calendar; and

when selection of one region which corresponds to one candidate visit time is detected in a region corresponding to any of days in the calendar in the communication device and when an appointment request indicating a selected candidate visit date/time is received from the communication device via the network, registering the selected candidate visit date/time indicated by the appointment request in the information management system as a visit date/time of the service person.

According to the present aspect, upon receiving an inquiry signal for making an appointment for a visit by the service person and schedule information from a communication device, the information management system uses the received schedule information and first candidate data indicating possible visit dates/times of the service person to extract possible visit dates/times obtained by excluding dates/times on which plans of the user are registered as candidate visit dates/times of the service person, and transmits second candidate data indicating the extracted candidate visit dates/times to the communication device. The communication device displays calendar that represents both the candidate visit dates/times and plans of the user. In addition, when a candidate visit date/time selected by the user via the display of the calendar is transmitted from the communication device, the information management system registers the candidate visit date/time as a visit date/time of the service person.

Therefore, in the present aspect, even in a mode configured such that the communication device is responsible for managing schedule information and the information management system is responsible for performing an extraction process of candidate visit dates/times, a process of making an appointment for a visit by the service person can be facilitated and efficiency thereof can be improved as described above.

(15) In addition, in the aspect described above, the visit date/time of the service person for which registration in the information management system has been completed may be displayed within the calendar, at the communication device.

For example, when an operation for registering a visit date/time of the service person in the calendar occurs separately after performing a process of making an appointment with the service person, since a registration operation in the calendar is to be performed separately from the process of making an appointment with the service person, the processes become a hassle. If the user forgets to register a visit date/time of the service person in the calendar, the user may misunderstand that the service person has made a sudden visit without an appointment on a date/time that is not registered in the calendar even though an appointment with the service person had actually been made.

According to the present aspect, the method causes the computer of the communication device to display a visit date/time of the service person for which registration in the information management system has been completed in the calendar in the communication device. Accordingly, the calendar is to include the visit date/time of the service person. As a result, a situation can be avoided where, after performing a process of making an appointment for a visit by the service person, the user misunderstands that the service person has made a sudden visit without an appointment because the user forgot to register the visit date/time of the service person in the calendar.

(16) In addition, in the aspect described above, the information management system may collect and manage log information of the electric appliances associated with the user of the communication device via the network, and

when the information management system determines that the maintenance or the inspection is required for the electric appliance based on the log information, the information management system may transmit to the communication device via network a notice indicating that the maintenance or the inspection is required for the electric appliance.

According to the present aspect, when it is determined based on the log information that any of the electric appliances requires maintenance or an inspection, a notification to that effect is transmitted to the communication device. Accordingly, even when the user is unaware of the fact that the electric appliance is in a state of requiring maintenance or an inspection, candidate visit dates/times of a service person who is to perform maintenance or an inspection of the electric appliance can be displayed based on the log information. Therefore, for example, since maintenance or an inspection of the electric appliance can be performed in a stage prior to the electric appliance breaking down or the like, the user can continuously use the electric appliance at a stable quality.

(17) Furthermore, in the aspect described above, the information management system may collect and manage log information of the electric appliances associated with the user of the communication device via the network, and

in a case which the information management system receives an inquiry signal for making the visit appointment with the service person from the communication device, the information management system may transmit to the communication device via the network state information which indicates whether or not the maintenance or the inspection is required for the electric appliance based on the log information.

(18) Furthermore, a control method according to another aspect of the present disclosure is a method for controlling a communication device which includes a display and which is connectable to an information management system that makes, via a network, a visit appointment with a service person who performs maintenance or an inspection of an electric appliance,

the information management system managing schedule information of a user of the communication device,

the method causing a computer of the communication device to:
access the information management system via the network to acquire i) schedule information of the user of the communication device and ii) candidate data indicating possible visit dates/times of the service person from the information management system for a visit appointment with the service person;

display display data which is generated using the received schedule information and which includes calendar representing each day on a per month or per week basis, on the display;

determining candidate visit dates/times of the service person by excluding dates/times on which plans of the user are included in the schedule information from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;

display each display representing each of the candidate visit dates/times within each region corresponding to each day in the calendar; and

when selection of one region which corresponds to one candidate visit time is detected in the calendar, display on the display an appointment screen which sets one candidate visit date/time as a visit date/time of the service person.

In the present aspect, the communication device acquires schedule information of a user and candidate data indicating possible visit dates/times of a service person from the information management system. In addition, the communication device extracts candidate visit dates/times obtained by excluding dates/times on which plans of the user are registered from the possible visit dates/times of the service person as candidate visit dates/times of the service person and displays calendar indicating both the extracted candidate visit dates/times and the plans of the user. Furthermore, when one candidate visit date/time is selected by the user through the display of the calendar, the communication device displays an appointment screen which sets the selected candidate visit date/time as a visit date/time of the service person.

Therefore, even in a mode configured such that the information management system is responsible for managing schedule information and the communication device is responsible for performing an extraction process of candidate visit dates/times, a process of making an appointment for a visit by the service person can be facilitated and efficiency thereof can be improved as described above.

(19) In addition, in the aspect described above, the method may further cause the computer of the communication device to transmit an appointment request indicating the one candidate visit date/time to the information management system via the network based on the appointment screen, to register the one candidate visit date/time as the visit date/time of the service person in the information management system.

Accordingly, a process of making an appointment of a visit date/time of the service person to the information management system is completed.

(20) Furthermore, in the aspect described above, the method may further cause the computer of the communication device to display in the calendar the visit date/time of the service person for which the registration in the information management system has been completed, within the one region corresponding to the visit dates/times.

For example, when an operation for registering a visit date/time of the service person in the calendar occurs separately after performing a process of making an appointment with the service person, since a registration operation in the calendar is to be performed separately from the process of making an appointment with the service person, the processes become a hassle. If the user forgets to register a visit date/time of the service person in the calendar, the user may misunderstand that the service person has made a sudden visit without an appointment on a date/time that is not registered in the calendar even though an appointment with the service person had actually been made.

According to the present aspect, the method causes the computer of the communication device to display a visit date/time of the service person for which registration in the information management system has been completed in the calendar. Accordingly, the calendar is to include the visit date/time of the service person. As a result, a situation can be avoided where, after performing a process of making an appointment for a visit by the service person, the user misunderstands that the service person has made a sudden visit without an appointment because the user forgot to register the visit date/time of the service person in the calendar.

(21) In addition, in the aspect described above, the method may further cause the computer of the communication device to display on the display information indicating that the registration has been completed, in association with a display of the calendar.

(22) Furthermore, in the aspect described above, the information management system may collect and manage log information of the electric appliances associated with the user of the communication device via the network, and

when the information management system determines that the maintenance or the inspection is required for the electric appliance based on the log information, the computer of the communication device is caused to receive a notice indicating that the maintenance or the inspection is required for the electric appliance from the information management system via the network.

(23) In addition, in the aspect described above, the method may further cause the computer of the communication device to, when all of the displays representing candidate visit times corresponding to a given day cannot not be displayed in a region corresponding to the given day, display a mark indicating one candidate visit date of the service person in the region corresponding to the given day, without displaying all of the displays representing the candidate visit times corresponding to the given day.

(24) Furthermore, in the aspect described above, each of the plans of the user may be displayed with in each region corresponding to each day in the calendar.

(25) In addition, a program according to another aspect of the present disclosure is a program to be executed by a communication device which includes a display and which is connectable to an information management system that makes, via a network, a visit appointment with a service person who performs maintenance or an inspection of an electric appliance,

the information management system managing schedule information of a user of the communication device,

the program causing a computer of the communication device to:

access the information management system via the network to acquire i) schedule information of the user of the communication device and ii) candidate data indicating possible visit dates/times of the service person from the information management system for a visit appointment with the service person;

display display data which is generated using the received schedule information and which includes calendar representing each day on a per month or per week basis, on the display;

determining candidate visit dates/times of the service person by excluding dates/times on which plans of the user are included in the schedule information from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;

display each display representing each of the candidate visit dates/times within each region corresponding to each day in the calendar; and

when selection of one region which corresponds to one candidate visit time is detected in the calendar, display on the display an appointment screen which sets one candidate visit date/time as a visit date/time of the service person.

(26) Furthermore, a method of providing information according to yet another aspect of the present disclosure is a method of providing information in an information management system that makes, via a network, a visit appointment with a service person who performs maintenance or an inspection of an electric appliance, the method including:

receiving, from a communication device of an authenticated user via the network, an inquiry signal for making an appointment for a visit by the service person;

acquiring, based on the inquiry signal, schedule information of the user of the communication device from a first database that stores the schedule information of the user of the communication device;

acquiring, based on the inquiry signal, first candidate data indicating possible visit dates/times of the service person from a second database that stores the possible visit dates/times of the service person;

determining candidate visit dates/times of the service person by excluding dates/times on which plans of the user are included in the acquired schedule information from the acquired possible visit dates/times of the service person using the acquired schedule information and the first candidate data, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;

transmitting second candidate data indicating the determined candidate visit dates/times to the communication device via the network, to display at the communication device each display representing each of the candidate visit times indicated by the second candidate data within each region corresponding to each day in calendar; and

when selection of one region which corresponds to one candidate visit time is detected in a region corresponding to any of days included in the calendar in the communication device and an appointment request indicating a selected candidate visit date/time is received from the communication device via the network, registering the selected candidate visit date/time indicated by the appointment request in the information management system as a visit date/time of the service person.

According to the present aspect, upon receiving an inquiry signal for making an appointment for a visit by the service person from a communication device, the information management system acquires schedule information of the user from a first database that manages the schedule information of the user and acquires first candidate data indicating possible visit dates/times of the service person from a second database that manages possible visit dates/times of the service person. In addition, using the acquired schedule information and the first candidate data, the information management system extracts possible visit dates/times obtained by excluding dates/times on which plans of the user are registered as candidate visit dates of the service person and transmits second candidate data indicating the extracted candidate visit dates/times to the communication device. The communication device displays calendar that represents both the candidate visit dates/times and plans of the user. In addition, when a candidate visit date/time selected by the user via the display of the calendar is transmitted from the communication device, the information management system registers the candidate visit date/time as a visit date/time of the service person.

Therefore, in the present aspect, even in a mode configured such that the information management system is responsible for managing schedule information as well as performing an extraction process of candidate visit dates/times, a process of making an appointment for a visit by the service person can be facilitated and efficiency thereof can be improved.

(27) In addition, in the aspect described above, the visit date/time of the service person for which registration in the information management system has been completed is displayed within the calendar at the communication device.

For example, when an operation for registering a visit date/time of the service person in the calendar occurs separately after performing a process of making an appointment with the service person, since a registration operation in the calendar is to be performed separately from the process of making an appointment with the service person, the processes become a hassle. If the user forgets to register a visit date/time of the service person in the calendar, the user may misunderstand that the service person has made a sudden visit without an appointment on a date/time that is not registered in the calendar even though an appointment with the service person had actually been made.

According to the present aspect, the method causes the computer of the communication device to display a visit date/time of the service person for which registration in the information management system has been completed in the calendar in the communication device. Accordingly, the calendar is to include the visit date/time of the service person. As a result, a situation can be avoided where, after performing a process of making an appointment for a visit by the service person, the user misunderstands that the service person has made a sudden visit without an appointment because the user forgot to register the visit date/time of the service person in the calendar.

(28) In addition, in the aspect described above, the information management system may collect and manage log information of the electric appliance associated with the user of the communication device via the network, and

when the information management system determines that any the maintenance or the inspection is required for the electric appliance based on the log information, the information management system may transmit to communication device via the network a notice indicating the maintenance or the inspection is required for the electric appliance.

(29) Furthermore, in the aspect described above, the information management system may collect and manage log information of the electric appliance associated with the user of the communication device via the network, and

in a case which the information management system receives an inquiry signal for making a visit appointment with the service person from the communication device, the information management system transmits to the communication device via the network state information which indicates whether or not the maintenance or the inspection is required for the electric appliance based on the log information.

### EMBODIMENT

Hereinafter, an appointment system according to the present disclosure will be described. The appointment system according to the present disclosure is a system that manages appointments of visit dates of a service person who performs maintenance or an inspection on electric appliances.

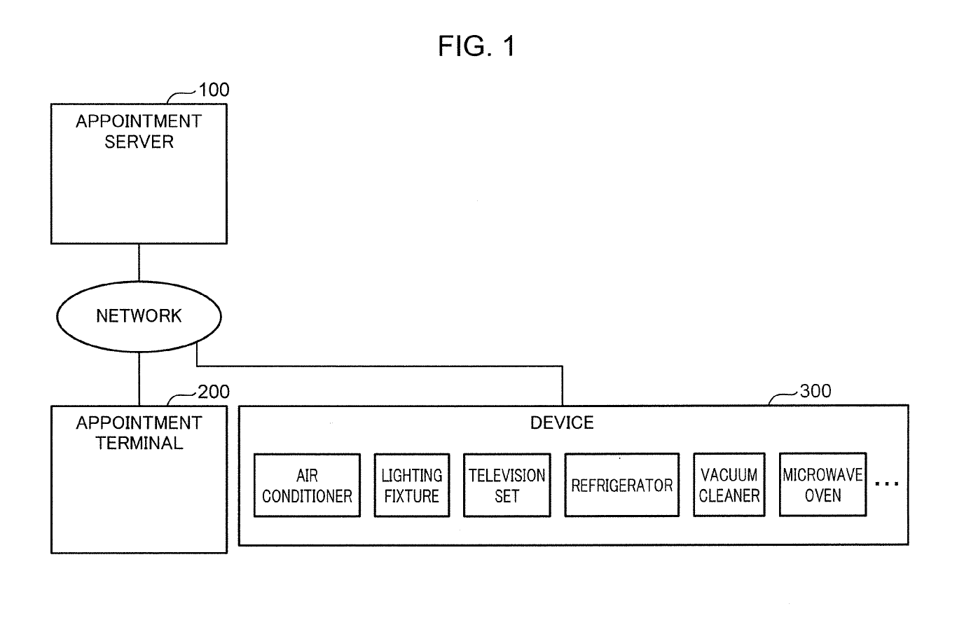

FIG. 1 is a diagram showing a first example of an overall configuration of the appointment system according to the present disclosure. The appointment system according to the first example includes an appointment server 100, an appointment terminal 200, and devices 300. The appointment server 100, the appointment terminal 200, and the devices 300 are connected so as to be capable of communicating with each other via a network. For example, a public communication network such as the Internet or a mobile phone communication network can be adopted as the network over which various types of data are transmitted and received using the TCP/IP communication protocol.

The appointment server 100 is, for example, a cloud server constituted by one or more computers. In addition, the appointment server 100 receives information related to an appointment that is input by a user through the appointment terminal 200 and manages the information. In this case, for example, the appointment server 100 may be a service provider server that is managed by a service provider who provides a service according to the present disclosure to the user or may be a manufacturer server that is managed by a manufacturer of the devices 300.

Moreover, in the appointment system according to the first example, the appointment server 100 corresponds to an example of an information management system.

The appointment terminal 200 is constituted by, for example, a button type mobile phone, a portable computer such as a smartphone and a tablet terminal, or a stationary computer. In addition, the appointment terminal 200 receives an appointment instruction from the user and transmits information related to the appointment to the appointment server 100 via the network. In this case, as the appointment terminal 200, a computer that performs the role of a home server in the house of the user may be adopted or a computer that does not perform such a role may be adopted. Moreover, while only one appointment terminal 200 is shown in FIG. 1, a plurality of the appointment terminals 200 may exist so as to correspond to a plurality of users.

The devices 300 are constituted by, for example, electric appliances installed in the house of the user who owns the appointment terminal 200. In the example shown in FIG. 1, an air conditioner, a lighting fixture, a television set, a refrigerator, a vacuum cleaner, and a cooking range are depicted as the devices 300. However, these are simply examples and any device may be adopted as the device 300 as long the device is an electric appliance that is installed in the house of the user. Therefore, an electric appliance other than the electric appliances shown in FIG. 1 may be included in the devices 300 or any of the devices 300 shown in FIG. 1 may be omitted. Examples of devices 300 not illustrated in FIG. 1 include an electric shutter and an electric curtain.

Moreover, while electric appliances installed in the house of the user owning the appointment terminal 200 are described herein as the devices 300, if there are other users, electric appliances of the other users are to be also included in the devices 300.

In addition, if the device 300 is an electric appliance with a communication function that enables communication with the appointment server 100 via a network, the device 300 is directly connected to the network. However, if the device 300 is an electric appliance without such a communication function, the device 300 is connected to the network via, for example, a gateway or a home controller.

Furthermore, while the device 300 is assumed to be installed in the house of the user in the description given above, this is simply an example and the device 300 may alternatively be installed in a building in which an office that is a workplace of the user is located. Moreover, the house may be a detached house or an apartment.

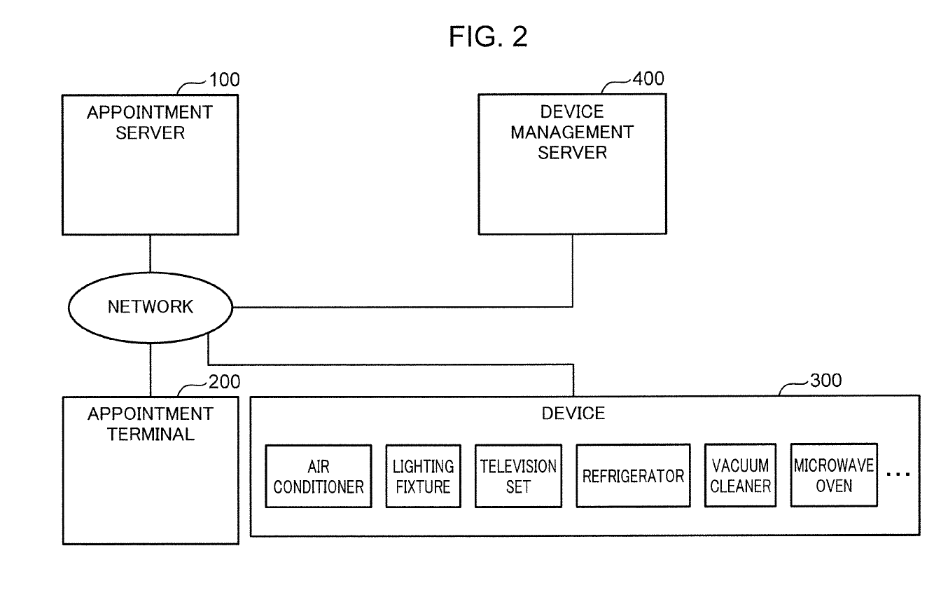

FIG. 2 is a diagram showing a second example of an overall configuration of the appointment system according to the present disclosure. The appointment system according to the second example differs from the appointment system according to the first example in that a device management server 400 is further provided. The device management server 400 is, for example, a cloud server constituted by one or more computers. In addition, the device management server 400 manages devices 300 owned by the respective users. Furthermore, in the appointment system according to the second example, the device management server 400 is given the responsibility of managing the devices 300. In this case, as the device management server 400, for example, a manufacturer server can be adopted which is used by a manufacturer of the device 300 to provide various services related to the device 300 to a user having purchased the device 300. Moreover, in the appointment system according to the second example, the appointment server 100 and the device management server 400 correspond to an example of an information management system.

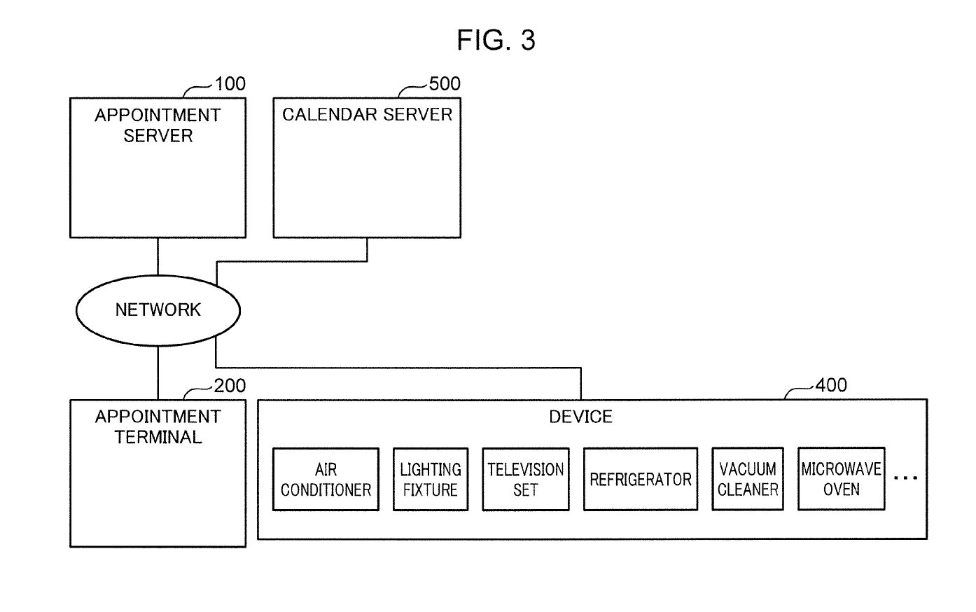

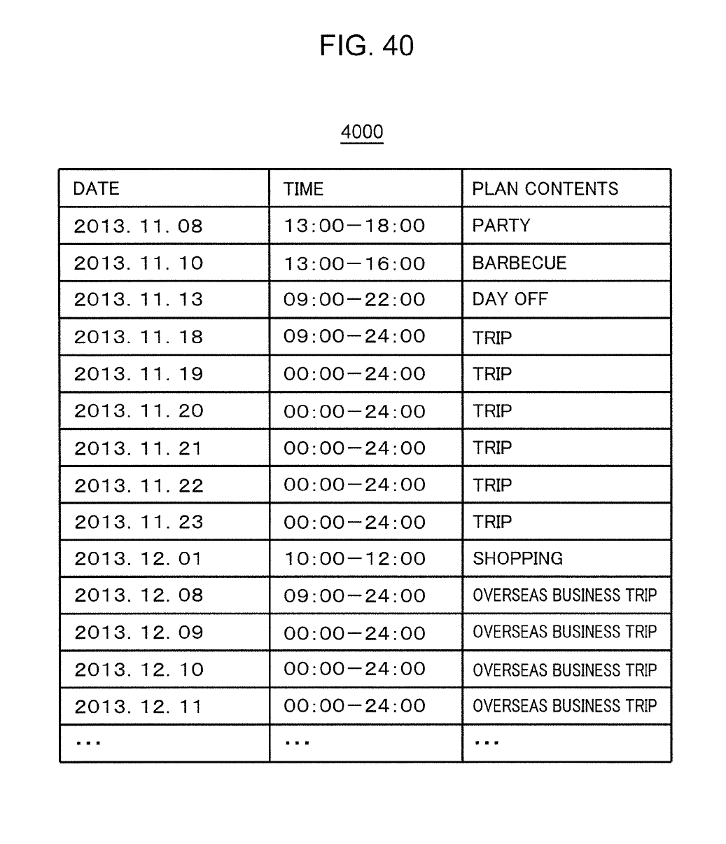

FIG. 3 is a diagram showing a third example of an overall configuration of the appointment system according to the present disclosure. The appointment system according to the third example differs from the appointment system according to the first example in that a calendar server 500 is further provided. The calendar server 500 is, for example, a cloud server constituted by one or more computers. In addition, the calendar server 500 manages schedule information of each of one or more users. In this case, as the schedule information, for example, a calendar plan list 4000 shown in FIG. 40 is adopted.

While schedule information is managed by the appointment server 100 or the appointment terminal 200 in the appointment systems according to the first and second examples, the calendar server 500 is given the responsibility of managing schedule information in the appointment system according to the third example. Moreover, in the appointment system according to the third example, the appointment server 100 and the calendar server 500 correspond to an example of an information management system.

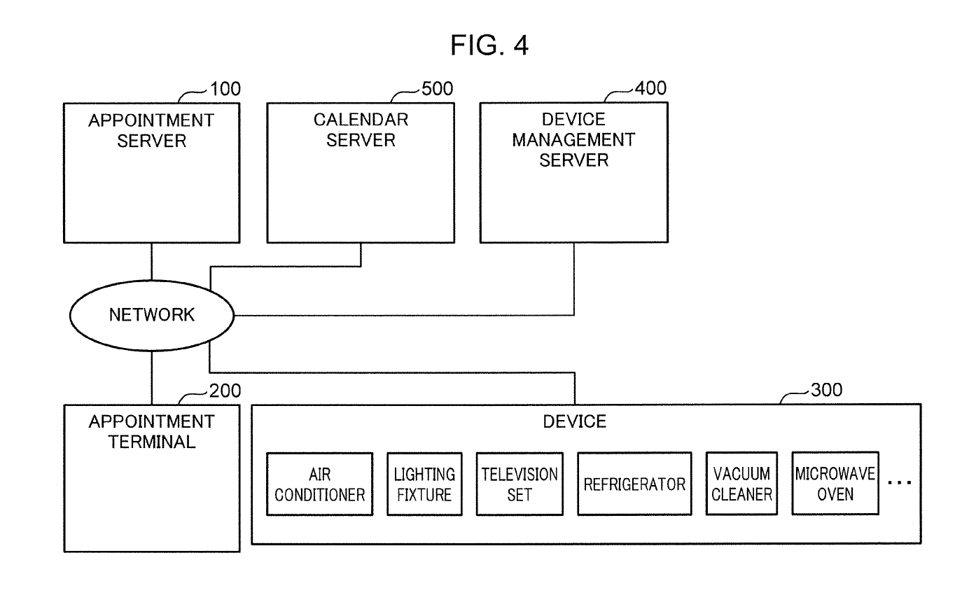

FIG. 4 is a diagram showing a fourth example of an overall configuration of the appointment system according to the present disclosure. The appointment system according to the fourth example incorporates all of the servers that have been described in the first to third examples. In other words, in the appointment system according to the fourth example, the device management server 400 and the calendar server 500 are present as servers in addition to the appointment server 100.

In the appointment system according to the fourth example, the calendar server 500 is given the responsibility of managing schedule information and the device management server 400 is given the responsibility of managing the devices 300. Moreover, in the appointment system according to the fourth example, the appointment server 100, the device management server 400, and the calendar server 500 correspond to an example of an information management system.

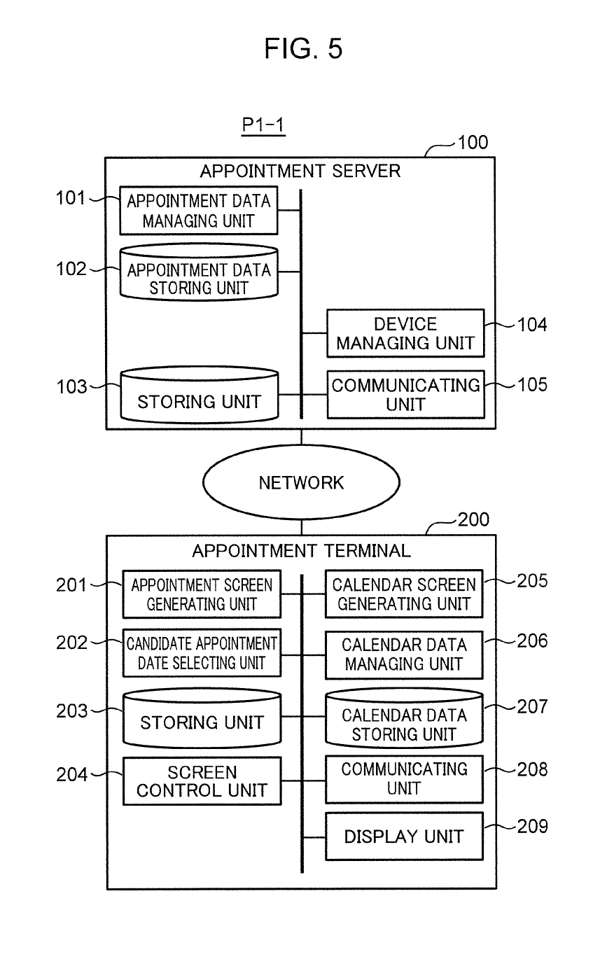

FIG. 5 is a block diagram showing a configuration pattern P1-1 of the appointment system according to the first example. In the appointment system shown in FIG. 5, the appointment server 100 includes an appointment data managing unit 101, an appointment data storing unit 102, a storing unit 103, a device managing unit 104, and a communicating unit 105. The appointment data managing unit 101 causes the appointment data storing unit 102 to store information related to an appointment that is input by a user through the appointment terminal 200 and manages the information related to the appointment.

The appointment data storing unit 102 is constituted by, for example, a non-volatile rewritable storage device and stores information related to an appointment.

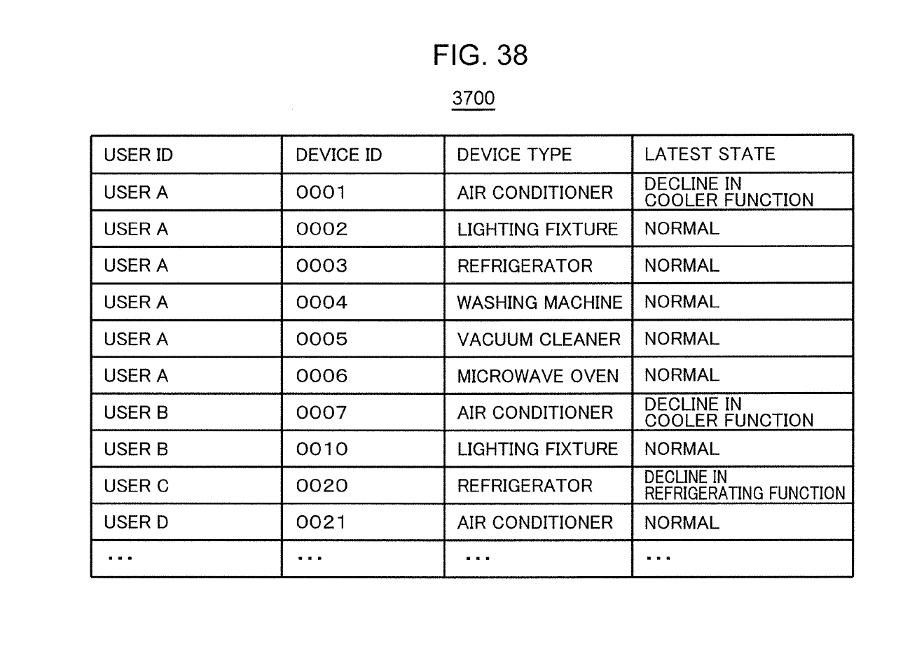

The storing unit 103 is constituted by, for example, a non-volatile rewritable storage device and stores various types of data that are used by the appointment server 100 when performing various processes. In the example shown in FIG. 5, since the device managing unit 104 is included in the appointment server 100, the storing unit 103 stores device information that is managed by the device managing unit 104. In this case, as the device information, for example, a device list table 3700 shown in FIG. 38 can be adopted.

The device managing unit 104 stores device information transmitted from the device 300 in the storing unit 103 and manages the device information.

The communicating unit 105 connects the appointment server 100 to the network and enables the appointment server 100 to communicate with the appointment terminal 200 and the like.

In FIG. 5, the appointment terminal 200 includes an appointment screen generating unit 201, a candidate appointment date selecting unit 202, a storing unit 203, a screen control unit 204, a calendar screen generating unit 205, a calendar data managing unit 206, a calendar data storing unit 207, a communicating unit 208, and a display unit 209.

The appointment screen generating unit 201 generates image data of various screens used by an appointment application that causes a computer to function as the appointment terminal 200 and displays the image data on the display unit 209.

The candidate appointment date selecting unit 202 selects, from appointment available dates/times (an example of possible visit dates/times) that represent dates/times at which a service person can visit the house of a user in order to perform maintenance or an inspection on the device 300, appointment available dates/times from which dates/times on which plans of the user are registered have been excluded as candidate appointment dates/times (an example of candidate visit dates/times).

Alternatively, the candidate appointment date selecting unit 202 selects, from appointment available dates (an example of possible visit dates) that represent dates on which a service person can visit the house of a user in order to perform maintenance or an inspection on the device 300, appointment available dates which are obtained by excluding dates on which plans of the user are registered as candidate appointment dates (an example of candidate visit dates). Hereinafter, processes of extracting candidate appointment dates/times or candidate appointment dates which are performed by the candidate appointment date selecting unit 202 will be collectively described as an extraction process of a candidate appointment date.

The storing unit 203 stores various data that is used by the appointment terminal 200 to perform various processes.

The screen control unit 204 detects various operations performed by the user on the various screens displayed on the display unit 209. In the present disclosure, a touch panel included in the display unit 209 is adopted as an operating device that accepts operations by the user. Therefore, the screen control unit 204 detects operations such as tapping, swiping, and flicking input by the user through the touch panel. In addition, when the screen control unit 204 detects an operation involving tapping a GUI component displayed on the display unit 209, the screen control unit 204 determines that the GUI component has been selected by the user. Moreover, when a keyboard or a mouse is adopted as the operating device, the screen control unit 204 may detect an operation by the user on the keyboard or an operation by the user using the mouse. Furthermore, when the screen control unit 204 detects an operation by the user during startup of the appointment application, the screen control unit 204 notifies the appointment screen generating unit 201 of the detected contents and causes the appointment screen generating unit 201 to detect the operation by the user.

The calendar screen generating unit 205 generates image data of various screens used by a calendar application and displays the image data on the display unit 209. Moreover, the calendar application is an application that is installed in existing smartphones and the calendar screen generating unit 205 is a program module that is responsible for generating a calendar screen. In addition, in the present disclosure, a calendar screen is displayed in various screens of the appointment application. Image data of the screens of the appointment application is generated by the appointment screen generating unit 201. As such, the calendar screen that is generated by the calendar screen generating unit 205 will not be particularly described.

The calendar data managing unit 206 generates schedule information, stores the schedule information in the calendar data storing unit 207, and manages the schedule information.

The calendar data storing unit 207 stores schedule information.

The communicating unit 208 connects the appointment terminal 200 to the network and enables the appointment terminal 200 to communicate with the appointment server 100 and the like.

The display unit 209 is constituted by, for example, a liquid crystal display including a touch panel.

Moreover, in the appointment server 100 shown in FIG. 5, the appointment data managing unit 101 is realized by, for example, having a processor of the appointment server 100 execute an appointment server program that causes a computer to function as the appointment server 100. Furthermore, the appointment data storing unit 102 and the storing unit 103 are constituted by, for example, rewritable non-volatile storage devices. The communicating unit 105 is constituted by a communication device such as a modem.

In addition, in FIG. 5, the appointment screen generating unit 201 and the candidate appointment date selecting unit 202 are realized by having a processor of the appointment terminal 200 execute an appointment application. Furthermore, the calendar screen generating unit 205 and the calendar data managing unit 206 are realized by having the processor of the appointment terminal 200 execute a calendar application.

In addition, the storing unit 203 and the calendar data storing unit 207 are constituted by, for example, rewritable non-volatile storage devices. Furthermore, the screen control unit 204 is realized by, for example, having the processor of the appointment terminal 200 execute an operation system. The communicating unit 208 is constituted by a communication device such as a modem.

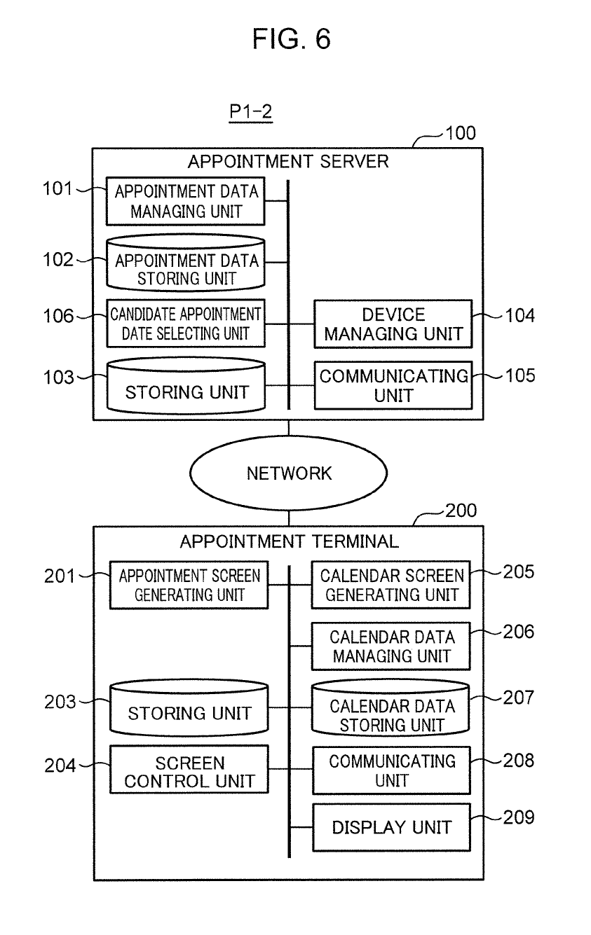

FIG. 6 is a block diagram showing a configuration pattern P1-2 of the appointment system according to the first example. In the configuration pattern P1-2, an extraction process of a candidate appointment date is performed by the appointment server 100 and management of schedule information is performed by the appointment terminal 200. To this end, the appointment server 100 includes a candidate appointment date selecting unit 106.

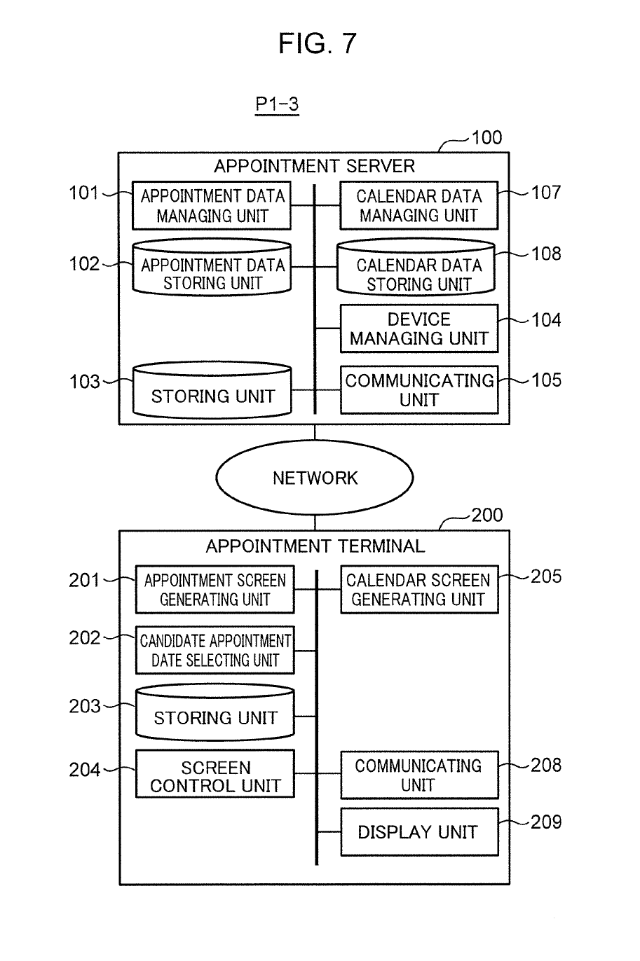

FIG. 7 is a block diagram showing a configuration pattern P1-3 of the appointment system according to the first example. In the configuration pattern P1-3, an extraction process of a candidate appointment date is performed by the appointment terminal 200 and management of schedule information is performed by the appointment server 100. To this end, the appointment terminal 200 includes the candidate appointment date selecting unit 202 and the appointment server 100 includes a calendar data managing unit 107 and a calendar data storing unit 108. In this pattern, the calendar screen generating unit 205 is constituted by a browser which, for example, acquires schedule information that is described in a script language (for example, HTML and JavaScript (registered trademark)) from the appointment server 100 and which displays the schedule information on the display unit 209.

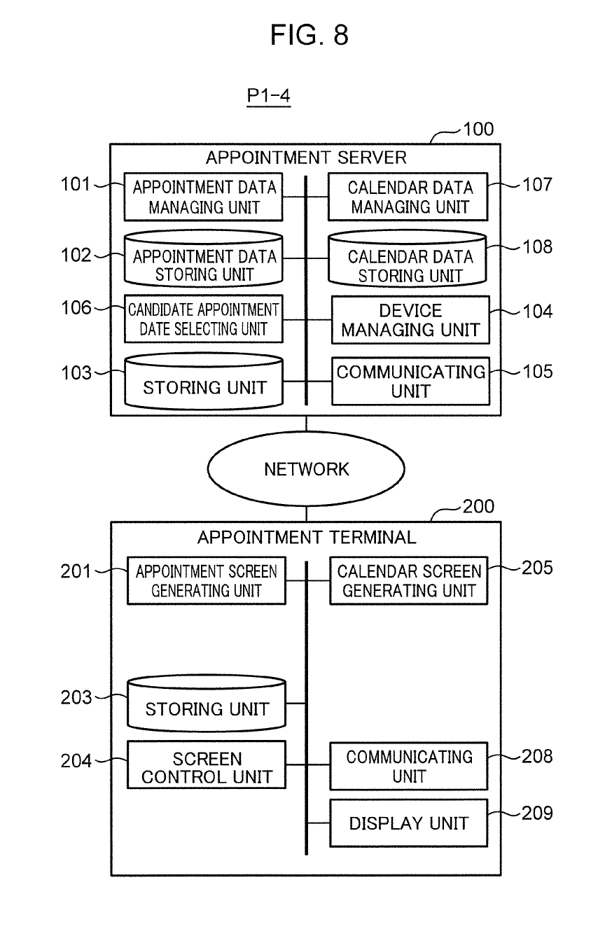

FIG. 8 is a block diagram showing a configuration pattern P1-4 of the appointment system according to the first example. In the configuration pattern P1-4, an extraction process of a candidate appointment date and management of schedule information are performed by the appointment server 100. To this end, the appointment server 100 includes the candidate appointment date selecting unit 106, the calendar data managing unit 107, and the calendar data storing unit 108.

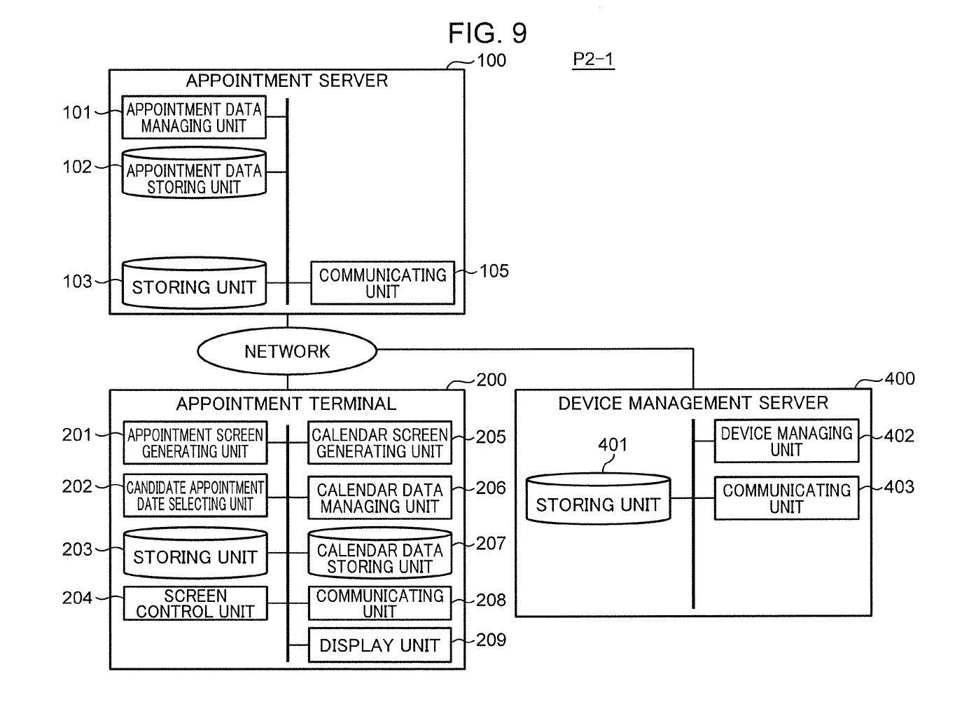

FIG. 9 is a block diagram showing a configuration pattern P2-1 of the appointment system according to the second example. In the configuration pattern P2-1, the device management server 400 has been added to the configuration patterns P1-1 to P1-4. The device management server 400 includes a storing unit 401, a device managing unit 402, and a communicating unit 403.

The storing unit 401 stores, for example, device information of each device 300.

The device managing unit 402 stores device information in the storing unit 401 and manages the device information.

The communicating unit 403 connects the device management server 400 to the network.

In FIG. 9, the device managing unit 402 is realized by, for example, having a processor of the device management server 400 execute a device management server program that causes a computer to function as the device management server 400. Moreover, in FIG. 9, an extraction process of a candidate appointment date and management of schedule information are performed by the appointment terminal 200. However, this simply represents an example and even when the appointment system according to the second example is adopted, the extraction process of a candidate appointment date may be performed by any of the appointment server 100 and the appointment terminal 200 and the management of schedule information may be performed by any of the appointment server 100 and the appointment terminal 200.

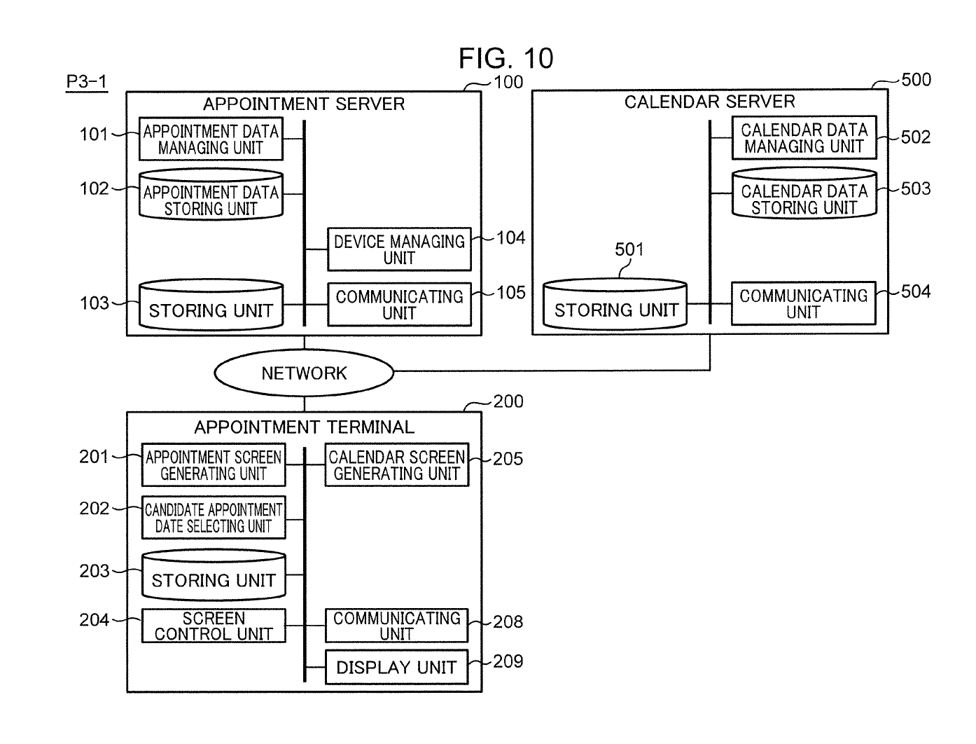

FIG. 10 is a block diagram showing a configuration pattern P3-1 of the appointment system according to the third example. In the configuration pattern P3-1, the calendar server 500 has been added to the configuration patterns P1-1 to P1-4.

The calendar server 500 includes a storing unit 501, a calendar data managing unit 502, a calendar data storing unit 503, and a communicating unit 504.

The storing unit 501 stores various types of data that are used by the calendar server 500 to perform various processes.

The calendar data managing unit 502 stores schedule information of each of one or more users in the calendar data storing unit 503 and manages the schedule information.

The calendar data storing unit 503 stores schedule information.

The communicating unit 504 connects the calendar server 500 to the network.

The calendar data managing unit 502 is realized by, for example, having a processor of the calendar server 500 execute a calendar server program that causes a computer to function as the calendar server 500. The storing unit 501 and the calendar data storing unit 503 are constituted by, for example, rewritable non-volatile storage devices. The communicating unit 504 is constituted by a communication device such as a modem. In the configuration pattern P3-1, an extraction process of a candidate appointment date is performed by the appointment terminal 200 and schedule information is managed by the calendar server 500. Therefore, calendar data managing units and calendar data storing units have been omitted from the appointment server 100 and the appointment terminal 200. Accordingly, the calendar screen generating unit 205 is constituted by a browser which generates image data of calendar data using the schedule information and which displays the image data on the display unit 209.

FIG. 11 is a block diagram showing a configuration pattern P3-2 of the appointment system according to the third example. The configuration pattern P3-2 differs from the configuration pattern P3-1 in that an extraction process of a candidate appointment date is performed by the appointment server 100. To this end, the appointment server 100 includes the candidate appointment date selecting unit 106.

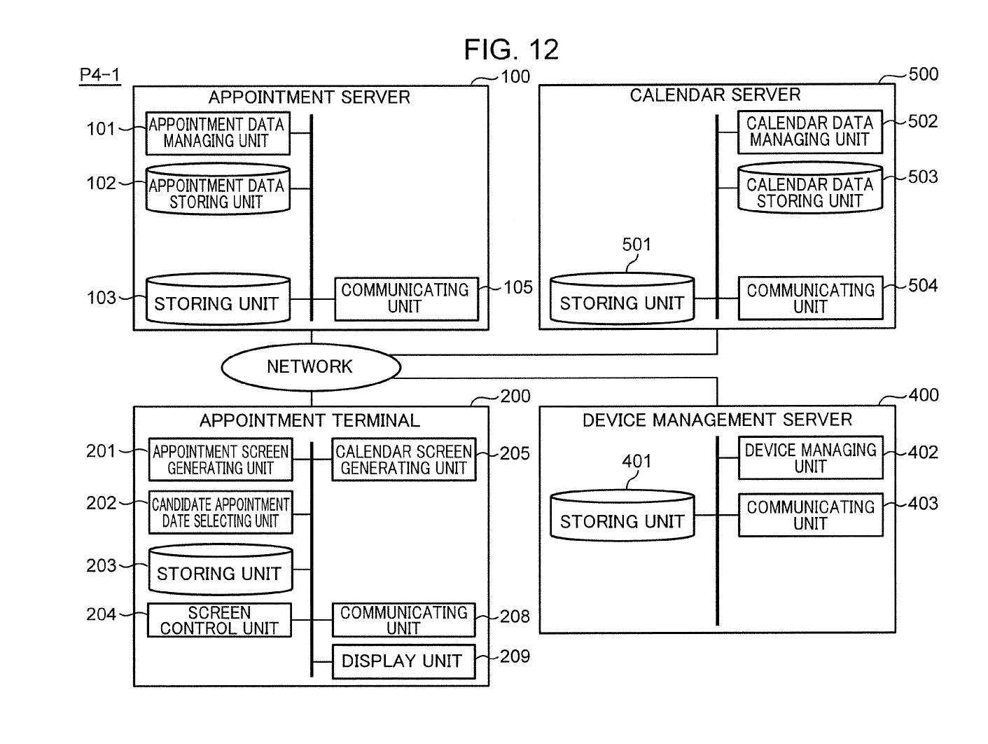

FIG. 12 is a block diagram showing a configuration pattern P4-1 of the appointment system according to the fourth example. In the configuration pattern P4-1, the calendar server 500 and the device management server 400 have been added to the configuration patterns P1-1 to P1-4. In other words, in the configuration pattern P4-1, management of schedule information is performed by the calendar server 500 and management of device information is performed by the device management server 400. In addition, in the configuration pattern P4-I, an extraction process of a candidate appointment date is performed by the appointment terminal 200. To this end, the appointment terminal 200 includes the candidate appointment date selecting unit 202.

Alternatively, in the configuration pattern P4-1, an extraction process of a candidate appointment date may be performed by the appointment server 100.

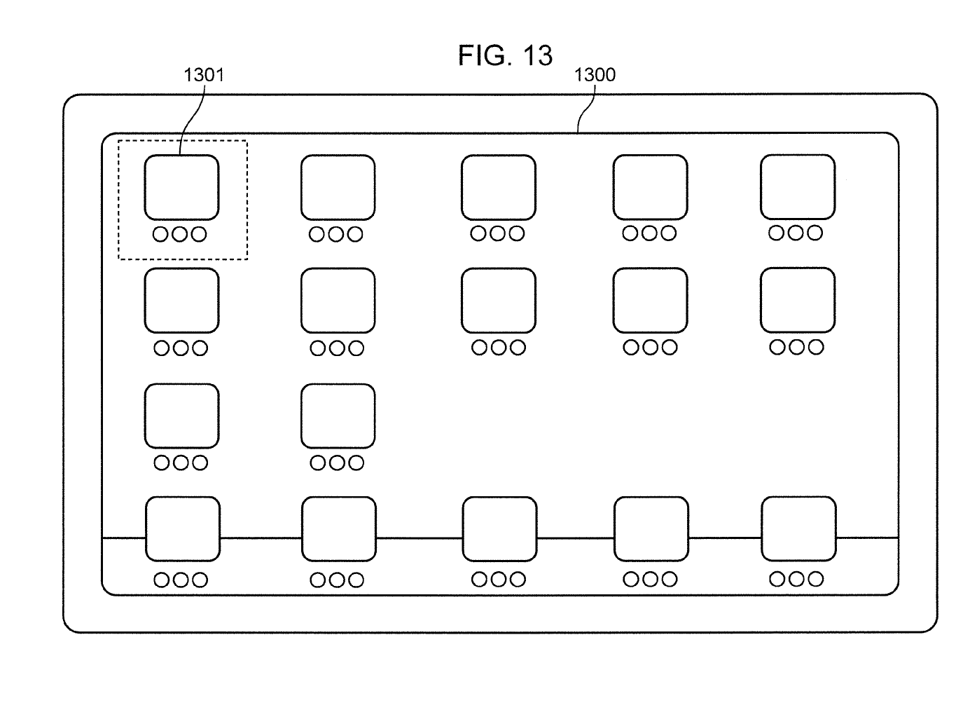

FIG. 13 is a diagram showing an example of a basic screen 1300. The basic screen 1300 is a basic screen displayed by an ordinary smartphone or a tablet terminal. The basic screen 1300 displays one or more icons for executing one or more applications in a matrix pattern. In addition, the one or more icons include an appointment application icon 1301 for executing an appointment application. In the example shown in FIG. 13, the appointment application icon 1301 is arranged at a top left position.

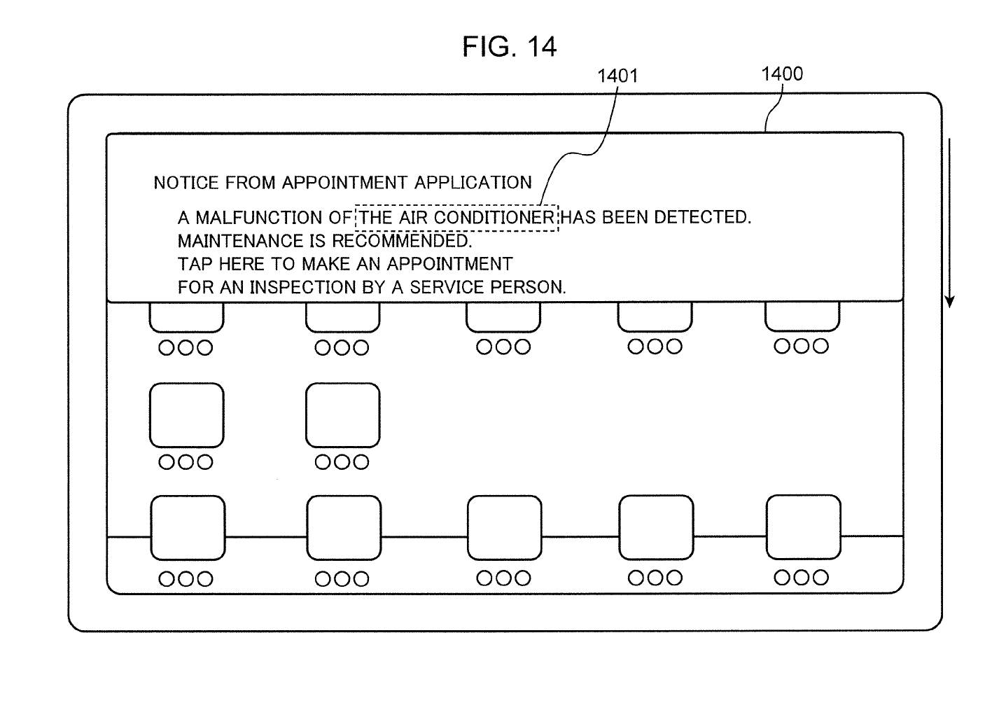

FIG. 14 is a diagram showing an example of an appointment guide notification screen 1400. The appointment guide notification screen 1400 is a notification screen of a push notification that is transmitted to the appointment terminal 200 of a user of concern when the appointment system detects a malfunction of the device 300 installed in the house of the user. In this case, the appointment guide notification screen 1400 is displayed overlaid on the basic screen 1300 in a region that occupies about a top one-third of the basic screen 1300.

A text reading “Notice from appointment application. A malfunction of the air conditioner has been detected. Maintenance is recommended. Tap here to make an appointment for an inspection by a service person.” is presented on the appointment guide notification screen 1400 to explicitly indicate that a malfunction of the device 300 has been detected. A device name 1401 is included in the text presented on the appointment guide notification screen 1400. In the example shown in FIG. 14, since a malfunction of the air conditioner has been detected, “air conditioner” is displayed as the device name 1401. When the screen control unit 204 detects that the user has tapped the device name 1401, the appointment screen generating unit 201 causes a symptom confirmation screen 1500 to be displayed on the display unit 209.

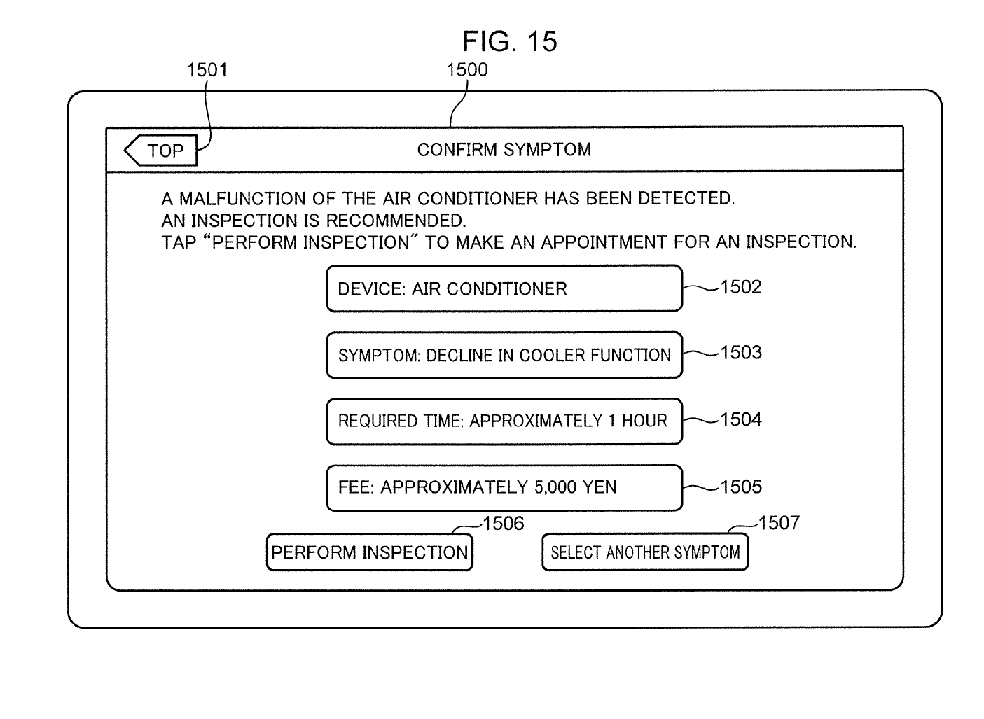

FIG. 15 is a diagram showing an example of the symptom confirmation screen 1500. The symptom confirmation screen 1500 is a screen on which a server managing device information presents symptoms of the device 300 for which a malfunction has been detected and which enables the user to confirm the symptoms of the device 300.

A heading that reads “Confirm symptom” is presented in an upper part of the symptom confirmation screen 1500 to explicitly indicate that the screen is a screen for having the user confirm the symptom of the device 300.

In addition, a text reading “A malfunction of the air conditioner has been detected. An inspection is recommended. Tap “perform inspection” to make an appointment for an inspection.” is displayed below the heading display field of the symptom confirmation screen 1500 to prompt the user to make an appointment for an inspection of the device 300.

A device display field 1502, a symptom display field 1503, a required time display field 1504, and a fee display field 1505 are, for example, displayed as a vertical line below the text.

The device display field 1502 displays a name of the device 300 for which a malfunction has been detected. In this case, since a malfunction of the air conditioner has been detected, “device: air conditioner” is displayed in the device display field 1502.

The symptom display field 1503 displays a symptom of the device 300 for which a malfunction has been detected. In this case, a symptom refers to contents of a malfunction of the device 300. In this case, since a decline in a cooler function has been detected, “symptom: decline in cooler function” is displayed in the symptom display field 1503.

The required time display field 1504 displays a required time that is required by a service person visiting the house of the user to perform an inspection. In this case, a service person refers to a person who performs maintenance or an inspection on the device 300 and who belongs to, for example, the manufacturer of the device 300 or a service provider which provides an appointment service.

In this case, since the time required by an inspection operation regarding a symptom of a decline in cooler function is approximately one hour, “required time: approximately 1 hour” is displayed in the required time display field 1504.

The fee display field 1505 displays a fee to be paid by the user in exchange for an inspection performed by the service person. In this case, since the fee for an inspection with respect to a decline in cooler function is approximately 5,000 yen, “fee: approximately 5,000 yen” is displayed in the fee display field 1505. Moreover, a required time and a fee are calculated using a symptom table 3900 to be described later.

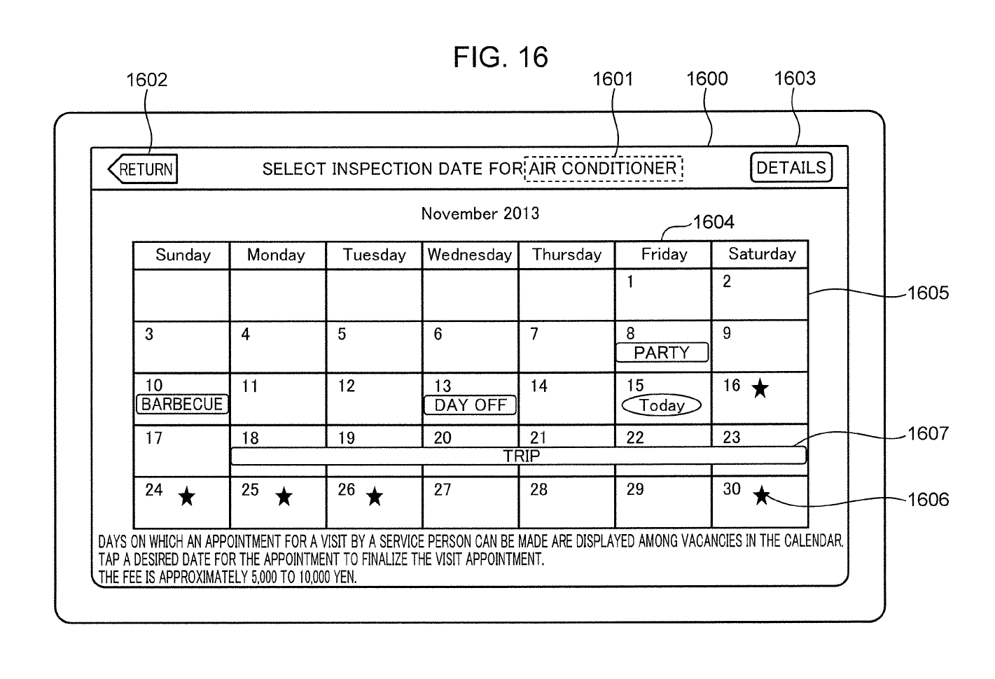

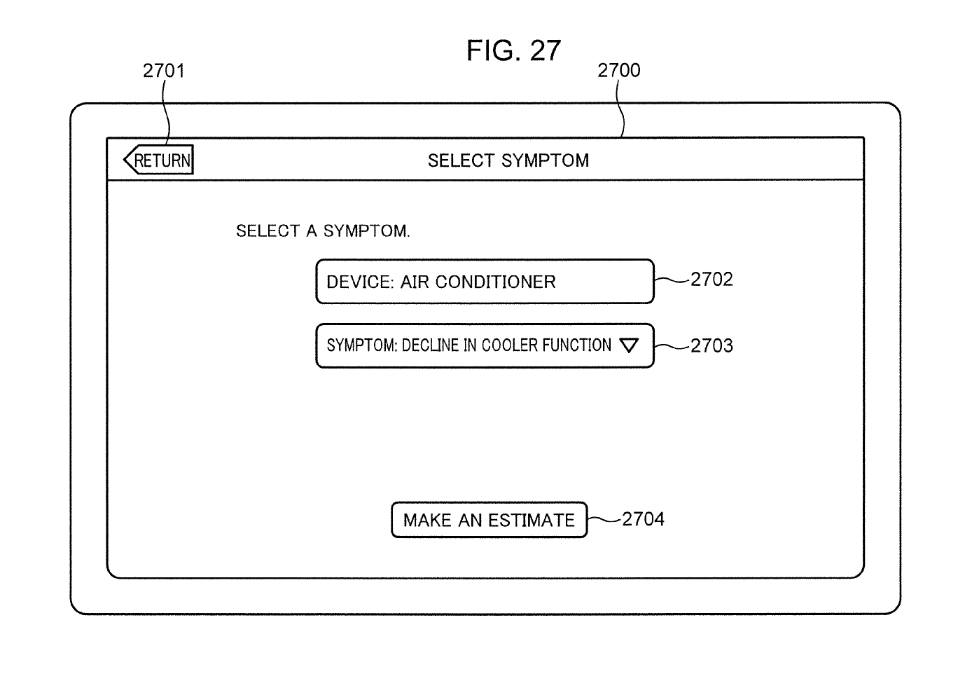

An inspection button 1506 with the description “perform inspection” and a symptom selection button 1507 with the description “select another symptom” are, for example, displayed as a horizontal line below the fee display field 1505. The inspection button 1506 is a button for switching the display screen of the display unit 209 to an inspection date selection screen 1600 (FIG. 16). The symptom selection button 1507 is a button for switching the display screen of the display unit 209 to a symptom selection screen 2700 (FIG. 27).

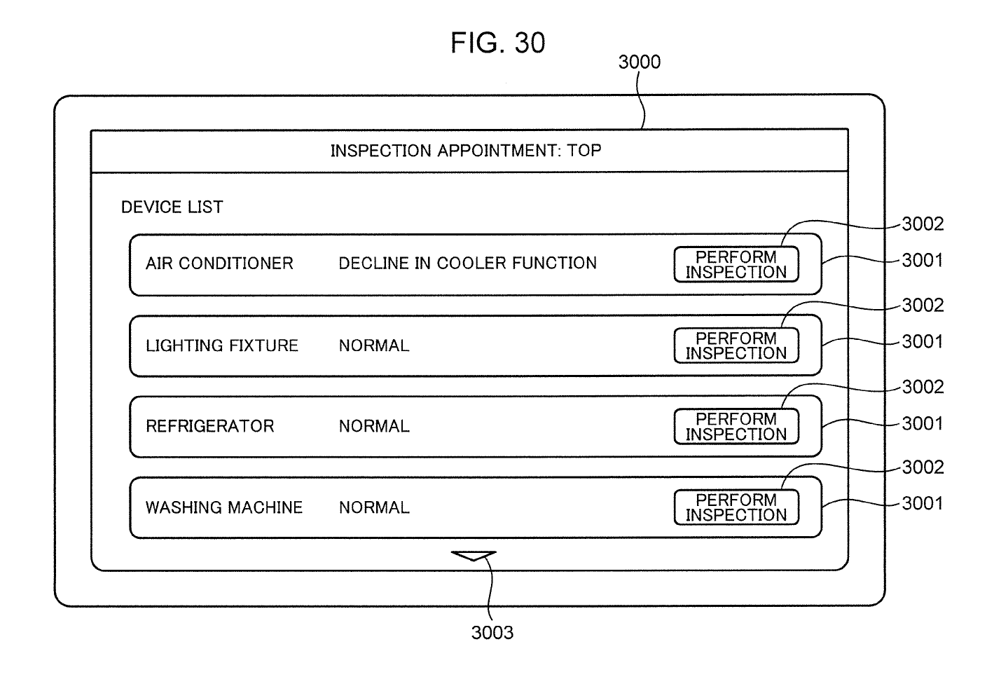

Moreover, a top button 1501 with the description “top” that is displayed in a top left part of the symptom confirmation screen 1500 is a button for switching the display screen of the display unit 209 to a top screen 3000 (FIG. 30).

FIG. 16 is a diagram showing a first example of the inspection date selection screen 1600. The inspection date selection screen 1600 is a screen for having a user select a visit date of the service person. A heading that reads “Select inspection date for air conditioner” is provided in an upper part of the inspection date selection screen 1600 to explicitly indicate that the screen is a screen for selecting an inspection date. The example shown in FIG. 16 presents the inspection date selection screen 1600 corresponding to an air conditioner. Therefore, “air conditioner” is described as a device name 1601 in the heading. In other words, a name of the device 300 that is an inspection object is described in the field of the device name 1601 in the heading.

The inspection date selection screen 1600 is provided with a calendar data display field 1604 in which plans of the user generated using schedule information are shown in a calendar format. In this case, the calendar data display field 1604 is a field that displays a calendar in which days are presented on a per month or per week basis. In the example shown in FIG. 16, a calendar in which days are presented on a per month basis is adopted.

The calendar data display field 1604 is constituted by 35 rectangular boxes 1605 divided in a matrix pattern by the seven days of the week from Sunday to Saturday which are arranged horizontally and five weeks arranged vertically. In this case, one box 1605 is a region representing a day. A numeral indicating a day is displayed in each box 1605. Moreover, in the example shown in FIG. 16, a numeral indicating a day is not displayed in boxes 1605 corresponding to days which do not belong to a month that is a display target but belong to the previous month or the following month. However, this is simply an example and days may be displayed in boxes 1605 corresponding to days which belong to the previous month or the following month. A year and a month which are display objects are displayed above the calendar data display field 1604. In the example shown in FIG. 16, since calendar data for November 2013 is displayed in the calendar data display field 1604, “November 2013” is displayed above the calendar data display field 1604.

The calendar data display field 1604 displays a schedule icon 1607 representing a schedule of a user input by the user using the calendar application. The example shown in FIG. 16 displays schedule icons 1607 such as “party” on the 8th, “barbeque” on the 10th, “day off” on the 13th, and “trip” from the 18th to the 23rd. In addition, in the example shown in FIG. 16, “today” is displayed in the box 1605 corresponding to the present day to explicitly indicate the present day to the user.

Furthermore, the calendar data display field 1604 displays a candidate symbol 1606 for explicitly indicating that a given day is a candidate appointment date of the service person in a box 1605 corresponding to the candidate appointment date. While a star-shaped graphic is adopted as the candidate symbol 1606 in the example shown in FIG. 16, any graphic such as a circle and a square may be adopted as long as a candidate appointment date can be recognized.

As described above, the calendar data display field 1604 which displays both a schedule of the user and candidate appointment dates of the service person is provided on the inspection date selection screen 1600. Therefore, the user can select a visit date of the service person using only the inspection date selection screen 1600.

For example, let us consider a case where the calendar data display field 1604 is not provided on the inspection date selection screen 1600. In this case, the user must separately start up a calendar application and select a visit date of the service person by collating the display of calendar data provided by the calendar application with the display on the inspection date selection screen 1600. In particular, when the appointment terminal 200 is a tablet terminal or a smartphone, since a small size of the display unit 209 makes it difficult to display the calendar data and the inspection date selection screen 1600 at the same time, the user must collate both screens while inputting operations for switching between both displays.

In consideration thereof, the present disclosure aims to improve efficiency of an appointment operation for setting up a visit date of the service person by providing the calendar data display field 1604 on the inspection date selection screen 1600.

Furthermore, the candidate appointment dates that are displayed in the calendar data display field 1604 are appointment available dates on which the service person can visit from which are obtained by excluding dates on which the user has plans. Therefore, only candidate appointment dates that are likely to be selected by the user are displayed in the calendar data display field 1604. As a result, the number of displayed candidate appointment dates can be narrowed down and the user can smoothly perform an appointment operation for setting up a visit date of the service person.

A text reading “Days on which an appointment for a visit by a service person can be made are displayed among vacancies in the calendar.” is displayed below the calendar data display field 1604 to explicitly indicate that the dates with the candidate symbols 1606 are candidate appointment dates. This text is followed by a text reading “Tap a desired date for the appointment to finalize the visit appointment.” which prompts the user to select a visit date from the candidate appointment dates. This text is, in turn, followed by a display of a text reading “The fee is 5,000 to 10,000 yen” which explicitly indicates the fee for the inspection work by the service person. Accordingly, information for making a determination on whether or not to carry out an inspection operation of the device 300 is provided to the user.

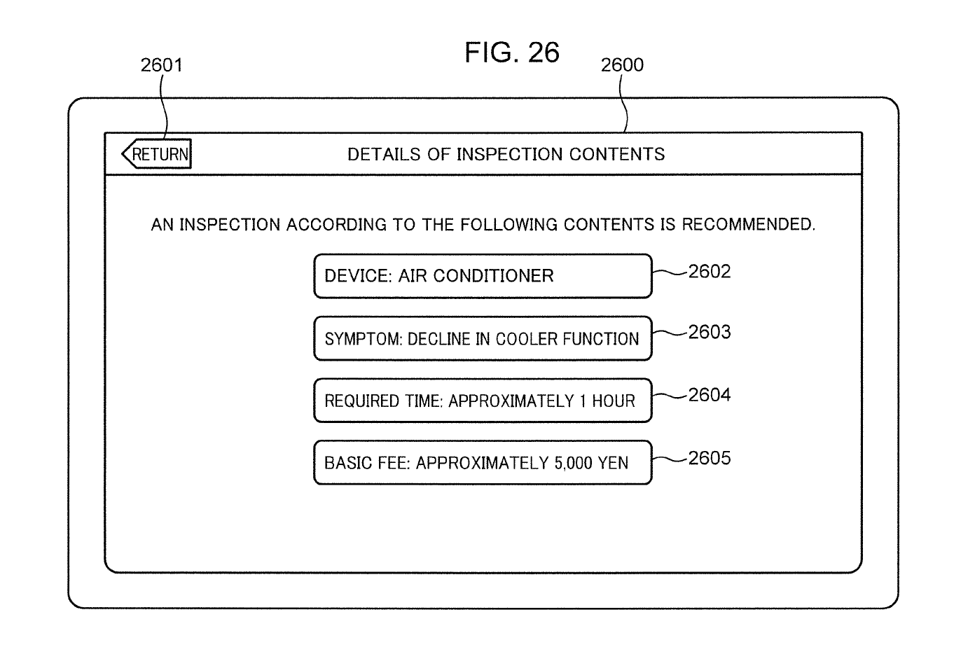

A return button 1602 with a description of “return” is displayed to the left of the display field of the device name 1601 on the inspection date selection screen 1600. The return button 1602 is a button for returning the display screen on the display unit 209 from the inspection date selection screen 1600 to the symptom confirmation screen 1500. In addition, a detail button 1603 with a description of “detail” is displayed to the right of the display field of the device name 1601 on the inspection date selection screen 1600. The detail button 1603 is a button for switching the display screen of the display unit 209 to an inspection detail confirmation screen 2600 (FIG. 26).

Moreover, while calendar data is displayed on a per month basis in the calendar data display field 1604 in FIG. 16, the calendar data may instead be displayed on a per week basis. In this case, the calendar data display field 1604 is constituted by, for example, seven boxes 1605 divided in a matrix pattern by the seven days of the week from Sunday to Saturday which are arranged horizontally and one week arranged vertically.

In this case, days are displayed in the calendar data display field 1604 on a per week basis regardless of month even if the present week that is a display target is a week extending to the following month or the previous month. For example, in FIG. 16, the week in the first row is a week that extends from October to November, and when only this week is displayed in the calendar data display field 1604, a numeral indicating the day, the schedule icon 1607, and the candidate symbol 1606 are also displayed for days which belong to October and which are blank fields.

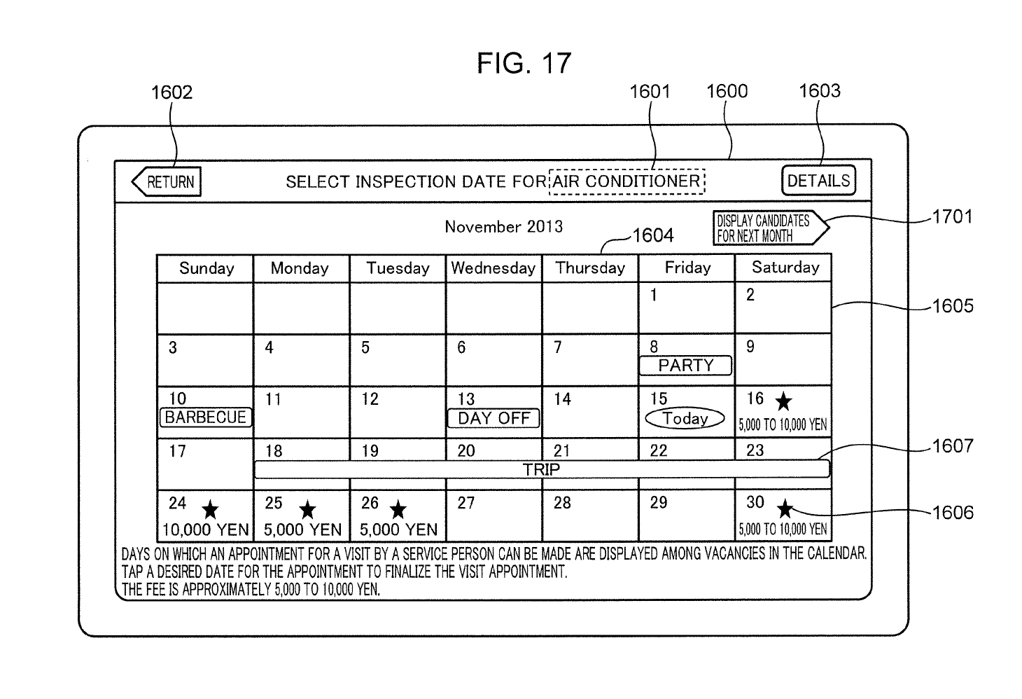

FIG. 17 is a diagram showing a second example of the inspection date selection screen 1600. On the inspection date selection screen 1600 according to the second example, a next month candidate display button 1701 has been added and a fee is displayed in the box 1605 corresponding to a candidate appointment date.

The next month candidate display button 1701 is a button for causing calendar data of a next month to be displayed in the calendar data display field 1604. The next month candidate display button 1701 is displayed when candidate appointment dates are extracted so as to extend from the present month that is a display object to the following month. When the screen control unit 204 detects that the next month candidate display button 1701 has been tapped, the appointment screen generating unit 201 displays the inspection date selection screen 1600 that displays calendar data for the following month on the display unit 209.

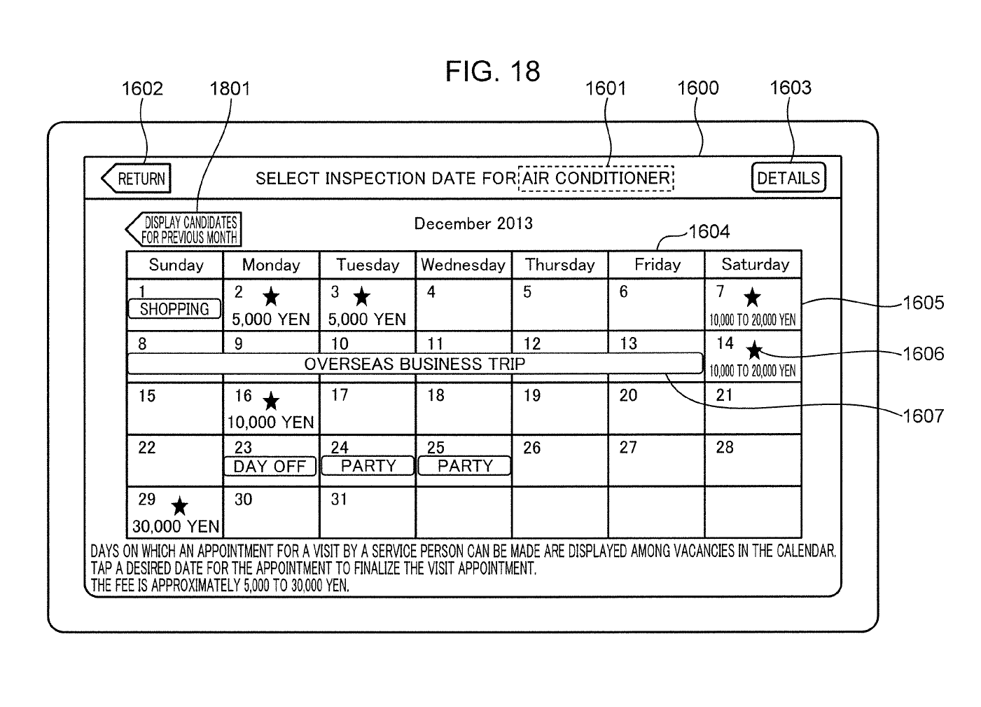

FIG. 18 is a diagram showing an example of the inspection date selection screen 1600 for the month following the inspection date selection screen 1600 shown in FIG. 17.

In the example shown in FIG. 18, since the present month is November 2013, calendar data for December 2013 that is the following month is displayed in the calendar data display field 1604. On the inspection date selection screen 1600 of the following month, a schedule of the user and candidate visit dates are both displayed in the calendar data display field 1604 in a similar manner to the inspection date selection screen of the present month.

Therefore, even if the present day is at the end of the present month, by causing the inspection date selection screen 1600 displaying calendar data of the following month that is shown in FIG. 18 to be displayed, the user can select a visit date without omitting candidate appointment dates of the following month.

In addition, a previous month candidate display button 1801 is displayed below the return button 1602 on the inspection date selection screen 1600 of the following month. The previous month candidate display button 1801 is a button for switching screen display of the display unit 209 to the inspection date selection screen 1600 of the present month that is shown in FIG. 17.

Therefore, when the screen control unit 204 detects that the previous month candidate display button 1801 has been tapped, the appointment screen generating unit 201 switches screen display from the inspection date selection screen 1600 of the following month to the inspection date selection screen 1600 of the present month.

Furthermore, as shown in FIGS. 17 and 18, on the inspection date selection screen 1600 according to the second example, a fee for an inspection by the service person is displayed in the box 1605 that corresponds to a candidate appointment date. At this point, the fee for an inspection by the service person may differ between weekdays and weekends. In this case, explicitly indicating a fee for the inspection for each candidate appointment date makes it easier for the user to select a candidate appointment date. Therefore, in the example shown in FIG. 17, a fee for the inspection operation is displayed in the box 1605 that corresponds to a candidate appointment date. Accordingly, the user can select a candidate appointment date on which the fee is lower.

In the example shown in FIG. 17, the fee on Sunday the 24th is 10,000 yen, the fees on Saturdays the 16th and 30th are 5,000 to 10,000 yen, and the fees on Monday the 25th and Tuesday the 26th are 5,000 yen. This indicates that fees are set higher on Sundays and Saturdays than on weekdays. Therefore, information suggesting that selecting weekdays may result in lower fees is explicitly indicated to the user.

Moreover, while an example in which fees differ depending on the day of the week is shown in FIG. 17, there may be cases where fees differ depending on whether or not it is a busy period. In this case, for a candidate appointment date corresponding to the busy period, a fee that is higher than other candidate appointment dates is displayed. In Japan, December is customarily considered a busy period. Therefore, fees displayed on the inspection date selection screen 1600 of December that is shown in FIG. 18 are set relatively higher than the fees displayed on the inspection date selection screen 1600 of November that is shown in FIG. 17.

In addition, while the examples in FIGS. 17 and 18 represent cases where fees are constant on a same day, there may be cases where fees fluctuate depending on time slots even on the same day. For example, there may be cases where fees for a time slot late at night or a time slot that is sandwiched between other plans of the service person are set higher than other time slots. In such a case, fees depending on time slots may be displayed in the box 1605 of a candidate appointment date.

Moreover, when a mode in which calendar data is displayed on a per week basis is adopted in FIGS. 17 and 18, for example, a next week candidate display button is displayed in place of the next month candidate display button 1701 on the inspection date selection screen 1600. In this case, when the next week candidate display button is tapped, the appointment screen generating unit 201 may display the calendar data of the next week. Since a schedule of the user and candidate appointment dates are also displayed on the calendar data of the next week, the user can select a candidate appointment date without omitting the candidate appointment dates of the next week.

Moreover, on the inspection date selection screens according to the first and second examples, the appointment screen generating unit 201 may display the schedule icon 1607 and the candidate symbol 1606 in different colors. Accordingly, the user can recognize the user's own schedule and candidate appointment dates in a more distinguishable manner.

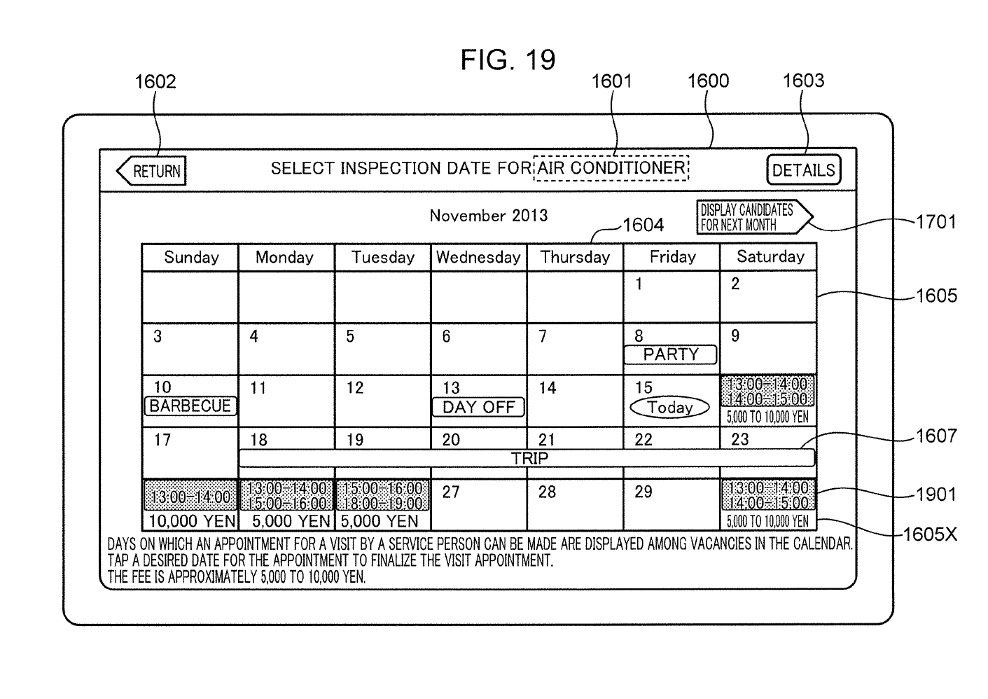

FIG. 19 is a diagram showing a third example of the inspection date selection screen 1600. The inspection date selection screen 1600 according to the third example differs from the inspection date selection screen 1600 according to the second example in that a candidate appointment date is indicated by a candidate appointment time 1901 instead of the candidate symbol 1606.

In FIG. 19, for example, a time slot of 13:00 to 14:00 and a time slot of 14:00 to 15:00 are displayed as candidate appointment times 1901 in a box 1605X of the 30th.

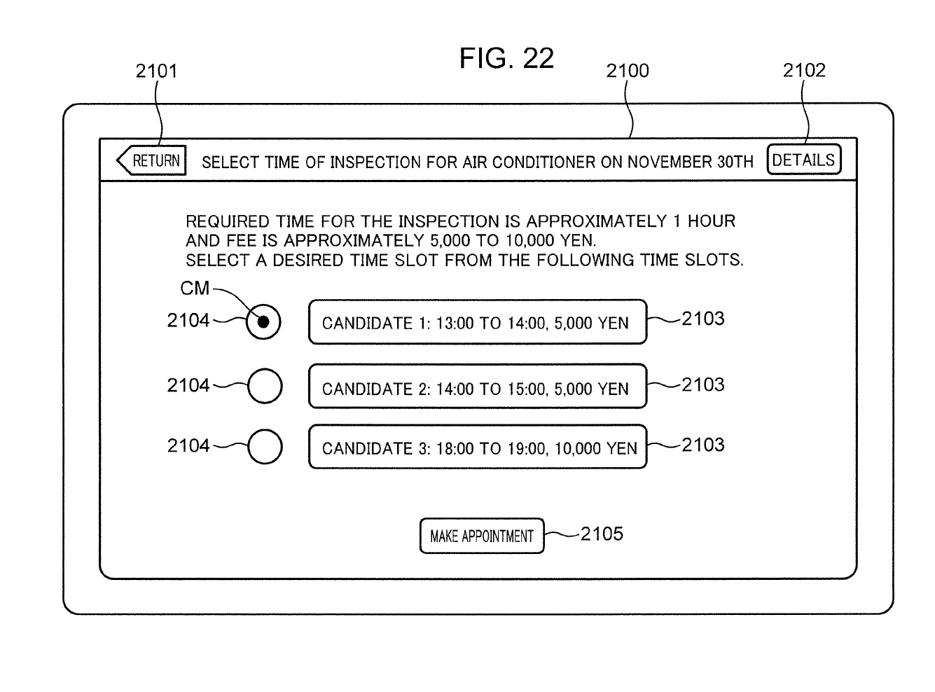

When the user taps a desired candidate appointment time 1901, an inspection time selection screen 2100 (FIG. 22) on which the candidate appointment time 1901 is initially selected is displayed on the display unit 209. For example, when the candidate appointment time 1901 of 13:00 to 14:00 is tapped, in FIG. 22, the inspection time selection screen 2100 is displayed on which a check mark CM is initially displayed in a check box 2104 corresponding to a time slot display field 2103 of 13:00 to 14:00.

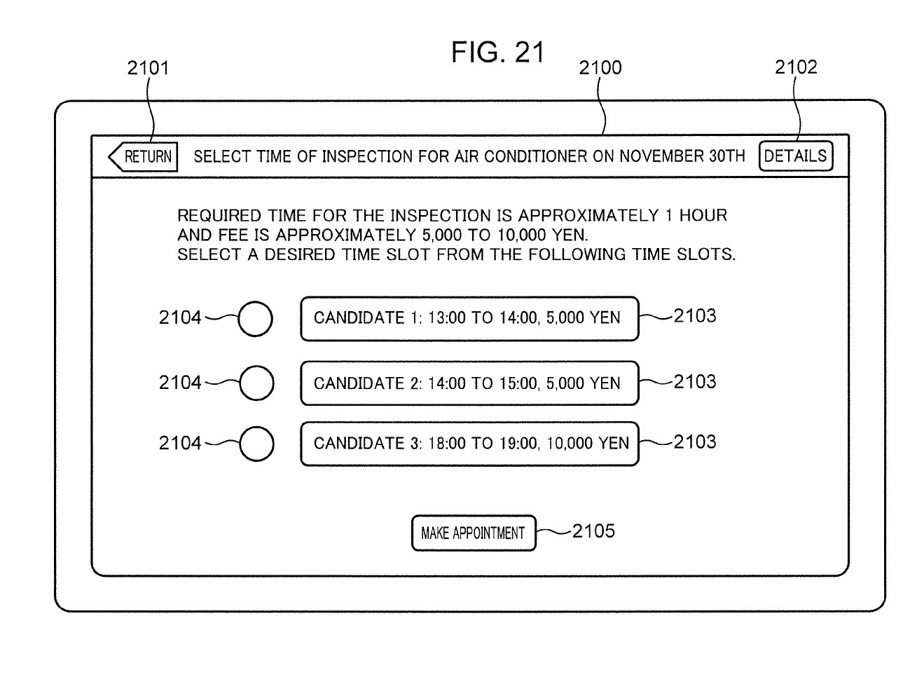

On the other hand, when the box 1605 corresponding to a candidate appointment date is tapped on the inspection date selection screens 1600 according to the first and second examples, the inspection time selection screen 2100 (FIG. 21) on which the check mark CM is not initially displayed is displayed. As a result, the user must tap the time slot display field 2103 that displays a desired candidate appointment time on the inspection time selection screen 2100 shown in FIG. 21.

Therefore, when the inspection date selection screen 1600 according to the third example is adopted, the user need no longer tap a desired candidate appointment time on the inspection time selection screen 2100 and is saved the trouble of having to do so.

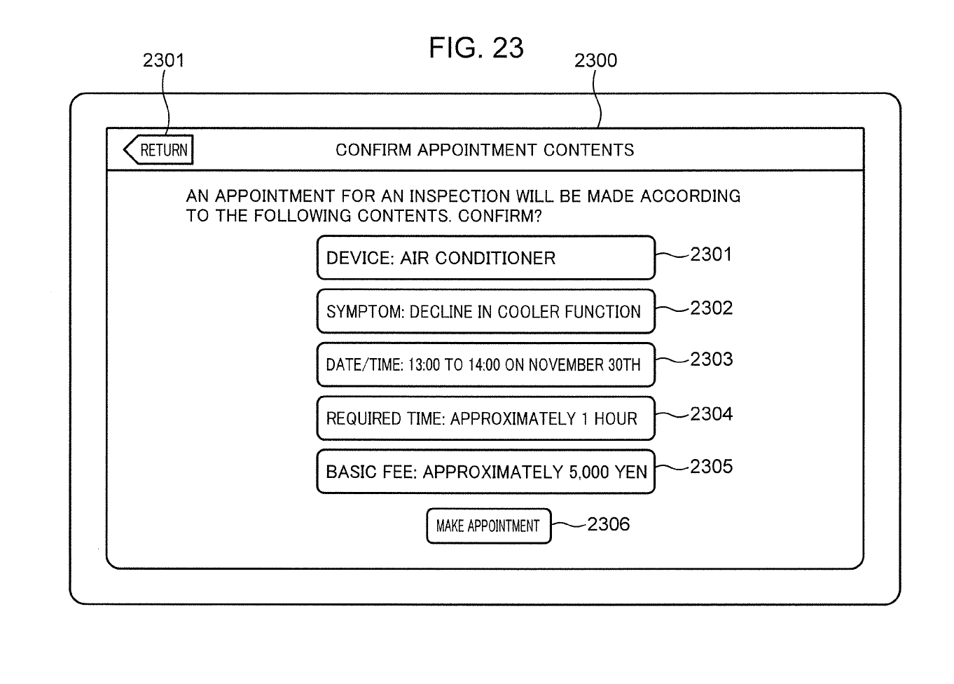

Alternatively, when the candidate appointment time 1901 is tapped on the inspection date selection screen 1600 according to the third example, the appointment screen generating unit 201 may cause a transition of the display screen to an appointment content confirmation screen 2300 (FIG. 23) without displaying the inspection time selection screen 2100. Accordingly, process steps of screen display are reduced and efficiency of the process can be improved.

In addition, in FIG. 19, when there is an excessive number of candidate appointment times 1901, the appointment screen generating unit 201 is unable to display all candidate appointment times 1901 in one box 1605 corresponding to a candidate appointment date. In such a case, the appointment screen generating unit 201 may not display the candidate appointment times 1901 in the box 1605. Specifically, the appointment screen generating unit 201 may be configured not to display the candidate appointment times 1901 in the box 1605 when the number of the candidate appointment times 1901 exceeds a prescribed upper limit value that can be displayed in the box 1605.

Alternatively, when all candidate appointment times 1901 cannot be displayed in one box 1905, the appointment screen generating unit 201 may only display candidate appointment times 1901 corresponding to the upper limit value in, for example, in an order of time slots from earliest to latest.

Moreover, when the candidate appointment times 1901 cannot be displayed in one box 1605, the appointment screen generating unit 201 may display the inspection time selection screen 2100 when the box 1605 is tapped. In addition, the appointment screen generating unit 201 may display the time slot display fields 2103 corresponding to all candidate appointment times on the inspection time selection screen 2100. Accordingly, the user can select the candidate appointment times 1901 that had been hidden on the inspection date selection screen 1600.

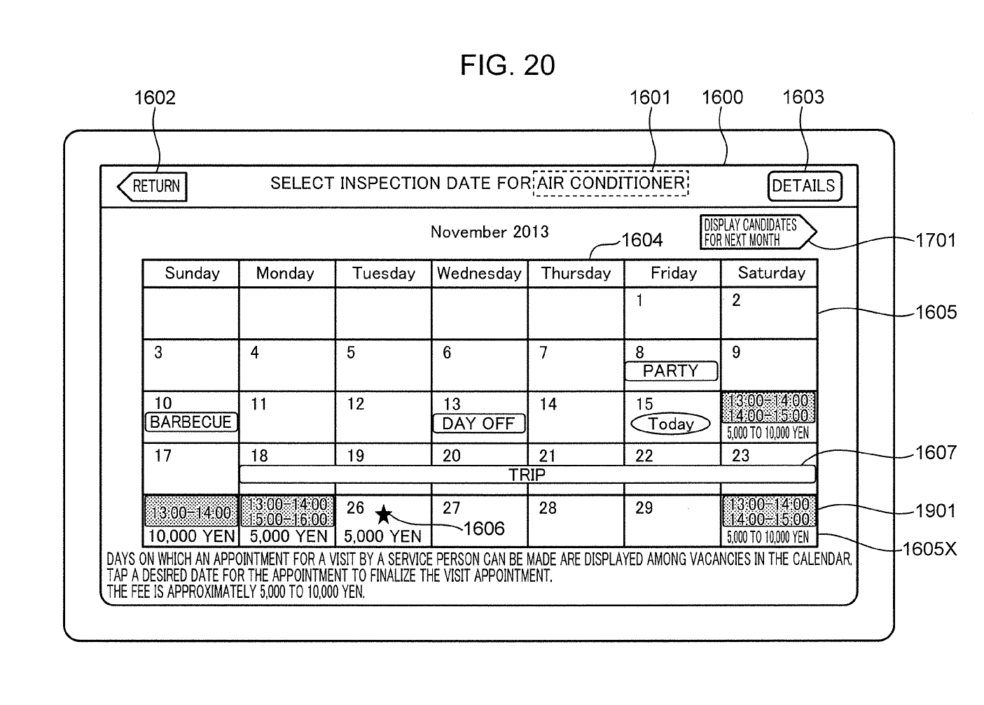

FIG. 20 is a diagram showing a fourth example of the inspection date selection screen 1600. The inspection date selection screen 1600 according to the fourth example is a combination of the inspection date selection screens 1600 according to the second and third examples. In other words, while the appointment screen generating unit 201 hides candidate appointment times 1901 when all candidate appointment times 1901 cannot be displayed in one box 1605 in the third example, the appointment screen generating unit 201 displays the candidate symbol 1606 in place of the candidate appointment times 1901 in the fourth example.

In FIG. 20, for example, since the number of candidate appointment times 1901 exceeds an upper limit value on the 26th, the appointment screen generating unit 201 displays the candidate symbol 1606 in the box 1605 corresponding to the 26th.

Moreover, on the inspection date selection screens according to the third and fourth examples, the appointment screen generating unit 201 may display the schedule icon 1607 and the candidate appointment times 1901 in different colors. Accordingly, the user can recognize the user's own schedule and candidate appointment dates in a more distinguishable manner.

FIG. 21 is a diagram showing an example of the inspection time selection screen 2100. The inspection time selection screen 2100 is a screen for having a user select a visit time of the service person. A heading that reads “Select time of inspection for air conditioner on November 30th” is displayed in an upper part of the inspection time selection screen to explicitly indicate that the screen is for selecting an inspection time. A return button 2101 that is displayed to the left of the heading is a button for returning the screen display from the inspection time selection screen 2100 to the inspection date selection screen 1600.

A detail button 2102 that is displayed to the right of the heading is a button for switching the screen display from the inspection time selection screen 2100 to the inspection detail confirmation screen 2600 (FIG. 26).

On the inspection time selection screen 2100, a text reading “Required time for the inspection is approximately 1 hour and fee is approximately 5,000 to 10,000 yen. Select a desired time slot from the following time slots.” is displayed below the heading to prompt the user to select a visit time.

One or more time slot display fields 2103 are displayed vertically aligned below the text. In addition, a check box 2104 is displayed to the left of each time slot display field 2103. The time slot display field 2103 displays candidate appointment times at which the service person can visit on the candidate appointment date that is tapped by the user on the inspection date selection screen 1600.

In the example shown in FIG. 21, since the box 1605 of November 30th has been tapped on the inspection date selection screen 1600, candidate appointment times on November 30th are displayed. In this example, three time slot display fields 2103 representing three time slots including a time slot of 13:00 to 14:00, a time slot of 14:00 to 15:00, and a time slot of 18:00 to 19:00 are displayed. In addition, candidate numbers from candidate 1 to candidate 3 are displayed in the time slot display fields 2103 in an order of time slots from earliest to latest. Furthermore, fees corresponding to candidate appointment times are displayed in the time slot display fields 2103. In this example, for example, since the time slot of 18:00 to 19:00 is a nighttime time slot, the fee is set higher than candidates 1 and 2 that represent daytime time slots.

The user selects a candidate appointment time by tapping a check box 2104 corresponding to the time slot display field 2103 that displays a desired candidate appointment time. For example, let us assume that the user taps the top check box 2104. As a result, the appointment screen generating unit 201 displays the check mark CM in the tapped check box 2104 as shown in FIG. 22.

FIG. 22 is a diagram showing the inspection time selection screen 2100 in a state in which a candidate appointment time is selected. Accordingly, the user can confirm the candidate appointment time selected by the user.

In addition, when an appointment button 2105 displayed at the bottom of the inspection time selection screen 2100 is tapped, the appointment screen generating unit 201 causes the appointment content confirmation screen 2300 (FIG. 23) to be displayed on the display unit 209. FIG. 23 is a diagram showing an example of the appointment content confirmation screen 2300. The appointment content confirmation screen 2300 is a screen for the user to confirm appointment contents.

A heading that reads “Confirm appointment contents” is displayed at the top of the appointment content confirmation screen 2300 to explicitly indicate that the screen is a screen for confirming appointment contents. A text reading “An appointment for an inspection will be made according to the following contents. Confirm?” is displayed below the heading to explicitly indicate that appointment contents are displayed in fields below.

A device display field 2301, a symptom display field 2302, a date/time display field 2303, a time display field 2304, and a fee display field 2305 are displayed as a vertical line aligned below the text. The device display field 2301 is a field that displays a type of the device 300 that is an inspection object. In this case, an air conditioner is displayed.

The symptom display field 2302 is a field that displays a symptom of the device 300 for which a malfunction has been detected. In this case, since a malfunction of the device 300 is detected due to a decline in a cooler function of the air conditioner, “decline in cooler function” is displayed.

The date/time display field 2303 is a field that displays a candidate appointment date and a candidate appointment time selected by the user. In this case, since a candidate appointment date of November 30th has been selected on the inspection date selection screen 1600 and a candidate appointment time of 13:00 to 14:00 has been selected on the inspection time selection screen 2100, “Date/time: 13:00 to 14:00 on November 30th” is displayed.

The time display field 2304 is a field for displaying a required time that is required for the inspection. In this case, “Approximately 1 hour” is displayed.

The fee display field 2305 is a field that displays a fee for the inspection. In this case, “5,000 yen” is displayed.

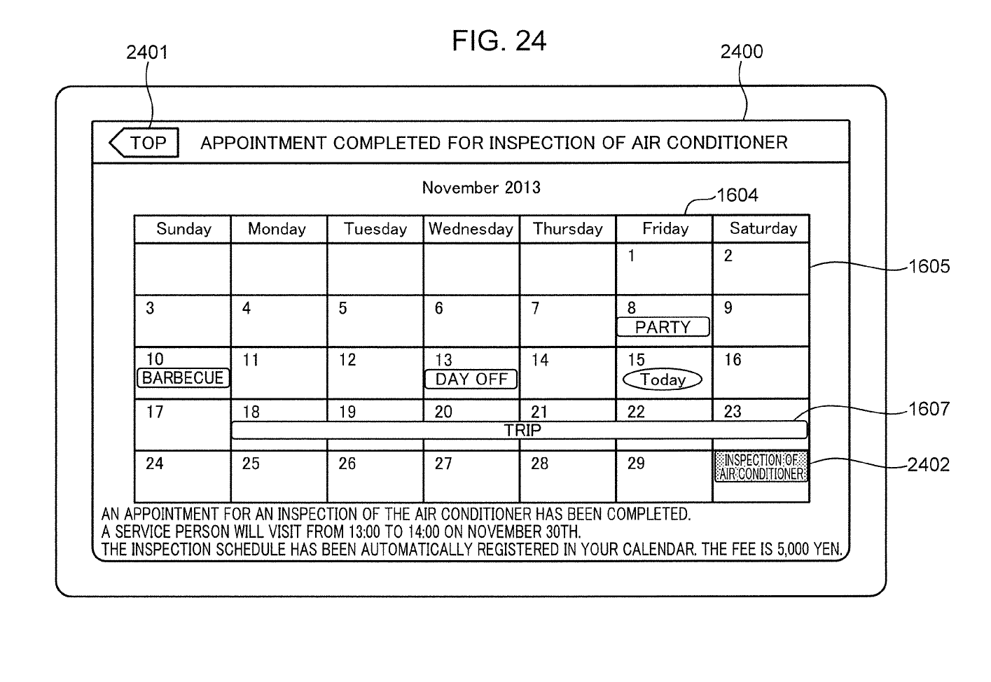

When the user consents to the appointment contents displayed on the appointment content confirmation screen 2300, the user taps the appointment button 2306. As a result, the appointment screen generating unit 201 displays an inspection appointment completion screen 2400 (FIG. 24) on the display unit 209.

FIG. 24 is a diagram showing a first example of the inspection appointment completion screen 2400. A heading that reads “Appointment completed for inspection of air conditioner” is provided in an upper part of the inspection appointment completion screen 2400 to explicitly indicate that the screen is a screen for notifying the completion of an appointment.

The calendar data display field 1604 is displayed on the inspection appointment completion screen 2400 in a similar manner to the inspection date selection screen 1600. An appointment icon 2402 indicating a visit date for which an appointment has been made is displayed in the box 1605 corresponding to the visit date for which the user has made an appointment in the calendar data display field 1604. In the example shown in FIG. 24, “Inspection of air conditioner” is displayed on the appointment icon 2402 to explicitly indicate that the device 300 which is an inspection object is an air conditioner. In addition, in the example shown in FIG. 24, since the visit date for which the user has made an appointment is the 30th, the appointment icon 2402 is displayed in the box 1605 corresponding to the 30th.

Furthermore, since there is no need to notify the user of a candidate appointment date on the inspection appointment completion screen 2400, the candidate symbol 1606 and the candidate appointment time 1901 which represent a candidate appointment date and which are displayed on the inspection date selection screen 1600 are hidden on the inspection appointment completion screen 2400. Accordingly, the user can confirm a visit date for which an appointment has been made at a glance with the appointment icon 2402.

On the other hand, the schedule icon 1607 which is displayed on the inspection date selection screen 1600 is also displayed on the inspection appointment completion screen 2400. Therefore, the user can confirm his/her own schedule on the inspection appointment completion screen 2400 without having to separately start up a calendar application.

Moreover, on the inspection appointment completion screen 2400, the appointment screen generating unit 201 may display the schedule icon 1607 and the appointment icon 2402 in different colors. Accordingly, the user can recognize the user's own schedule and the visit date in a more distinguishable manner.

On the inspection appointment completion screen 2400, a text reading “An appointment for an inspection of the air conditioner has been completed. A service person will visit from 13:00 to 14:00 on November 30th. The inspection schedule has been automatically registered in your calendar. The fee is 5,000 yen.” informing that an appointment has been completed is displayed below the calendar data display field 1604. Accordingly, completion of the appointment is explicitly indicated to the user.

Moreover, in the calendar data display field 1604 displayed on the inspection date selection screen 1600 and the inspection appointment completion screen 2400 displayed above, the user can also register a schedule. In this case, for example, when the user taps the box 1605 corresponding to a desired date in the calendar data display field 1604, the appointment screen generating unit 201 causes a screen for inputting details of a schedule to be displayed. Subsequently, the appointment screen generating unit 201 notifies the calendar data managing units 107 and 206 of the information input using the screen. Accordingly, the schedule input by the user through the calendar data display field 1604 is registered in the calendar data storing units 108 and 207.

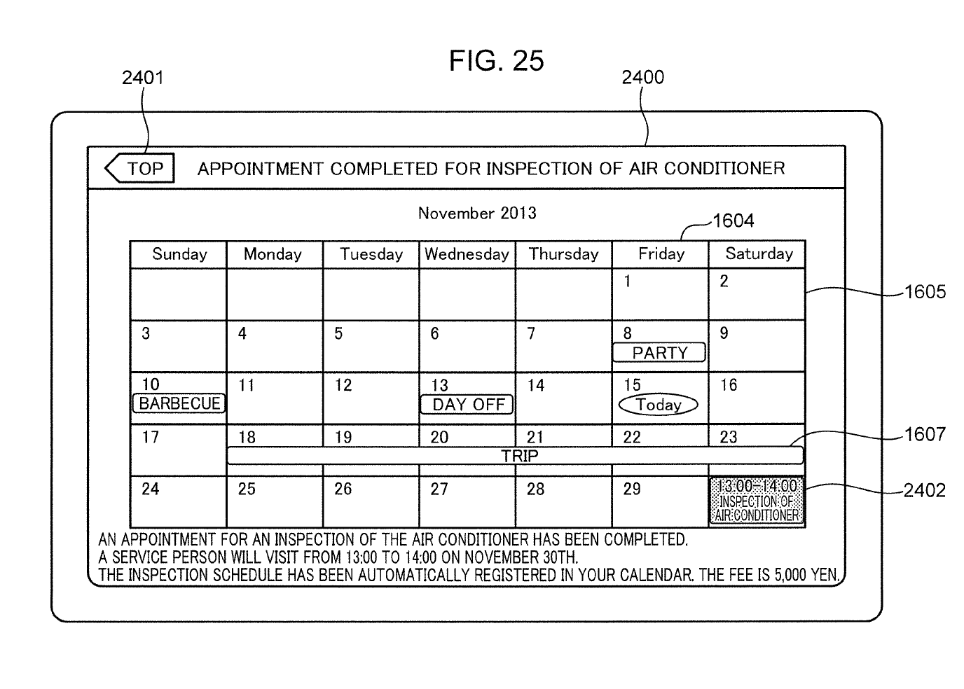

FIG. 25 is a diagram showing a second example of the inspection appointment completion screen 2400. A difference from the first example is that a visit time is displayed on the appointment icon 2402. In the example shown in FIG. 25, since the time slot of 13:00 to 14:00 is the visit time, “13:00 to 14:00” is displayed in addition to a text reading “Inspection of conditioner” on the appointment icon 2402. Accordingly, the user can confirm a visit time in addition to a visit date with the appointment icon 2402.

FIG. 26 is a diagram showing an example of the inspection detail confirmation screen 2600. The inspection detail confirmation screen 2600 is a screen that is displayed when the detail button 1603 is tapped on the inspection date selection screen 1600 or when the detail button 2102 is tapped on the inspection time selection screen 2100. In addition, the inspection detail confirmation screen 2600 is a screen for having the user confirm details of inspection contents.

A heading that reads “Details of inspection contents” is displayed at the top of the inspection detail confirmation screen 2600 to explicitly indicate that the screen is a screen for confirming details of inspection contents. A text reading “An inspection according to the following contents is recommended.” is displayed below the heading to explicitly indicate that details of inspection contents are displayed in fields below.

A device display field 2602, a symptom display field 2603, a time display field 2604, and a fee display field 2605 are displayed below the text. These fields display the same contents as those displayed in the fields with the same names on the appointment content confirmation screen 2300.

Through the inspection detail confirmation screen 2600, information for making a determination on whether or not to carry out an inspection can be presented to the user.

FIG. 27 is a diagram showing an example of the symptom selection screen 2700. The symptom selection screen 2700 is either a screen for causing the user to select an inspection with respect to a symptom that differs from the symptom for which an inspection is recommended on the symptom confirmation screen 1500 or a screen for causing the user to select a symptom for which an inspection is to be performed on the device 300 that is functioning normally on the top screen 3000. Therefore, the symptom selection screen 2700 is displayed when the symptom selection button 1507 is tapped on the symptom confirmation screen 1500 or when an inspection button 3002 is tapped on the top screen 3000.

A heading that reads “Select symptom” is displayed at the top of the symptom selection screen 2700 to explicitly indicate that the screen is a screen for selecting a symptom that is an inspection object.

A return button 2701 is displayed to the left of the heading. When the return button 2701 is tapped, the appointment screen generating unit 201 switches the screen display to a previous screen (the symptom confirmation screen 1500 or the top screen 3000).

A text reading “Select a symptom.” is displayed below the heading to prompt the user to select a symptom. A device display field 2702 and a symptom selection field 2703 are displayed below the text. The device display field 2702 displays the name of the device 300 for which a malfunction has been detected in the case of a transition from the symptom confirmation screen 1500 and displays a name of the device 300 selected by the user on the top screen 3000 in the case of a transition from the top screen 3000.

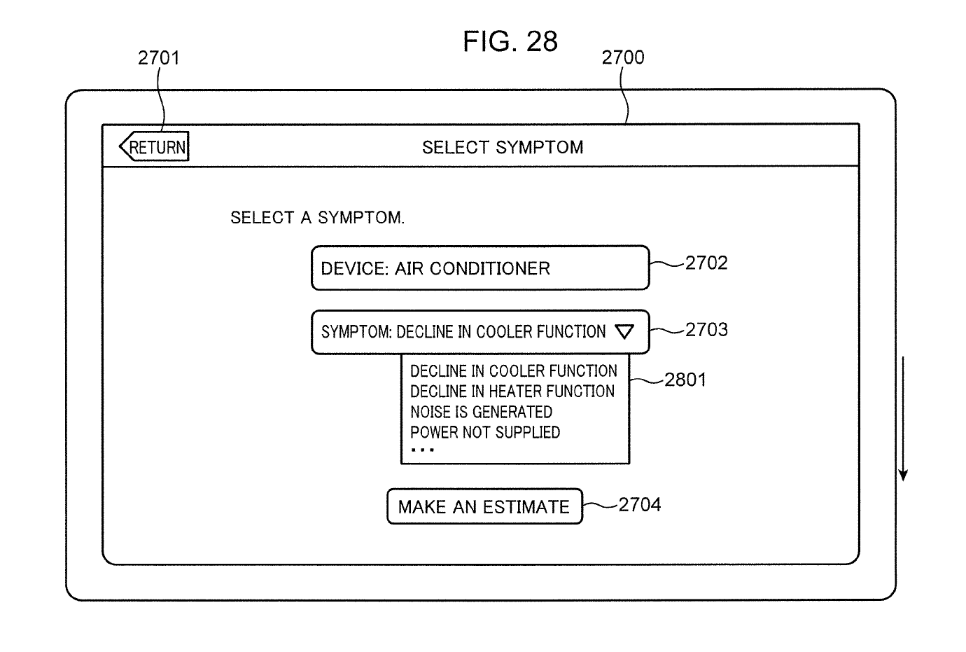

The symptom selection field 2703 is a field for having a user select a symptom that is an inspection object. When the symptom selection field 2703 is tapped by the user, the appointment screen generating unit 201 displays a pull down menu 2801 which displays symptoms as a list as shown in FIG. 28. FIG. 28 shows the symptom selection screen 2700 on which the pull down menu 2801 is displayed. In the example shown in FIG. 28, candidates of symptoms to be inspection objects such as a decline in cooler function and a decline in heater function are displayed as a list. Moreover, while symptoms with respect to an air conditioner are displayed as a list in the pull down menu 2801 in FIG. 28, when another device 300 is selected, symptoms corresponding to the selected device 300 are to be displayed as a list.

In addition, in a state shown in FIG. 27 prior to the pull down menu 2801 being displayed, a default symptom is displayed in the symptom selection field 2703. For example, when a transition is made from the symptom confirmation screen 1500, a symptom for which a malfunction has been detected is displayed as a default symptom in the symptom selection field 2703. On the other hand, when a transition is made from the top screen 3000, for example, a symptom that is displayed at the top of the pull down menu 2801 is displayed as a default symptom in the symptom selection field 2703.

When an estimate button 2704 with a description of “make an estimate” is tapped by the user on the symptom selection screen 2700, the appointment screen generating unit 201 switches the screen display from the symptom selection screen 2700 to an inspection estimation screen 2900.

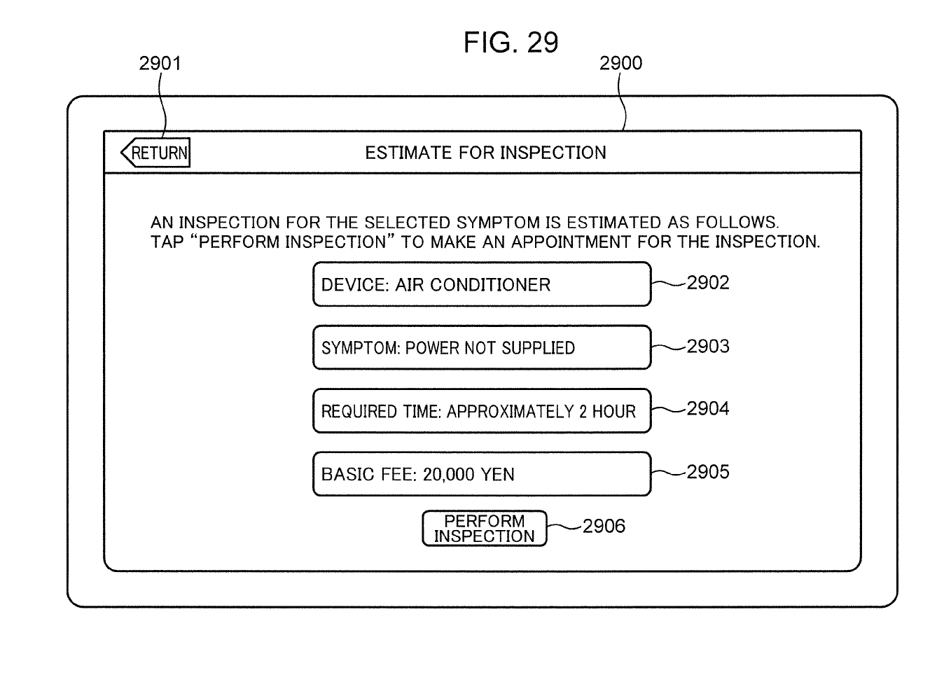

FIG. 29 is a diagram showing an example of the inspection estimation screen 2900. A header reading “Estimate for inspection” is displayed at the top of the inspection estimation screen 2900 to explicitly indicate that the screen is a screen for displaying an estimate for the inspection.

A return button 2901 is displayed to the left of the heading. When the return button 2901 is tapped, the appointment screen generating unit 201 returns the screen display from the inspection estimation screen 2900 to the symptom selection screen 2700.

A text reading “An inspection for the selected symptom is estimated as follows. Tap “perform inspection” to make an appointment for the inspection.” is displayed below the heading to explicitly indicate that contents of an estimate are displayed in fields below.

A device display field 2902, a symptom display field 2903, a time display field 2904, and a fee display field 2905 are displayed as a vertical line below the text. These fields display the same contents as those displayed in the fields with the same names on the inspection detail confirmation screen 2600.

In the example shown in FIG. 29, since a symptom of “power not supplied” is selected from the pull down menu 2801, “power not supplied” is displayed in the symptom display field 2903. In addition, since the time required by an inspection with respect to this symptom is approximately two hours, “Approximately 2 hours” is displayed in the time display field 2904. Furthermore, since a fee with respect to the symptom is 20,000 yen, “20,000 yen” is displayed in the fee display field 2905.

An inspection button 2906 with the description “perform inspection” is displayed at the bottom of the inspection estimation screen 2900. The inspection button 2906 is a button that is tapped by the user when the user consents to the contents of the estimate displayed on the inspection estimation screen 2900. When the inspection button 2906 is tapped, the appointment screen generating unit 201 displays the inspection date selection screen 1600 on the display unit 209.

FIG. 30 is a diagram showing an example of the top screen 3000. The top screen 3000 is a top screen of the appointment application and is a screen which is displayed on the display unit 209 when the appointment application icon 1301 is tapped on the basic screen 1300.

A heading that reads “Inspection appointment: Top” is displayed in an upper part of the top screen 3000 to explicitly indicate that the screen is a top screen of the appointment application. Characters reading “device list” are displayed below the heading to explicitly indicate that a list of devices 300 that can be inspected is displayed below.

Device display fields 3001 indicating devices 300 which are installed in the house of the user having started up the appointment application and which can be inspected are displayed vertically aligned below the characters. In the example shown in FIG. 30, the device display field 3001 is displayed with devices 300 including an air conditioner, a lighting fixture, a refrigerator, and a washing machine.

A name of the device 300, a symptom of the device 300, and the inspection button 3002 are displayed in the device display field 3001. In the example shown in FIG. 30, since a decline in a cooler function of an air conditioner is detected, “decline in cooler function” is displayed as a symptom of the device 300 in the device display field 3001. Since symptoms of malfunctions are not detected for the other device 300 are not detected, “normal” is displayed as the symptoms of the devices 300 in the device display field 3001.

A next page button 3003 is displayed in a lower part of the top screen 3000. When the next page button 3003 is tapped, the appointment screen generating unit 201 displays the top screen 3000 for a second page which displays a list of device display fields 3001 representing devices 300 that could not be displayed on the first page.

When the inspection button 3002 corresponding to the normal device 300 is tapped, the appointment screen generating unit 201 displays the symptom selection screen 2700 on the display unit 209. The symptom selection screen 2700 is as described earlier. On the other hand, when the inspection button 3002 corresponding to the device 300 for which a malfunction has been detected is tapped, the appointment screen generating unit 201 displays the symptom confirmation screen 1500 on the display unit 209.

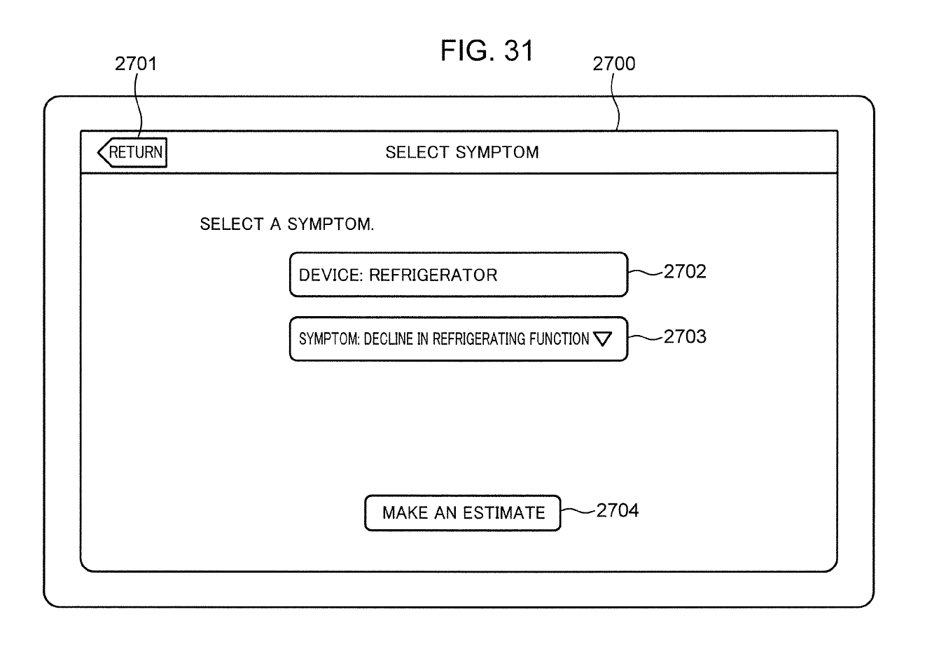

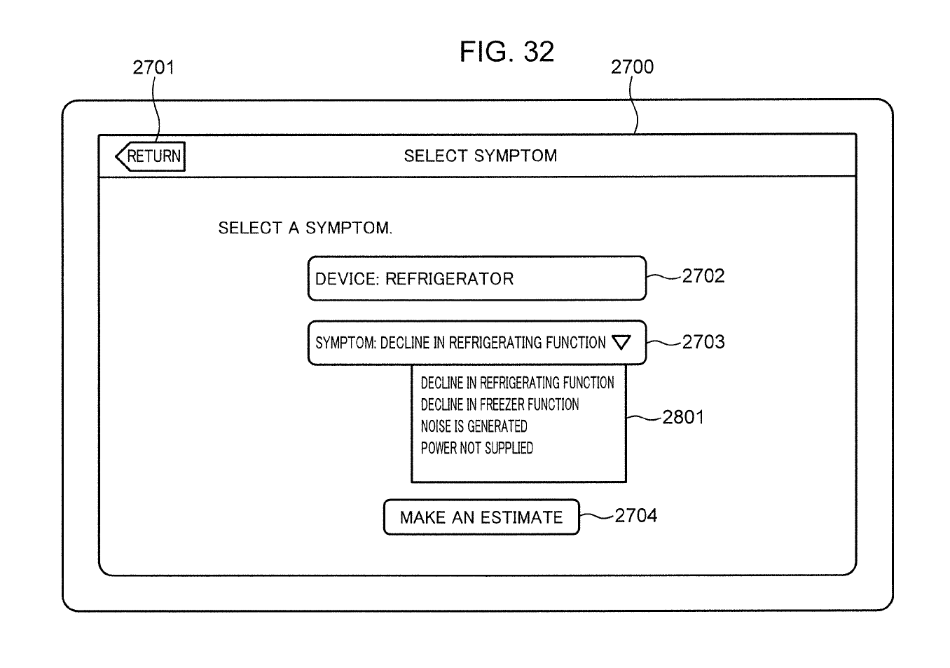

For example, let us assume that the inspection button 3002 for a refrigerator is tapped on the top screen 3000 shown in FIG. 30. As shown in FIG. 31, the appointment screen generating unit 201 displays the symptom selection screen 2700 of the refrigerator on the display unit 209. FIG. 31 is a diagram showing an example of the symptom selection screen 2700 of the refrigerator. While “air conditioner” is displayed in the device display field 2702 on the symptom selection screen 2700 of an air conditioner, “refrigerator” is displayed in the device display field 2702 on the symptom selection screen 2700 of the refrigerator. In addition, symptoms with respect to the refrigerator are displayed as a list in the symptom selection field 2703 on the symptom selection screen 2700 of the refrigerator. When the symptom selection field 2703 is tapped, the appointment screen generating unit 201 displays a pull down menu 2801 which displays symptoms of the refrigerator as a list as shown in FIG. 32.

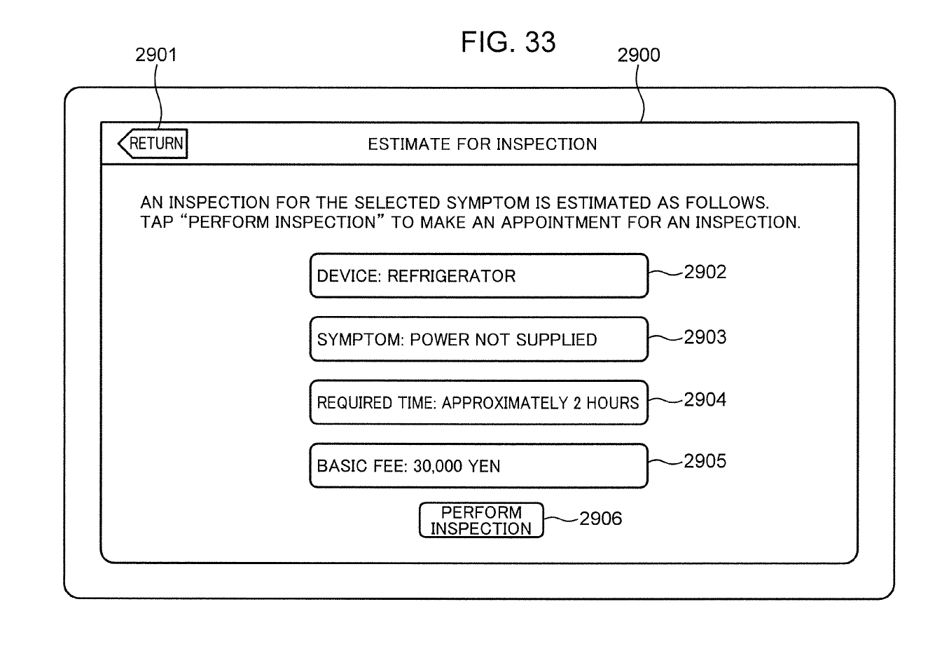

When a desired symptom is selected from the pull down menu 2801 and the estimate button 2704 is tapped, the appointment screen generating unit 201 displays the inspection estimation screen 2900 shown in FIG. 33. FIG. 33 is a diagram showing an example of the inspection estimation screen 2900 of a refrigerator. The inspection estimation screen 2900 of the refrigerator is provided with the device display field 2902 to the fee display field 2905 in a similar manner to the inspection estimation screen 2900 of the air conditioner. In FIG. 33, “refrigerator” is displayed in the device display field 2902. Otherwise, the inspection estimation screen 2900 is the same as the inspection estimation screen 2900 of an air conditioner that is shown in FIG. 29.

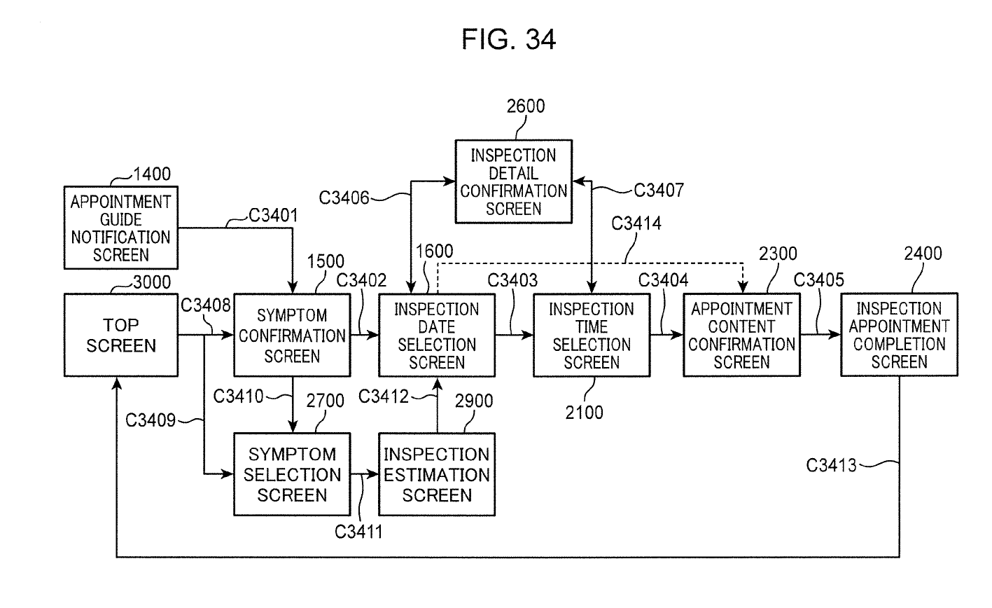

FIG. 34 is a diagram showing a screen flow according to the present disclosure. In the present disclosure, there are two start points in the screen flow. One start point is the appointment guide notification screen 1400 and the other start point is the top screen 3000. The appointment guide notification screen 1400 is displayed when a malfunction of the device 300 is detected and the top screen 3000 is displayed when the user taps the appointment application icon 1301 on the basic screen 1300.

When the screen control unit 204 detects that the device name 1401 has been tapped on the appointment guide notification screen 1400, the appointment screen generating unit 201 switches the screen display to the symptom confirmation screen 1500 (C3401). When the screen control unit 204 detects that the inspection button 1506 has been tapped on the symptom confirmation screen 1500, the appointment screen generating unit 201 switches the screen display to the inspection date selection screen 1600 (C3402).

When the screen control unit 204 detects that the box 1605 representing a candidate appointment date has been tapped on the inspection date selection screen 1600, the appointment screen generating unit 201 switches the screen display to the inspection time selection screen 2100 (C3403). When the screen control unit 204 detects that the time slot display field 2103 has been tapped on the inspection time selection screen 2100, the appointment screen generating unit 201 switches the screen display to the appointment content confirmation screen 2300 (C3404).

When the screen control unit 204 detects that the appointment button 2306 has been tapped on the appointment content confirmation screen 2300, the appointment screen generating unit 201 switches the screen display to the inspection appointment completion screen 2400 (C3405). When the screen control unit 204 detects that the detail button 1603 has been tapped on the inspection date selection screen 1600, the appointment screen generating unit 201 switches the screen display to the inspection detail confirmation screen 2600 (C3406). In this case, when the screen control unit 204 detects that the return button 2601 has been tapped on the inspection detail confirmation screen 2600, the appointment screen generating unit 201 returns the screen display to the inspection date selection screen 1600 (C3406).

In addition, when the screen control unit 204 detects that the detail button 2102 has been tapped on the inspection time selection screen 2100, the appointment screen generating unit 201 switches the screen display to the inspection detail confirmation screen 2600 (C3407). In this case, when the screen control unit 204 detects that the return button 2601 has been tapped on the inspection detail confirmation screen 2600, the appointment screen generating unit 201 returns the screen display to the inspection time selection screen 2100 (C3407).

When the screen control unit 204 detects that the inspection button 3002 of the device 300 for which a malfunction has been detected has been tapped on the top screen 3000, the appointment screen generating unit 201 switches the screen display to the symptom confirmation screen 1500 (C3408).

On the other hand, when the screen control unit 204 detects that the inspection button 3002 of the device 300 for which a malfunction has not been detected is tapped on the top screen 3000, the appointment screen generating unit 201 switches the screen display to the symptom selection screen 2700 (C3409).

When the screen control unit 204 detects that the symptom selection button 1507 has been tapped on the symptom confirmation screen 1500, the appointment screen generating unit 201 switches the screen display to the symptom selection screen 2700 (C3410).

When the screen control unit 204 detects that the estimate button 2704 has been tapped on the symptom selection screen 2700, the appointment screen generating unit 201 switches the screen display to the inspection estimation screen 2900 (C3411). When the screen control unit 204 detects that the inspection button 2906 has been tapped on the inspection estimation screen 2900, the appointment screen generating unit 201 switches the screen display to the inspection date selection screen 1600 (C3412).

When the screen control unit 204 detects that the top button 2401 has been tapped on the inspection appointment completion screen 2400, the appointment screen generating unit 201 switches the screen display to the top screen 3000 (C3413).

Moreover, when the screen control unit 204 detects that the candidate appointment time 1901 has been tapped on the inspection date selection screen 1600, the appointment screen generating unit 201 may bypass the inspection time selection screen 2100 and display the appointment content confirmation screen 2300 (C3414).

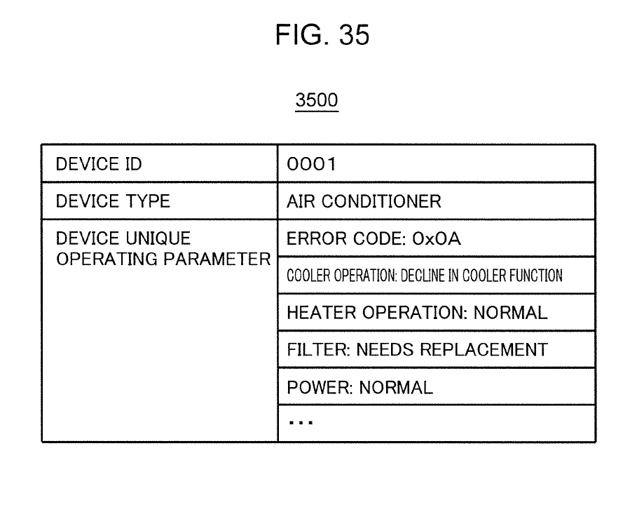

FIG. 35 is a diagram showing an example of a data configuration of a device state 3500. The device state 3500 (an example of state information) is data indicating a state of the device 300. The device state 3500 is periodically transmitted from the device 300 to the appointment terminal 200, the appointment server 100, or the device management server 400 which analyzes the state of the device 300. In addition, the device state 3500 is stored in plurality in the appointment terminal 200, the appointment server 100, or the device management server 400 and is used when the appointment terminal 200, the appointment server 100, or the device management server 400 analyzes the state of the device 300.

The device state 3500 includes a “device ID”, a “device type”, and a “device unique operating parameter”. The device ID is an identifier that is unique to the device 300. For the “device ID”, a different symbol string is adopted for each device 300 even in cases where the devices 300 are of a same type. For example, a serial number of the device 300 can be adopted.

The “device type” is information indicating a type of the device 300. As the “device type”, for example, a symbol string indicating a type of an electric appliance such as a television set, an air conditioner, and a refrigerator can be adopted. Alternatively, a product number for specifying a product name of a device may be adopted as the “device type”.

The “device unique operating parameter” is a parameter indicating a state of the device 300. Since FIG. 35 concerns the device state 3500 of an air conditioner, parameters indicating a state of an air conditioner are shown. In the example shown in FIG. 35, the “device unique operating parameter” includes parameters indicating a state of an air conditioner such as an “error code”, a “cooler operation”, a “heater operation”, a “filter”, and “power”.

The “error code” is a parameter indicating contents of a breakdown that has occurred in the device 300 itself. The “cooler operation” is a parameter regarding a cooler function of the air conditioner. In this case, since the cooler function has declined, “decline in cooler function” is given as the parameter “cooler operation”. Moreover, if the cooler function is normal, “normal” is to be given as the parameter “cooler operation”.

The “heater operation” is a parameter regarding a heater function of the air conditioner. In this case, since the heater function is normal, “normal” is given as the parameter “heater operation”. The “filter” is a parameter regarding a filter of the air conditioner. In this case, since the filter is worn down, “needs replacement” is given as the parameter “filter”. The “power” is a parameter regarding a power supply function of the air conditioner. In this case, since the power supply function is normal, “normal” is given as the parameter “power”. Moreover, if the power supply function is malfunctioning, “malfunctioning” is to be given as the parameter “power”.

Moreover, while FIG. 35 concerns the device state 3500 of an air conditioner and therefore adopts the illustrated parameters as the “device unique operating parameter”, in a case of a different device 300, parameters which differs from those illustrated and which correspond to the different device 300 are to be adopted.

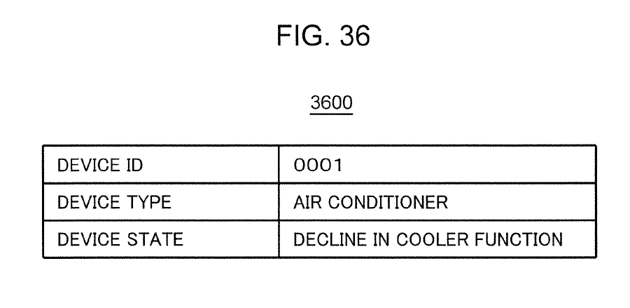

FIG. 36 is a diagram showing an example of a data configuration of an analysis result 3600 of a state of the device 300. The analysis result 3600 is generated by the appointment server 100 or the device management server 400 and transmitted to the appointment terminal 200. The analysis result 3600 includes a “device ID”, a “device type”, and a “device state”. As the “device ID”, the “device type”, and the “device state”, same symbol systems as data with the same names in the device state 3500 are adopted. The example shown in FIG. 35 represents the analysis result 3600 of a case where the appointment server 100 or the device management server 400 determines that a cooler function of an air conditioner with a “device ID” of “0001” has declined. Therefore, the analysis result 3600 shown in FIG. 36 includes “0001” as the “device ID”, “air conditioner” as the “device type”, and “decline in cooler function” as the “device state”.

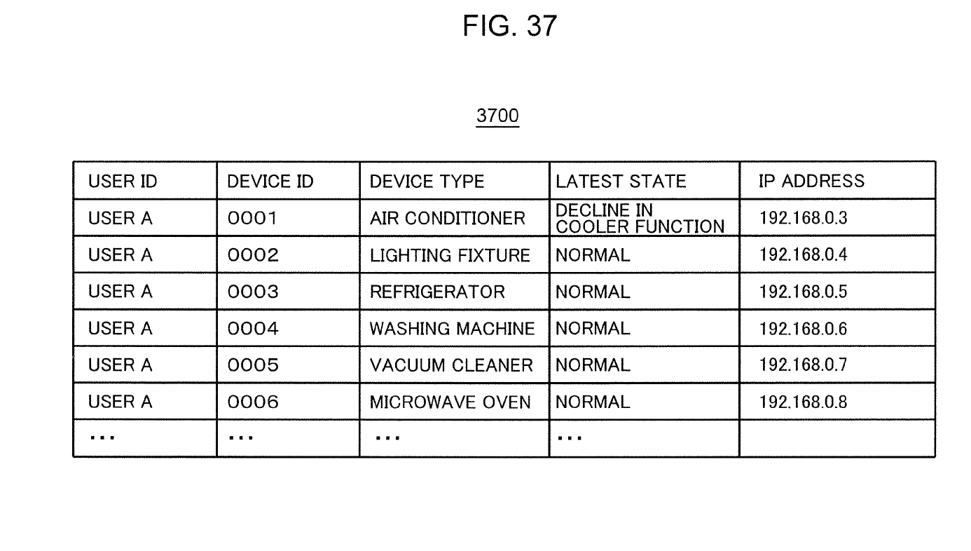

FIG. 37 is a diagram showing an example of a data configuration of the device list table 3700 that is managed by the appointment terminal 200. A device state indicating a latest state of the device 300 is registered in the device list table 3700. The device list table 3700 is, for example, stored in the storing unit 203 of the appointment terminal 200 and managed by the appointment terminal 200. In addition, the device list table 3700 is used when the appointment screen generating unit 201 displays the top screen 3000. Moreover, in the appointment systems according to the second and fourth examples which include the device management server 400, the device management server 400 also includes the device list table 3700. In this case, the device list table 3700 is stored in the storing unit 401 and managed by the device managing unit 402.

A device state of one device 300 is registered in one record in the device list table 3700. A registered device state includes a “user ID”, a “device ID”, a “device type”, a “latest state”, and an “IP address”.

The “user ID” is a user ID of a user owning the device 300 of concern. The “user ID” is an identifier for individually identifying each user which is registered by the user in the appointment server 100 in advance. The “device ID” is a device ID of the device 300 of concern. The “device type” is a device type of the device 300 of concern. Moreover, as the “device ID” and the “device type”, same symbol systems as the data with the same names in the device state 3500 are adopted.

The “latest state” indicates a latest state of the device 300 of concern. As the “latest state”, for example, the “device state” of the latest analysis result 3600 among the analysis results 3600 received by the appointment terminal 200 with respect to one device 300 is adopted.

The “IP address” represents an IP address (communication address) of the device 300 of concern. The “IP address” is used by the appointment terminal 200 to communicate with the device 300.

For example, it is registered in the record in the first row that an air conditioner with a device ID of “0001” which is owned by a user A is currently experiencing a decline in its cooler function and that the IP address of the air conditioner is “192.168.0.3”.

Moreover, since the device list table 3700 shown in FIG. 37 is managed by the appointment terminal 200, only device states with respect to user owning the appointment terminal 200 are registered.

FIG. 38 is a diagram showing an example of a data configuration of the device list table 3700 that is managed by the device management server 400. Moreover, when a configuration that does not include the device management server 400 is adopted, the appointment server 100 is to manage the device list table 3700 shown in FIG. 38. The device list table 3700 shown in FIG. 38 differs from the device list table 3700 shown in FIG. 37 in that, since the device list table 3700 is managed by the device management server 400, device information of devices 300 owned by a plurality of users with different user IDs is registered. In other words, the device management server 400 manages device states of devices 300 respectively owned by a plurality of users. Therefore, device states of devices 300 owned by respective users having registered as users in the device management server 400 are registered in the device list table 3700 shown in FIG. 38.

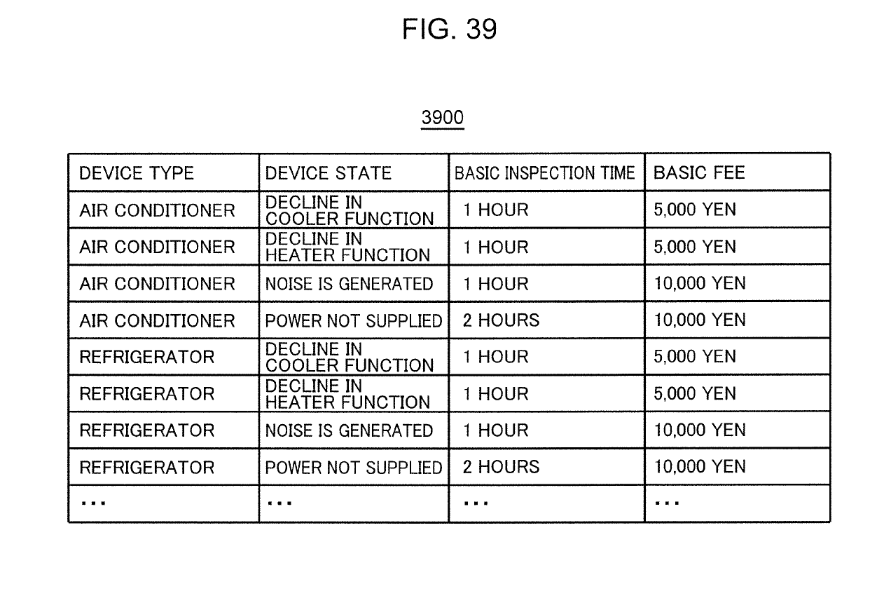

FIG. 39 is a diagram showing an example of a data configuration of the symptom table 3900. The symptom table 3900 is a table in which an inspection time, a fee, and the like with respect to each inspection are registered. One inspection with respect to one device 300 is allocated to one record.

Specifically, a “device type”, a “device state”, a “basic inspection time”, and a “basic fee” are registered in the symptom table 3900.

As the “device type”, a same symbol system as the “device type” in the device state 3500 is adopted. A device state indicating a state of a function of the device 300 that is an inspection object is registered in the “device state”. The “device state” is the same as the “device state” in the analysis result 3600.

The “basic inspection time” indicates a standard inspection time by a service person with respect to the inspection of concern. For example, “1 hour” is registered as the basic inspection time with respect to an inspection of a decline in a cooler function of an air conditioner.

A fee with respect to an inspection of concern is registered in the “basic fee”. For example, “5,000 yen” is registered as the basic fee with respect to an inspection of a cooler function of an air conditioner.

FIG. 40 is a diagram showing an example of a data configuration of the calendar plan list 4000. The calendar plan list 4000 (an example of schedule information) is data in which schedules input by the user using an appointment application or a calendar application are registered. The calendar plan list 4000 is used when the appointment screen generating unit 201 generates the calendar data display field 1604 described earlier. Moreover, the calendar plan list 4000 is also used when the calendar screen generating unit 205 displays a calendar screen. In addition, the calendar plan list 4000 is provided for each user.

Specifically, the calendar plan list 4000 is data in which one or more records are allocated to one plan and in which a “day”, a “time”, and “plan contents” are registered. The “day” represents the day on which a plan of concern is to be carried out. The “time” represents the time at which the plan of concern is to be carried out. The “plan contents” represent contents of the plan of concern.

For example, a plan for a “party” to be held between 13:00 and 18:00 on Nov. 8, 2013 is registered in the record in the first row. Moreover, since the plan of the “party” ends on the same day, one record is allocated to the plan.

On the other hand, while a plan of a “trip” registered in the fourth to ninth rows is one plan, since the plan extends over six days, six records are allocated.

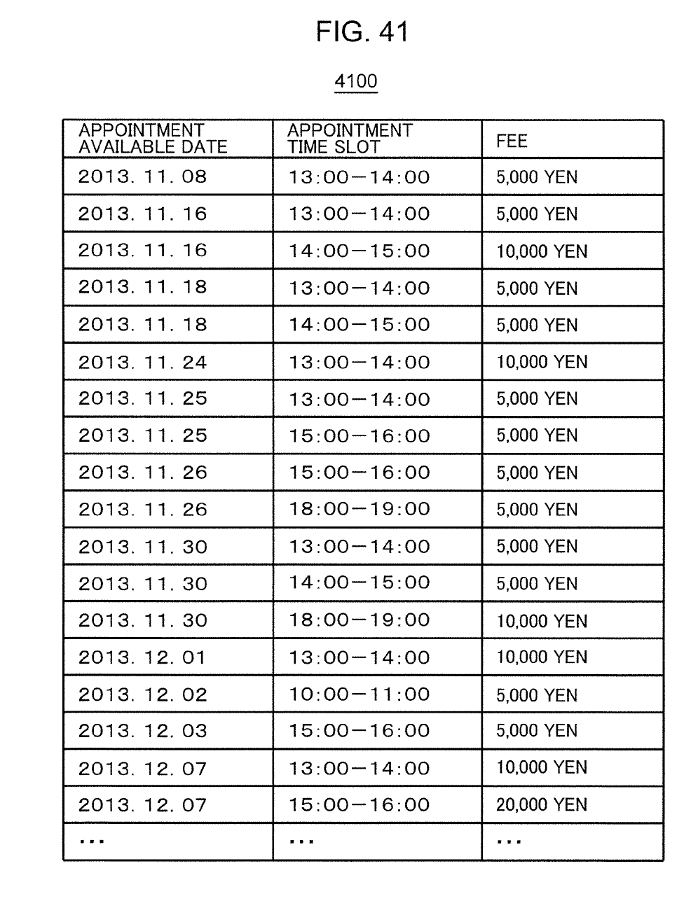

FIG. 41 is a diagram showing an example of a data configuration of an appointment available date list 4100. The appointment available date list 4100 is data in which appointment available dates on which a service person can visit are registered and is data that is created in advance by a manufacturer or a service provider to which the service person belongs.

Specifically, the appointment available date list 4100 is data in which one record is allocated to one appointment available date/time and in which an “appointment available date”, an “appointment time slot”, and a “fee” are registered.

The “appointment available date” represents an appointment available date/time of concern. The “appointment time slot” represents a time slot of the appointment available date/time of concern. A fee as of the appointment available date/time of concern is registered in the “fee”.

For example, an appointment available date/time between 13:00 and 14:00 on Nov. 8, 2013 with a fee of 5,000 yen is registered in the record in the first row.

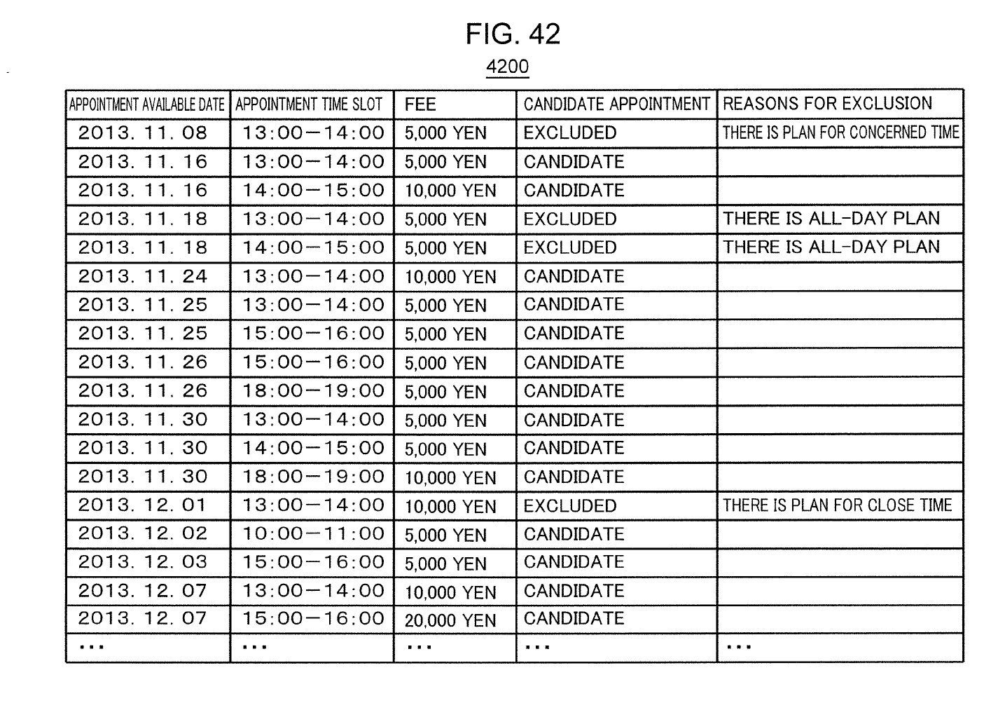

FIG. 42 is a diagram showing an example of a data configuration of a candidate appointment date list 4200. The candidate appointment date list 4200 is data which is created based on the appointment available date list 4100 and in which candidate appointment dates/times of a user corresponding to the appointment available date list 4100 are registered. The candidate appointment date list 4200 is created for each user by the candidate appointment date selecting unit 202 by referring to the calendar plan list 4000 and the appointment available date list 4100 of each user.

The candidate appointment date list 4200 is data in which one record is allocated to one appointment available date/time. An “appointment available date”, an “appointment time slot”, a “fee”, a “candidate appointment”, and “reasons for exclusion” are registered in the candidate appointment date list 4200. The “appointment available date”, the “appointment time slot”, and the “fee” are the same as the data with the same names in the appointment available date list 4100.

In the “candidate appointment”, “candidate” is registered if an appointment available date/time of concern is extracted as a candidate appointment date/time and “excluded” is registered if the appointment available date/time of concern is excluded from the candidate appointment dates/times. The “reasons for exclusion” represent reasons for exclusion in a case where an appointment available date/time of concern is excluded from the candidate appointment dates.

Hereinafter, assuming that the calendar plan list 4000 belongs to a user A, an extraction process of a candidate appointment date/time of the user A will be described.

For example, “13:00 to 14:00” on “Nov. 8, 2013” is registered as an appointment available date/time in a first row of the candidate appointment date list 4200. On the other hand, a plan of “party” is registered in the calendar plan list 4000 for the same time slot. Therefore, the candidate appointment date selecting unit 202 excludes the appointment available date/time of the first row from the candidate appointment dates/times with respect to the user A. Therefore, “excluded” is registered as the “candidate appointment” in the record of the first row in the candidate appointment date list 4200 and “there is plan for concerned time” is registered as the “reasons for exclusion”. At this point, if a plan of the user is registered in a part of a time slot indicated by an appointment available date/time, the candidate appointment date selecting unit 202 may exclude the appointment available date/time from the candidate appointment dates/times.

For example, “13:00 to 14:00” on “Nov. 16, 2013” is registered as an appointment available date/time in a second row of the candidate appointment date list 4200. On the other hand, there are no plans registered in the calendar plan list 4000 for the same time slot. Therefore, the candidate appointment date selecting unit 202 extracts the appointment available date/time of the second row as a candidate appointment date/time with respect to the user A. Therefore, “candidate” is registered as the “candidate appointment” in the record of the second row in the candidate appointment date list 4200 and nothing is registered as the “reasons for exclusion”.

For example, “there is all-day plan” is registered as the “reasons for exclusion” in a record of a fourth row in the candidate appointment date list 4200. This is because a plan is registered for 24 hours in the calendar plan list 4000 on the day to which the appointment available date/time of the record in the fourth row belongs.

For example, “there is plan for close time” is registered as the “reasons for exclusion” in a record of a 14th row in the candidate appointment date list 4200. This is because, while the appointment available date/time of this record is “13:00 to 14:00” on “Dec. 1, 2013”, a finish time for a plan to do shopping is registered one hour prior to “13:00” in the calendar plan list 4000 and an interval between the finish time of a time slot for this plan and a start time of the appointment available date/time is short. In this manner, even if a time slot represented by an appointment available date/time and a time slot represented by a plan of the user do not overlap each other, the candidate appointment date selecting unit 202 may exclude the appointment available date/time from candidate appointment dates/times if an interval between the time slots is shorter than a specified value. Accordingly, the user can receive a visit by the service person without being rushed.

In this case, while the candidate appointment date selecting unit 202 extracts a candidate appointment date/time by comparing a time slot represented by an appointment available date/time with a time slot represented by a candidate appointment date/time, the present disclosure is not limited thereto. For example, the candidate appointment date selecting unit 202 may extract a candidate appointment date by comparing an appointment available date with a candidate appointment date.

For example, let us assume that a plan is registered in a time slot of 9:00 to 10:00 on Nov. 16, 2013 in the calendar plan list 4000. In this case, since an appointment available date/time of a second row in the candidate appointment date list 4200 is “13:00 to 14:00” on “Nov. 16, 2013”, although the time slots do not overlap each other, the appointment available date/time is excluded from the candidate appointment dates/times because the dates overlap each other.

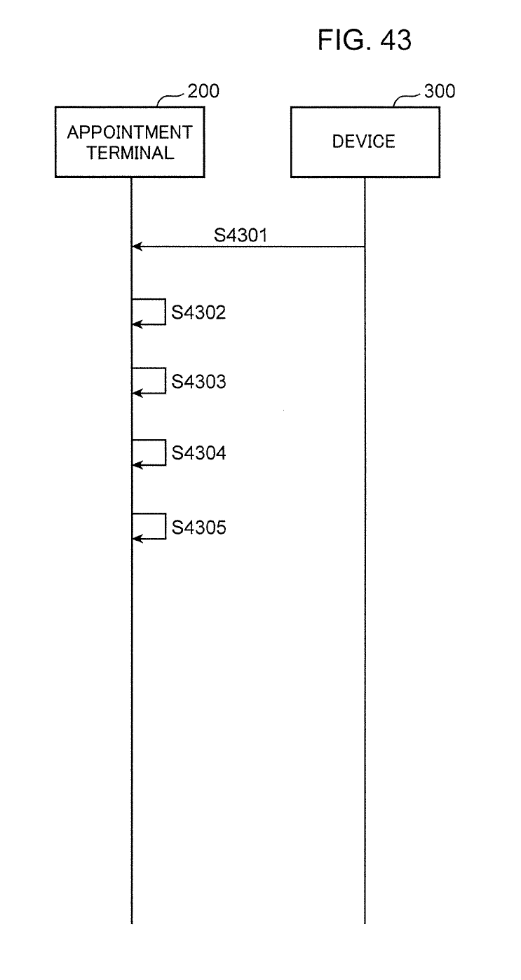

FIG. 43 is a sequence diagram showing a first example of an automatic startup process of an appointment application. In this case, the automatic startup process refers to a process for automatically starting up the appointment application without causing the user to input an operation to start up the appointment application. First, the device 300 transmits the device state 3500 (S4301). In this case, for example, the device state 3500 may be transmitted by the device 300 at regular time intervals or may be transmitted by the device 300 when the state of the device 300 changes.

Next, the appointment terminal 200 stores the transmitted device state 3500 (S4302). In this case, the device state 3500 is received by the communicating unit 208 and stored in the storing unit 203.

Next, the appointment terminal 200 analyzes the device state 3500 (S4303) and updates the device list table 3700 (S4304). In this case, the appointment terminal 200 may update the “latest state” in the device list table 3700 by the state of the device 300 represented by the analysis result.

Next, the appointment terminal 200 starts up the appointment application (S4305). In this case, the appointment screen generating unit 201 displays the appointment guide notification screen 1400 on the display unit 209. Moreover, the process of S4305 is not executed if the analysis result of the device 300 is normal. Accordingly, the appointment application is automatically started up when a malfunction of the device 300 is detected.

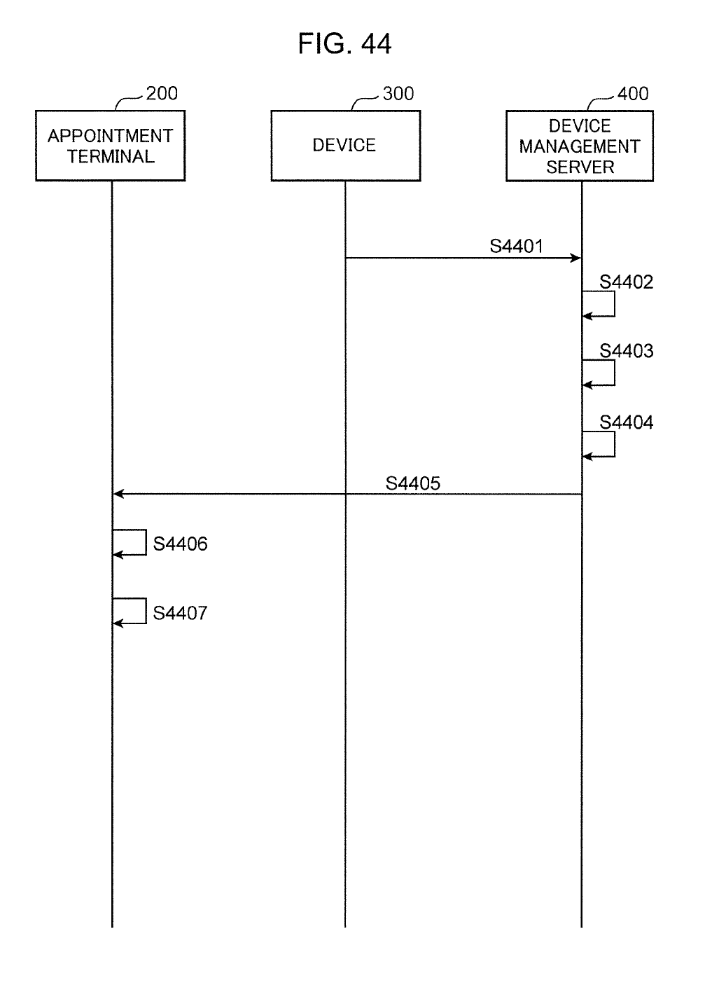

FIG. 44 is a sequence diagram showing a second example of an automatic startup process of the appointment application. In the automatic startup process according to the second example, the device state 3500 is transmitted to the appointment terminal 200 via the device management server 400.

First, the device 300 transmits the device state 3500 to the device management server 400 (S4401). Next, the device management server 400 stores the transmitted device state (S4402). In this case, the communicating unit 403 receives the device state 3500 and the device managing unit 402 stores the device state 3500 in the storing unit 401.

Subsequently, the device management server 400 analyzes the device state (S4403). In this case, the device managing unit 402 analyzes the device state 3500. Next, the device management server 400 updates the device list table 3700 (S4404). In this case, the appointment terminal 200 may update the “latest state” in the device list table 3700 using parameters registered in the “device unique operating parameter” of the received device state 3500.

Next, the device management server 400 transmits the analysis result 3600 to the appointment terminal 200 (S4405). Subsequently, the appointment terminal 200 updates the device list table 3700 (S4406). In this case, the appointment terminal 200 may update the “latest state” in the device list table 3700 with data registered in the “device state” in the analysis result 3600.

Next, the appointment terminal 200 starts up the appointment application (S4407). At this point, if the analysis result 3600 does not represent a malfunction of the device 300, the appointment terminal 200 does not start up the appointment application. Accordingly, the appointment application is automatically started up when a malfunction of the device 300 is detected.

Moreover, when a configuration that does not include the device management server 400 is adopted, the device management server 400 in FIG. 44 is to be replaced with the appointment server 100.

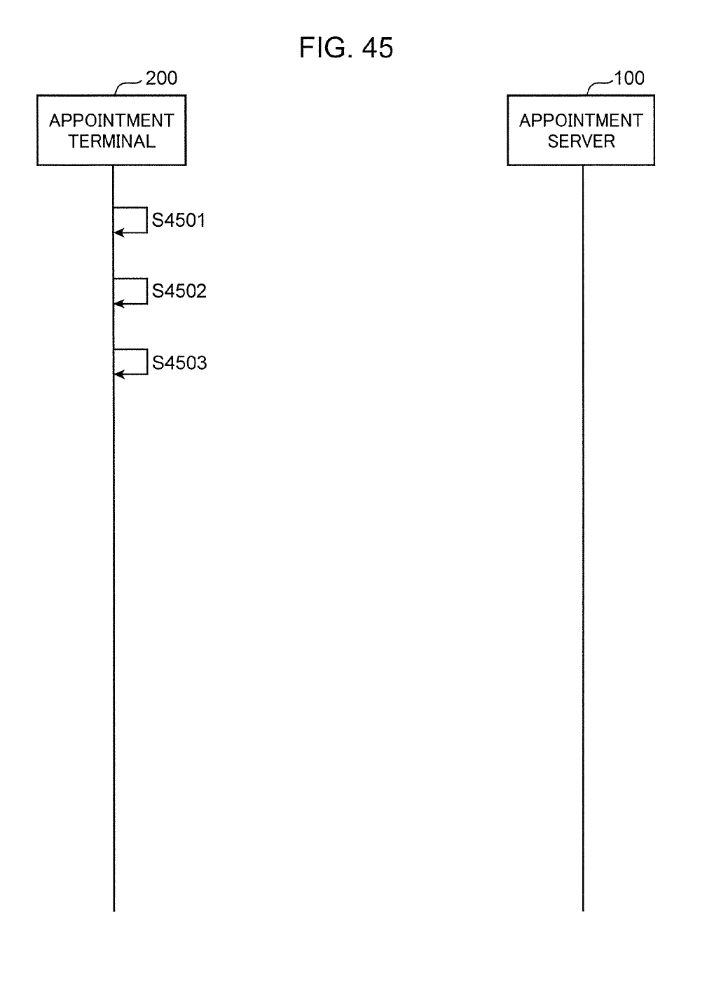

FIG. 45 is a sequence diagram showing a startup process of the appointment application when the appointment application is an embedded application. In this case, an embedded application refers to an application which is stored in a local memory (for example, a rewritable non-volatile storage device) of the appointment terminal 200 and which is read out from the local memory upon each startup.

First, the appointment terminal 200 starts up the appointment application (S4501). In this case, startup of the appointment application is triggered by an input of an operation for starting up the appointment application by the user or by detection of a malfunction of the device 300.

Next, the appointment terminal 200 reads the appointment application from the local memory (S4502). In this case, the appointment application is read from the local memory by, for example, a processor of the appointment terminal 200.

Subsequently, the appointment terminal 200 displays a screen of the appointment application on the display unit 209 (S4503). At this point, the top screen 3000 is displayed when the startup of the appointment application is triggered by the input of an operation by the user and the appointment guide notification screen 1400 is displayed when the startup of the appointment application is triggered by the detection of a malfunction of the device 300.

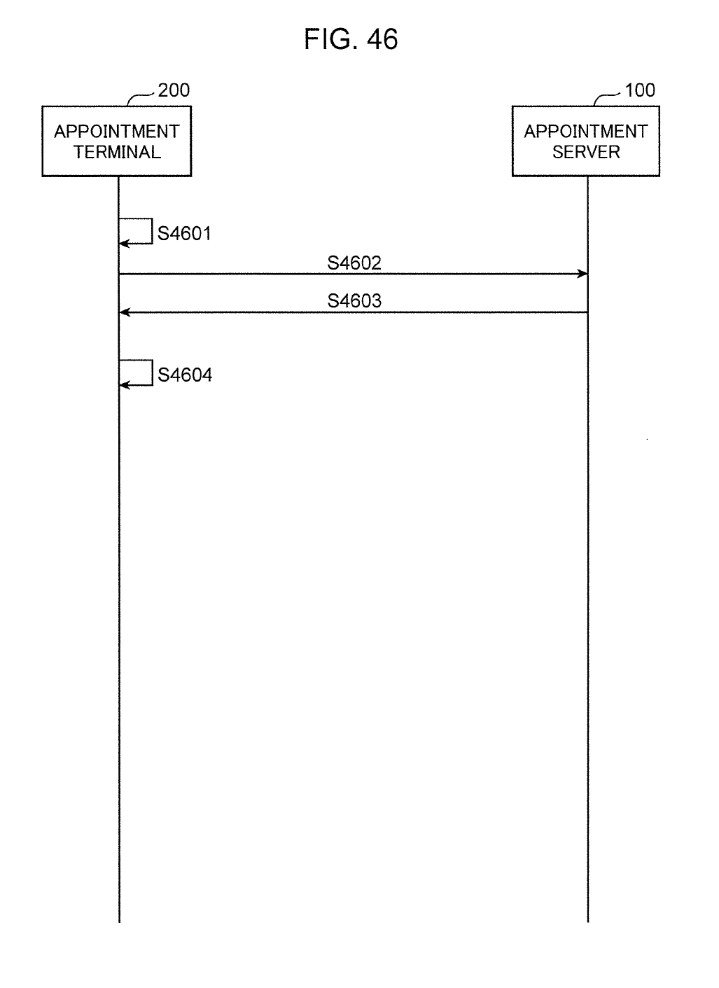

FIG. 46 is a sequence diagram showing a startup process of the appointment application when the appointment application is an HTML application. In this case, an HTML (Hyper Text Markup Language) application refers to, for example, an application which is described in a script language such as HTML and JavaScript that is executable by a browser and which is downloaded by the appointment terminal 200 from the appointment server 100 upon each startup of the application.

First, the appointment terminal 200 starts up the appointment application (S4601). The triggers for the startup of the appointment application are the same as in S4501. Next, the appointment terminal 200 transmits an acquisition request for the appointment application to the appointment server 100 (S4602). Subsequently, the appointment server 100 transmits the appointment application to the appointment terminal 200 (S4603). Next, the appointment terminal 200 displays a screen of the appointment application (S4604). Details of the display at this point are the same as in S4503.

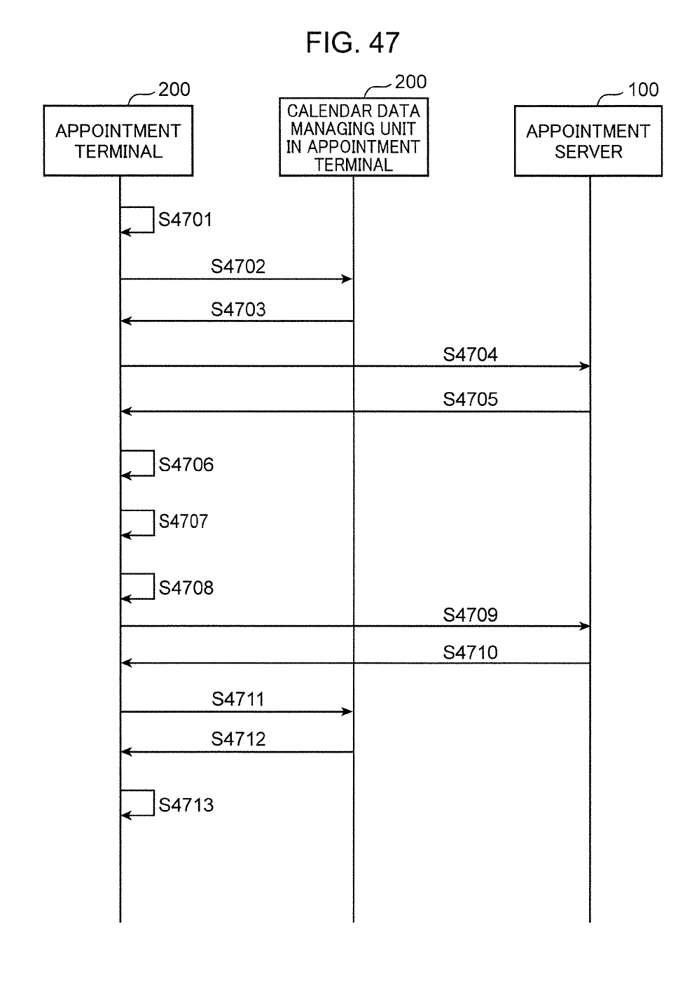

FIG. 47 is a sequence diagram of a process sequence S1-1 that is an overall process sequence of a first example of an appointment system according to the present disclosure. In this case, in the process sequence S1-1, the calendar data managing unit 206 is included in the appointment terminal 200 and the appointment terminal 200 executes an extraction process of a candidate appointment date. In addition, “S1” in the reference characters “S1-1” attached to the process sequence denotes that a configuration of the appointment system is any of those shown in FIGS. 5 to 9.

First, the appointment terminal 200 displays a screen of the appointment application on the display unit 209 (S4701). At this point, the inspection date selection screen 1600 is displayed on which no candidate appointment dates are shown.

Next, the appointment screen generating unit 201 of the appointment terminal 200 notifies the calendar data managing unit 206 of an acquisition request for the calendar plan list 4000 (S4702). Subsequently, the calendar data managing unit 206 notifies the appointment screen generating unit 201 of the calendar plan list 4000 (S4703).

Next, using the communicating unit 208, the appointment screen generating unit 201 of the appointment terminal 200 transmits an acquisition request for appointment available dates/times to the appointment server 100 (S4704). Subsequently, the appointment server 100 transmits appointment available dates/times to the appointment terminal 200 (S4705).

Next, the candidate appointment date selecting unit 202 of the appointment terminal 200 executes an extraction process of a candidate appointment date using the calendar plan list 4000 and the appointment available dates/times (S4706). Subsequently, using an extraction result, the appointment screen generating unit 201 displays a candidate appointment date/time or a candidate appointment date in the calendar data display field 1604 (S4707). For example, when a mode is adopted in which a candidate appointment date is displayed, the candidate symbol 1606 is displayed in the box 1605 corresponding to the candidate appointment date on the inspection date selection screen 1600. Alternatively, when a mode is adopted in which a candidate appointment date/time is displayed, the candidate appointment time 1901 is displayed in the box 1605 corresponding to the candidate appointment date/time on the inspection date selection screen 1600. Moreover, when a mode is adopted in which a fee is displayed together with a candidate appointment date/time or a candidate appointment date, a fee is displayed in the box 1605 corresponding to the candidate appointment date/time or the candidate appointment date. In this case, the candidate appointment date selecting unit 202 may acquire a fee corresponding to the appointment available date/time in S4705 and display the fee in the corresponding box 1605.

Next, the screen control unit 204 of the appointment terminal 200 accepts an operation for selecting a candidate appointment date/time by the user (S4708). In this case, the user may input an operation for selecting a candidate appointment date/time on the inspection date selection screen 1600 and the inspection time selection screen 2100.

Subsequently, the appointment screen generating unit 201 transmits an appointment request for an inspection to the appointment server 100 using the communicating unit 208 (S4709). The appointment request includes the candidate appointment date/time selected by the user and is transmitted when the appointment button 2306 is tapped on the appointment content confirmation screen 2300.

At this point, the appointment data managing unit 101 of the appointment server 100 registers the candidate appointment date/time indicated in the appointment request as a visit date/time in the appointment available date list 4100 that is stored in the appointment data storing unit 102. In this case, an “appointment accepted” (not shown) field may be provided in the appointment available date list 4100 and the appointment data managing unit 101 may register a user ID of a user having made an appointment in the “appointment accepted” field of an appointment available date/time corresponding to the visit date/time indicated by the appointment request. Accordingly, the appointment server 100 can manage the visit date/time for which an appointment has been made by the user.

Next, the appointment data managing unit 101 of the appointment server 100 transmits an appointment result that represents the visit date/time of the accepted appointment to the appointment terminal 200 using the communicating unit 105 (S4710).

Subsequently, the candidate appointment date selecting unit 202 notifies the calendar data managing unit 206 of a registration request for the visit date/time represented by the transmitted appointment result (S4711). Accordingly, the calendar data managing unit 206 registers the visit date/time represented by the appointment result in the calendar plan list 4000 that is stored in the calendar data storing unit 207.

Next, the calendar data managing unit 206 notifies the appointment screen generating unit 201 of the calendar plan list 4000 in which the visit date/time has been registered (S4712).

Subsequently, the appointment screen generating unit 201 generates the inspection appointment completion screen 2400 using the notified calendar plan list 4000 and displays the inspection appointment completion screen 2400 on the display unit 209 (S4713). In this case, as shown in FIG. 24 or 25, the inspection appointment completion screen 2400 on which the appointment icon 2402 is displayed in the box 1605 corresponding to the visit date/time for which an appointment has been made is displayed on the display unit 209.

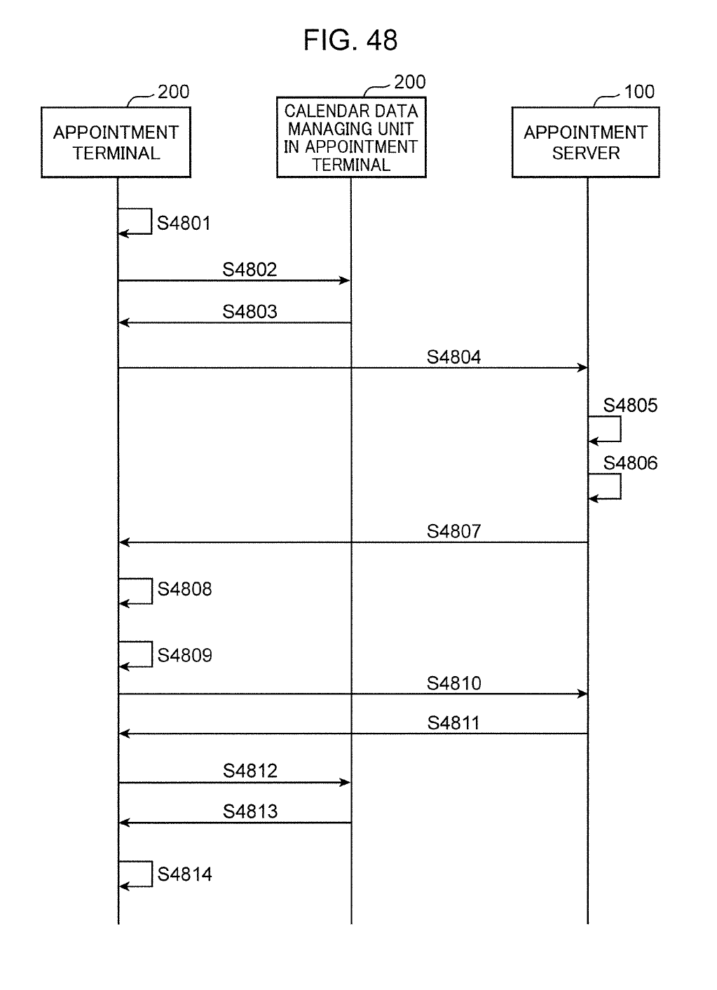

FIG. 48 is a sequence diagram of a process sequence S1-2 that is an overall process sequence of a second example of the appointment system according to the present disclosure. In this case, in the process sequence S1-2, the calendar data managing unit 206 is included in the appointment terminal 200 and the appointment server 100 executes an extraction process of a candidate appointment date.

S4801 to S4803 are the same as S4701 to S4703 in FIG. 47. In 54804, the appointment terminal 200 transmits an acquisition request for a candidate appointment date/time to the appointment server 100. In this case, the calendar plan list 4000 is included in the acquisition request. Accordingly, the appointment server 100 can acquire the calendar plan list 4000.

Next, the appointment data managing unit 101 of the appointment server 100 acquires appointment available dates/times from the appointment available date list 4100 stored in the appointment data storing unit 102 (S4805). Subsequently, the candidate appointment date selecting unit 106 executes an extraction process of a candidate appointment date using the calendar plan list 4000 and the acquired appointment available dates/times (S4806). Details of the extraction process are the same as in S4706 in FIG. 47.

Next, the candidate appointment date selecting unit 106 transmits an extraction result to the appointment terminal 200 using the communicating unit 105 (S4807). S4808 to S4814 are the same as S4707 to S4713 in FIG. 47.

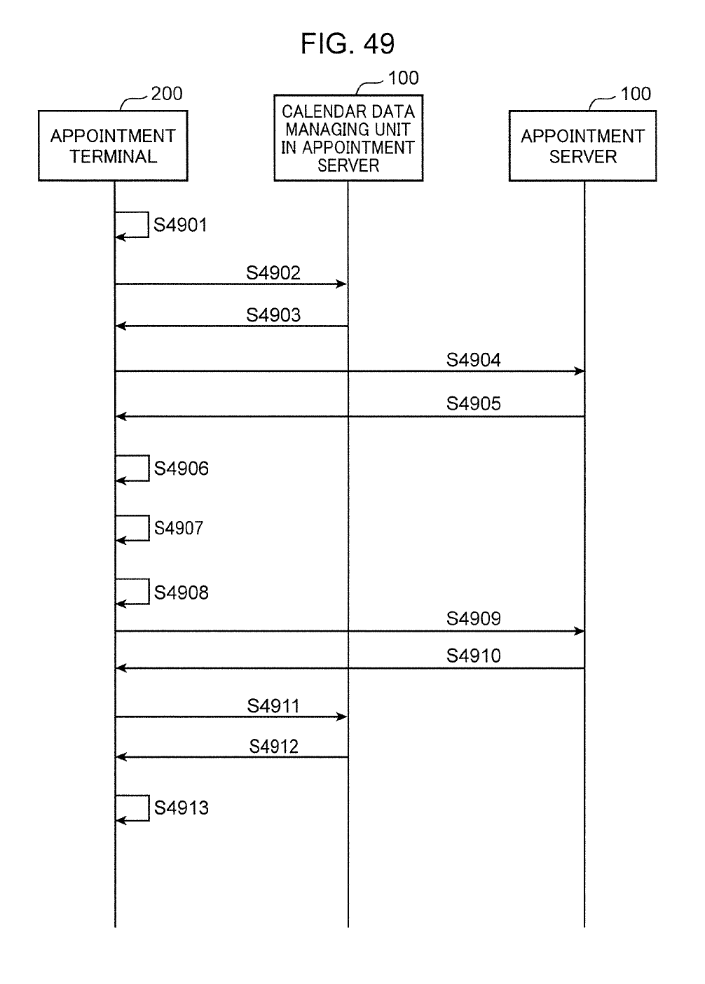

FIG. 49 is a sequence diagram of a process sequence S1-3 that is an overall process sequence of a third example of the appointment system according to the present disclosure. In this case, in the process sequence S1-3, the calendar data managing unit 107 is included in the appointment server 100 and the appointment terminal 200 executes an extraction process of a candidate appointment date.

S4901 is the same as S4701 in FIG. 47. Next, the appointment screen generating unit 201 of the appointment terminal 200 transmits an acquisition request for the calendar plan list 4000 to the appointment server 100 (S4902). Subsequently, the calendar data managing unit 107 of the appointment server 100 acquires the calendar plan list 4000 of the user who owns the appointment terminal 200 which had transmitted the acquisition request from the calendar data storing unit 108 and transmits the calendar plan list 4000 to the appointment terminal 200 (S4903).

S4904 to S4913 are the same as S4704 to S4713 in FIG. 47.

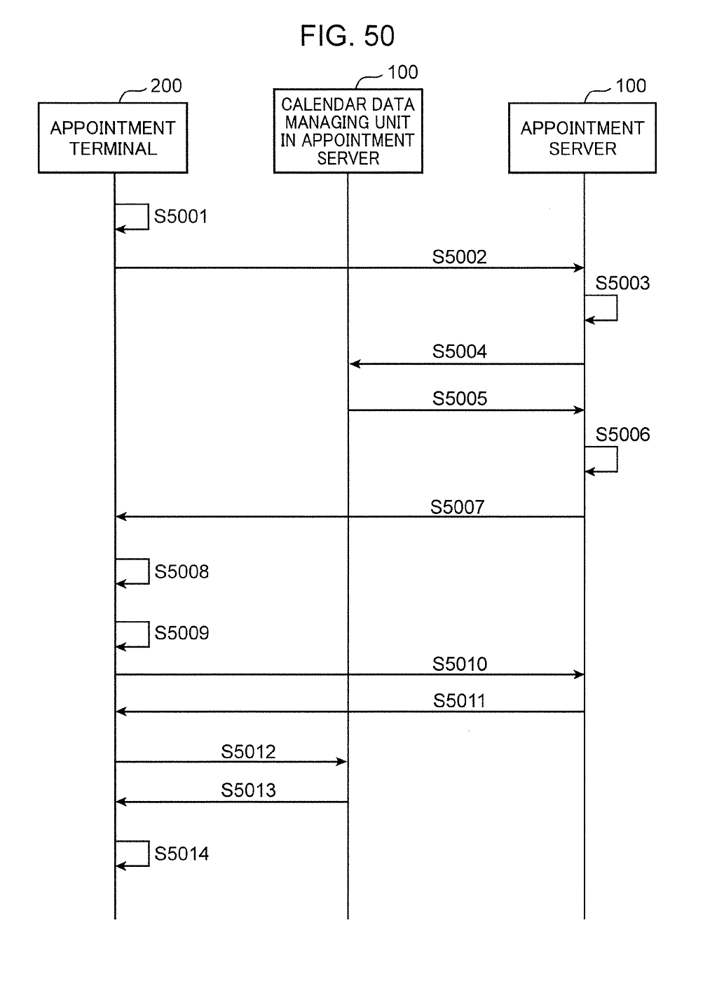

FIG. 50 is a sequence diagram of a process sequence S1-4 that is an overall process sequence of a fourth example of the appointment system according to the present disclosure. In this case, in the process sequence S1-4, the calendar data managing unit 107 is included in the appointment server 100 and the appointment server 100 executes an extraction process of a candidate appointment date.

S5001 is the same as S4701 in FIG. 47. Next, the appointment screen generating unit 201 of the appointment terminal 200 transmits an acquisition request for candidate appointment dates/times to the appointment server 100 (S5002).

Subsequently, the candidate appointment date selecting unit 106 of the appointment server 100 acquires appointment available dates/times from the appointment available date list 4100 stored in the appointment data storing unit 102 (S5003). Next, the candidate appointment date selecting unit 106 notifies the calendar data managing unit 107 of an acquisition request for the calendar plan list 4000 of the user who owns the appointment terminal 200 which had transmitted the acquisition request (S5004).

Subsequently, the calendar data managing unit 107 acquires the calendar plan list 4000 of the user of concern from the calendar data storing unit 108 and notifies the candidate appointment date selecting unit 106 of the calendar plan list 4000 (S5005). S5006 to S5014 are the same as S4806 to S4814 in FIG. 48.

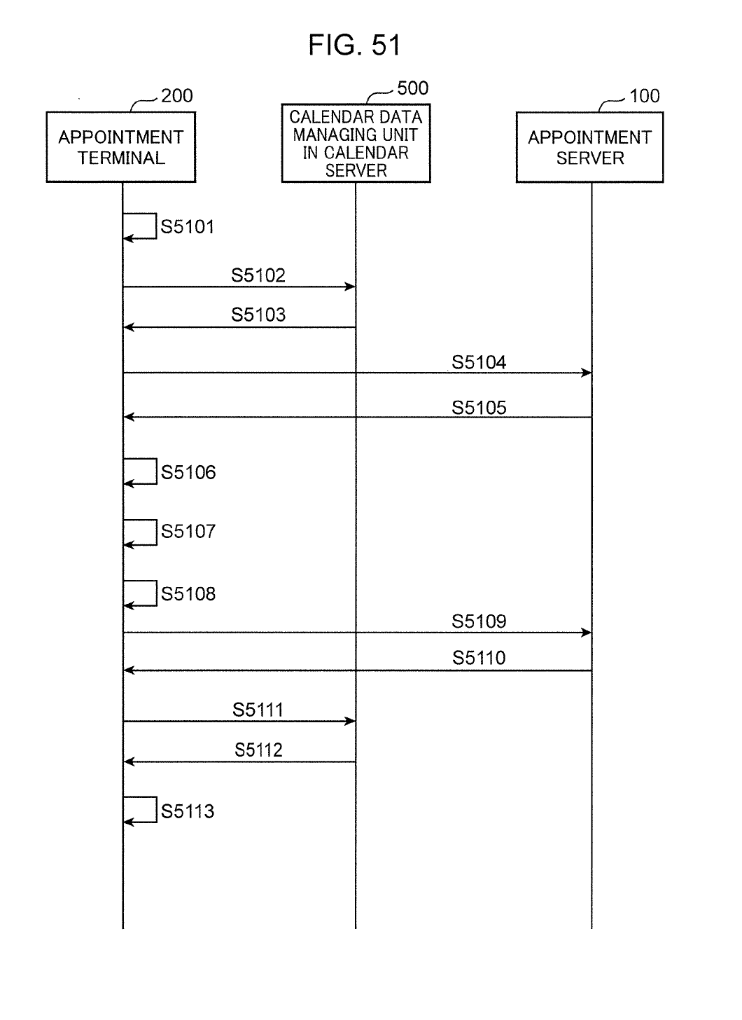

FIG. 51 is a sequence diagram of a process sequence S2-1 that is an overall process sequence of a fifth example of the appointment system according to the present disclosure. In this case, in the process sequence S2-1, the calendar data managing unit 107 is included in the calendar server 500 and the appointment terminal 200 executes an extraction process of a candidate appointment date. In addition, reference characters “S2” that are attached to the process sequence indicate that a configuration of the appointment system is any of those shown in FIGS. 10 to 12.

S5101 is the same as S4701 in FIG. 47. Next, the appointment screen generating unit 201 of the appointment terminal 200 transmits an acquisition request for the calendar plan list 4000 to the calendar server 500 (S5102). Subsequently, the calendar data managing unit 502 of the calendar server 500 acquires the calendar plan list 4000 of the user who owns the appointment terminal 200 which had transmitted the acquisition request from the calendar data storing unit 108 and transmits the calendar plan list 4000 to the appointment terminal 200 (S5103). S5104 to S5113 are the same as S4904 to S4913 in FIG. 49.

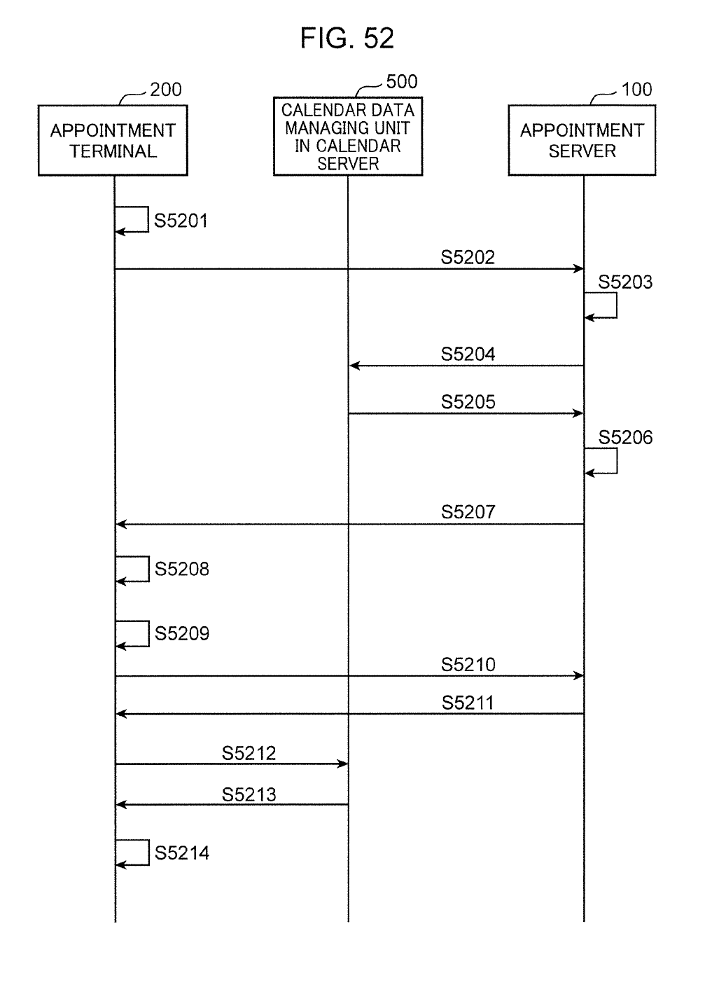

FIG. 52 is a sequence diagram of a process sequence S2-2 that is an overall process sequence of a sixth example of the appointment system according to the present disclosure. In this case, in the process sequence S2-2, the calendar data managing unit 502 is included in the calendar server 500 and the appointment server 100 executes an extraction process of a candidate appointment date.

S5201 is the same as S4701 in FIG. 47. S5202 and S5203 are the same as S5002 and S5003 in FIG. 50. Next, the candidate appointment date selecting unit 106 notifies the calendar server 500 of an acquisition request for the calendar plan list 4000 of the user who owns the appointment terminal 200 which had transmitted the acquisition request (S5204).

Subsequently, the calendar data managing unit 502 of the calendar server 500 acquires the calendar plan list 4000 of the user of concern from the calendar data storing unit 503 and notifies the appointment server 100 of the calendar plan list 4000 (S5205). S5206 to S5214 are the same as S5006 to S5014 in FIG. 50.

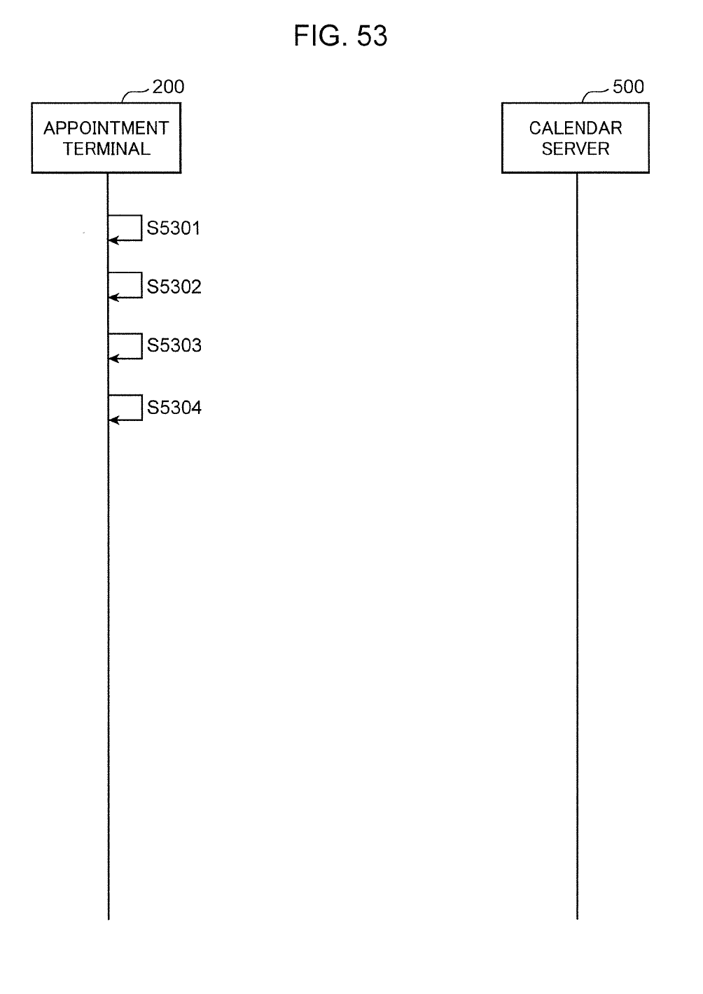

FIG. 53 is a sequence diagram showing a startup process of a calendar application when the calendar application is an embedded application. First, the appointment terminal 200 starts up the calendar application (S5301). In this case, the startup of the calendar application by the appointment terminal 200 is triggered by an input of an operation for starting up the calendar application by the user.

Next, the appointment terminal 200 reads the calendar application from the local memory (S5302). In this case, the calendar application is read from the local memory by, for example, a processor of the appointment terminal 200.

Subsequently, the calendar screen generating unit 205 acquires the calendar plan list 4000 from the calendar data managing unit 206 (S5303).

Next, the calendar screen generating unit 205 displays a screen of the calendar application on the display unit 209 (S5304).

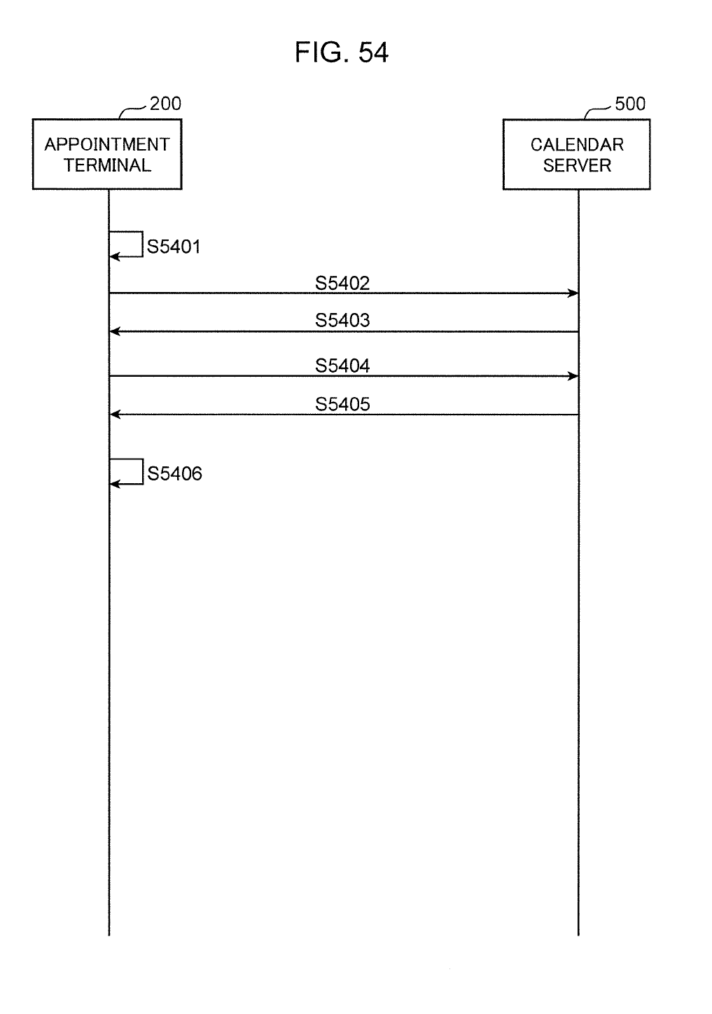

FIG. 54 is a sequence diagram showing a startup process of the calendar application when the calendar application is an HTML application.

First, the appointment terminal 200 starts up the calendar application (S5401). The trigger for the startup of the calendar application is the same as in S5301. Next, the appointment terminal 200 transmits an acquisition request for the calendar application to the calendar server 500 (S5402). Subsequently, the calendar server 500 transmits the calendar application to the appointment terminal 200 (S5403). Next, the calendar screen generating unit 205 of the appointment terminal 200 transmits an acquisition request for the calendar plan list 4000 of the user who owns the appointment terminal 200 to the calendar server 500 (S5404). Subsequently, the calendar server 500 transmits the calendar plan list 4000 of the user of concern to the appointment terminal 200 (S5405). Next, the calendar screen generating unit 205 displays a screen of the calendar application using the transmitted calendar plan list 4000 (S5406).

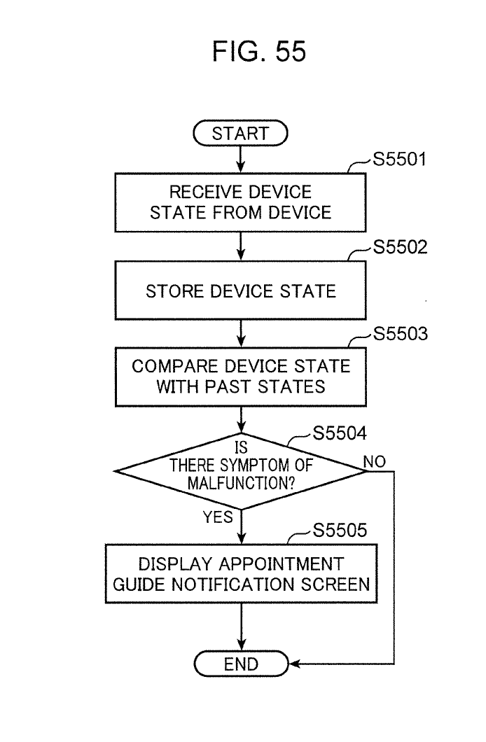

FIG. 55 is a flow chart showing a first example of an automatic startup process of the appointment application. The flow chart corresponds to the sequence diagram shown in FIG. 43. First, the appointment terminal 200 receives the device state 3500 from the device 300 (S5501).

Subsequently, the appointment terminal 200 stores the device state 3500 in the storing unit 203 (S5502). Next, the appointment terminal 200 compares the received device state 3500 with previous device states 3500 stored in the storing unit 203 (S5503).

Subsequently, the appointment terminal 200 determines whether or not there are indications of a malfunction in the device 300 from the comparison result (S5504). For example, when a given parameter that is included in the received device state 3500 deviates from a past average value or exceeds a threshold, the appointment terminal 200 may determine that there are indications of a malfunction in the device 300. Alternatively, when a parameter of an error code is included in the received device state 3500 and the device state 3500 including the parameter of an error code has been consecutively received a certain number of times or more in the past, the appointment terminal 200 may determine that there are indications of a malfunction in the device 300.

A specific description will now be given with reference to FIG. 35. The example shown in FIG. 35 includes “0x0A” as an error code. In this case, when the device state 3500 including the error code “0x0A” has been consecutively received a certain number of times or more in the past, the appointment terminal 200 may determine that there are indications of a malfunction in the device 300 (in this case, an air conditioner).

In addition, although not shown in FIG. 35. let us assume that the device state 3500 includes a parameter that represents a state of the device 300 using a numerical value. In this case, the appointment terminal 200 may calculate an average value of the parameter using device states 3500 received over a certain period in the past, and may determine that there are indications of a malfunction when a difference between a value of the parameter in the currently received device state 3500 and the calculated average value is equal to or greater than a threshold.

Subsequently, when the appointment terminal 200 determines that there are indications of a malfunction in the device 300 (yes in S5504), the appointment terminal 200 advances the process to S5505, and when the appointment terminal 200 determines that there are no indications of a malfunction in the device 300 (no in S5504), the appointment terminal 200 ends the process.

Next, the appointment screen generating unit 201 displays the appointment guide notification screen 1400 on the display unit 209 (S5505).

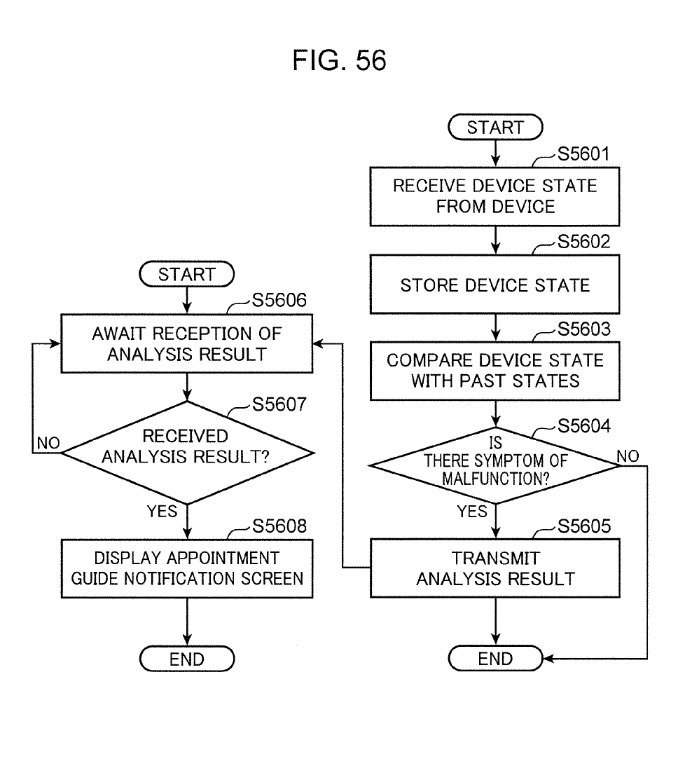

FIG. 56 is a flow chart showing a second example of an automatic startup process of the appointment application. The flow chart corresponds to the sequence diagram shown in FIG. 44. First, the communicating unit 504 of the device management server 400 receives the device state 3500 from the device 300 (S5601). Next, the device managing unit 402 of the device management server 400 stores the received device state 3500 in the storing unit 401 (S5602). Subsequently, the device managing unit 402 compares the received device state 3500 with previous device states 3500 stored in the storing unit 401 (S5603).

Next, the device managing unit 402 determines whether or not there are indications of a malfunction in the device 300 from the comparison result (S5604). Details of the process at this point are the same as in S5504 in FIG. 55.

Subsequently, when the device managing unit 402 determines that there are indications of a malfunction (yes in S5604), the device managing unit 402 advances the process to S5605, and when the device managing unit 402 determines that there are no indications of a malfunction in the device 300 (no in S5604), the device managing unit 402 ends the process.

Next, the device managing unit 402 transmits the analysis result 3600 to the appointment terminal 200 (S5605). Subsequently, when the communicating unit 208 of the appointment terminal 200 that is in a reception waiting state (S5606) of the analysis result 3600 receives the analysis result 3600 (yes in S5607), the process is advanced to S5608. On the other hand, when the communicating unit 208 does not receive the analysis result 3600 (no in S5607), the reception waiting state is maintained (S5606).

Next, the appointment screen generating unit 201 displays the appointment guide notification screen 1400 on the display unit 209 (S5608).

Moreover, while FIG. 56 shows the device management server 400 to be a processing entity of S5601 to S5605, when the device managing unit 104 is included in the appointment server 100, the appointment server 100 is the processing entity of S5601 to S5605.

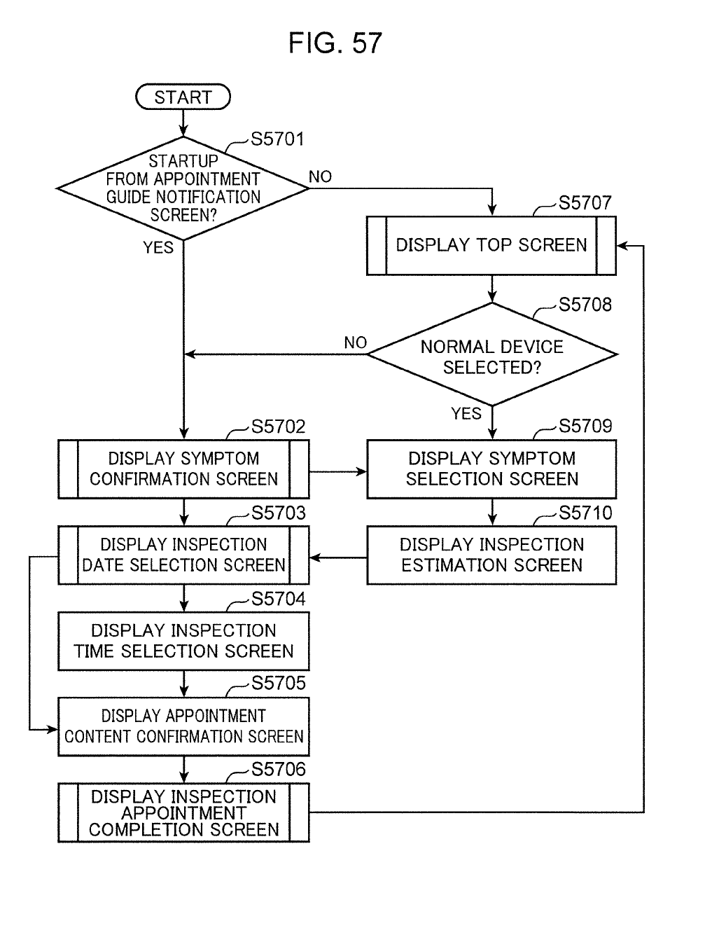

FIG. 57 is a flow chart showing an example of an overall process of the appointment application. First, in a case of a startup from the appointment guide notification screen 1400 (yes in S5701), the appointment screen generating unit 201 executes a display process of the symptom confirmation screen 1500 (S5702). Details of the process of S5702 as well as branching of the process at S5702 to S5703 and S5709 will be described later.

On the other hand, when the startup is not from the appointment guide notification screen 1400 (no in S5701), the appointment screen generating unit 201 executes a display process of the top screen 3000 (S5707). Details of the display process of the top screen 3000 will be described later.

For example, when the device name 1401 is tapped on the appointment guide notification screen 1400, the appointment screen generating unit 201 makes a determination of yes in S5701. In addition, when the appointment application icon 1301 is tapped on the basic screen 1300, the appointment screen generating unit 201 makes a determination of no in S5701.

Next, the appointment screen generating unit 201 executes a display process of the inspection date selection screen 1600 (S5703). Details of the process of S5703 as well as branching of the process at S5703 to S5704 and S5705 will be described later.

Next, the appointment screen generating unit 201 displays the inspection time selection screen 2100 on the display unit 209 (S5704). When the appointment button 2105 is tapped on the inspection time selection screen 2100, the appointment screen generating unit 201 displays the appointment content confirmation screen 2300 on the display unit 209 (S5705). Next, the appointment screen generating unit 201 executes a display process of the inspection appointment completion screen 2400 (S5706). When the top button 2401 is tapped on the inspection appointment completion screen 2400, the appointment screen generating unit 201 advances the process to S5707. Details of the display process of the inspection appointment completion screen 2400 will be described later.

Moreover, as described earlier, in the case of the inspection date selection screen 1600 according to the third example (FIG. 19), when the candidate appointment time 1901 is tapped, the appointment screen generating unit 201 may skip S5704 and advance the process to S5705.

Moreover, the appointment application may be ended at an arbitrary timing by an operation such as tapping a home button of the appointment terminal 200.

When a normal device 300 is selected on the top screen 3000 (yes in S5708), the appointment screen generating unit 201 displays the symptom selection screen 2700 on the display unit 209 (S5709). When the estimate button 2704 is tapped on the symptom selection screen 2700, the appointment screen generating unit 201 displays the inspection estimation screen 2900 on the display unit 209 (S5710) and advances the process to S5703.

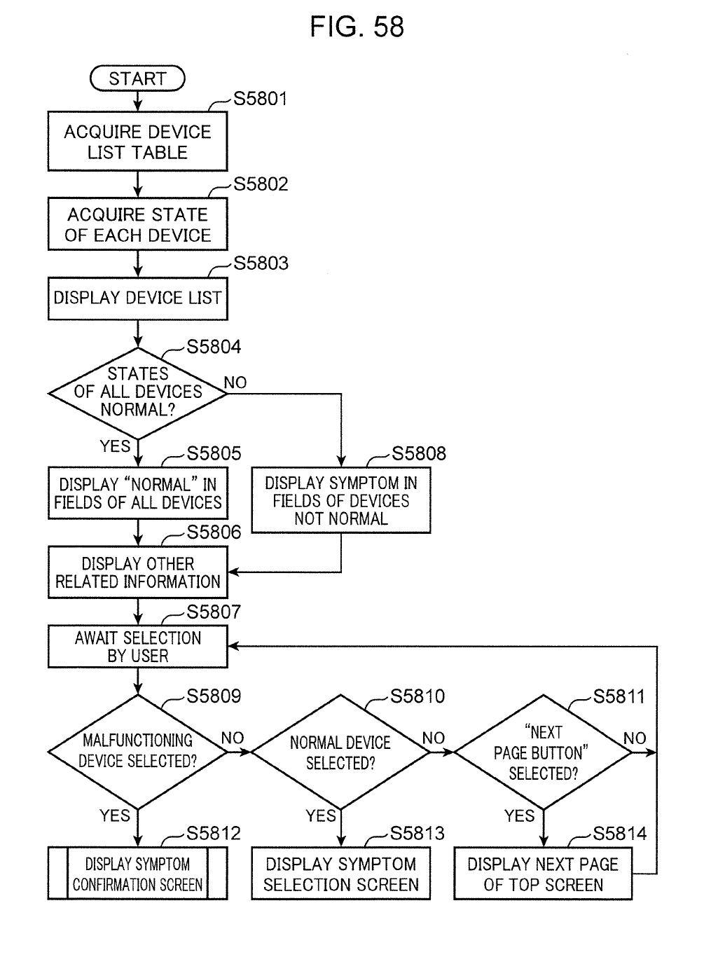

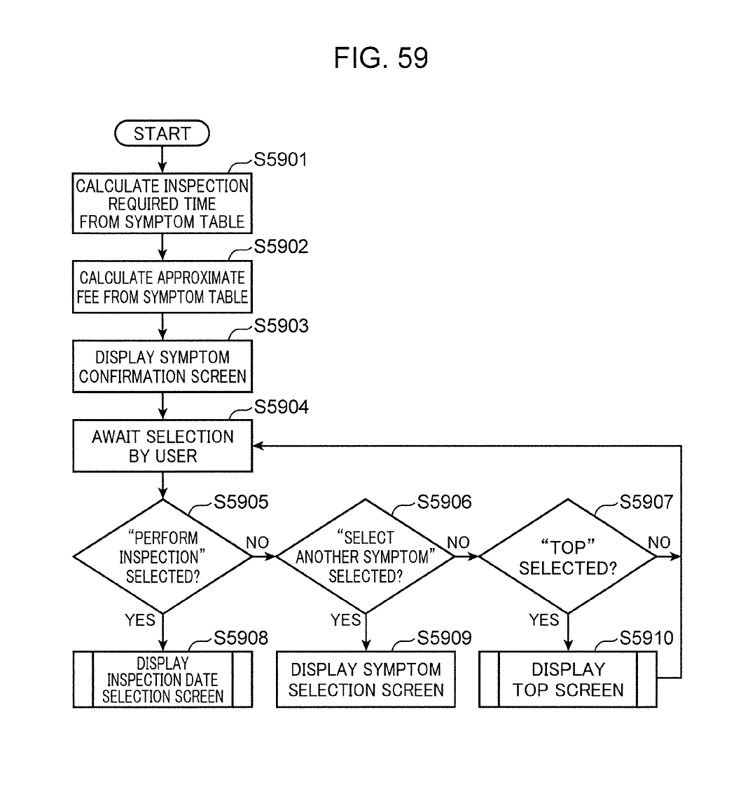

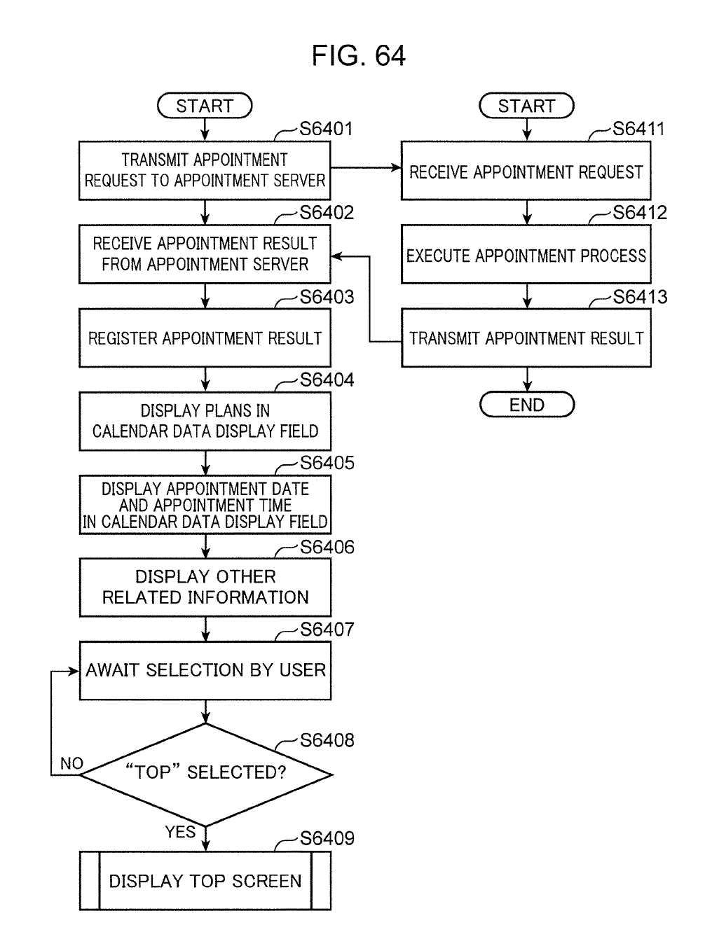

FIG. 58 is a flow chart showing details of the display process of the top screen 3000 (S5707 in FIG. 57, S5910 in FIG. 59, and S6409 in FIG. 64). First, the appointment terminal 200 acquires the device list table 3700 (S5801). At this point, when the device management server 400 manages the device list table 3700, the appointment terminal 200 may acquire the device list table 3700 of the user who owns the appointment terminal 200 from the device management server 400. Alternatively, when the appointment terminal 200 itself is managing the device list table 3700, the appointment terminal 200 may acquire the device list table 3700 from the storing unit 203.

Next, the appointment screen generating unit 201 acquires a state of each device 300 from the device list table 3700 (S5802). In the example shown in FIG. 37, data registered in the “latest state” in the device list table 3700 is acquired.

Subsequently, the appointment screen generating unit 201 displays the top screen 3000 displaying a list of devices 300 as shown in FIG. 30 on the display unit 209 (S5803). Accordingly, a list of devices 300 registered in the device list table 3700 is displayed on the top screen 3000. At this point, states of the devices 300 are not displayed on the top screen 3000.

Next, the appointment screen generating unit 201 determines whether or not the state is normal with respect to all of the devices 300 displayed as a list (S5804). When all of the devices 300 are normal (yes in S5804), “normal” is displayed in state display fields of all of the devices 300 on the top screen 3000 (S5805). On the other hand, if there is a device 300 whose state is not normal (no in S5804), the appointment screen generating unit 201 displays a symptom in the state display field of the device 300 that is not normal and displays “normal” in the state display field of the devices 300 that are normal (S5808).

For example, in the example shown in FIG. 30, since an air conditioner, a lighting fixture, a refrigerator, and a washing machine are registered as the devices 300 owned by the user in the device list table 3700, these devices 300 are displayed as a list. In addition, since “decline in cooler function” is registered as a “latest state” of the air conditioner in the device list table 3700, “decline in cooler function” is displayed in the state display field of the air conditioner. Moreover, since “normal” is registered as a “latest state” of the devices 300 other than the air conditioner in the device list table 3700, “normal” is displayed in the state display field of these devices 300.

Next, the appointment screen generating unit 201 displays other related information on the top screen 3000 (S5806). In this case, examples of related information include screen components such as the inspection button 3002, characters that form headings, and frames that enclose display fields of the respective devices 300.

Consequently, the top screen 3000 shown in FIG. 30 is completed.

Subsequently, the appointment screen generating unit 201 enters a standby state for a selection operation by the user (S5807). In addition, when the inspection button 3002 of the device 300 that is in a malfunctioning state is tapped and the device 300 is selected (yes in S5809), the appointment screen generating unit 201 executes a display process of the symptom confirmation screen 1500 (S5812).

Furthermore, when the inspection button 3002 of the device 300 whose state is normal is tapped and the device 300 is selected (no in S5809 and yes in S5810), the appointment screen generating unit 201 displays the symptom selection screen 2700 on the display unit 209 (S5813).

Alternatively, when the next page button 3003 is tapped (selected) (no in S5810 and yes in S5811), the appointment screen generating unit 201 displays the top screen 3000 of the next page on the display unit 209 (S5814) and returns the process to S5807. Moreover, when all of S5809, S5810, and S5811 are no or, in other words, when no operation is input by the user, the process is returned to S5807 and the standby state for a selection operation by the user is maintained.

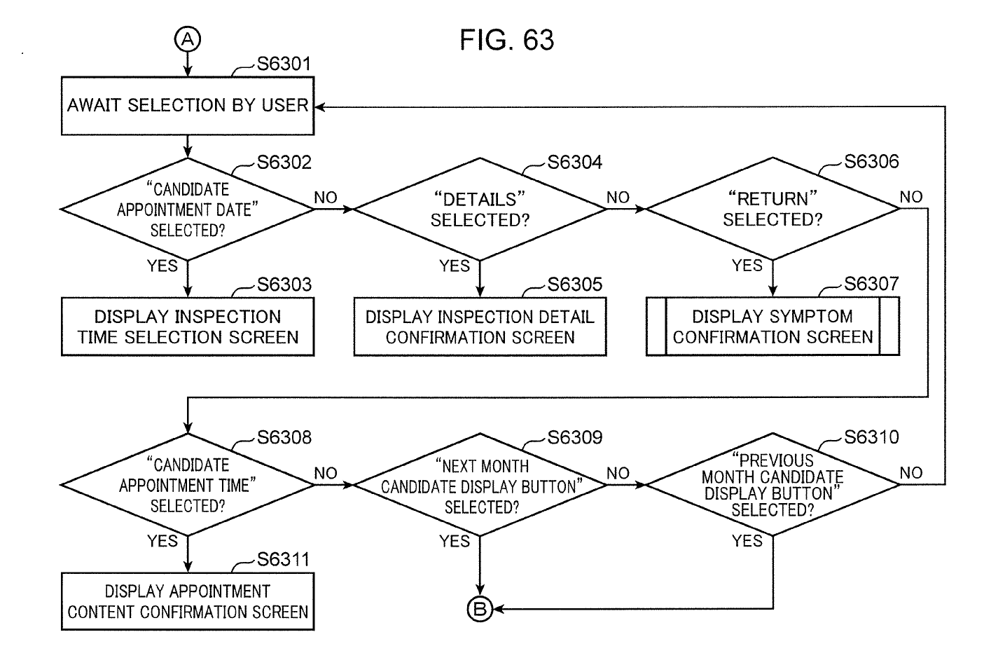

FIG. 59 is a flow chart showing an example of a display process of the symptom confirmation screen 1500 (S5702 in FIG. 57, S5812 in FIG. 58, and S6307 in FIG. 63). First, the appointment screen generating unit 201 uses the symptom table 3900 to calculate a required time with respect to the inspection of concern (S5901). At this point, in a case of a startup from the appointment guide notification screen 1400, an inspection corresponding to a symptom of a malfunction of the device 300 for which the malfunction has been detected corresponds to the inspection of concern, and in a case of a startup from the top screen 3000, inspection corresponding to a symptom selected by the user corresponds to the inspection of concern.

For example, if the inspection of concern is “decline in cooler function”, since “1 hour” is registered as a “basic inspection time” in the symptom table 3900 shown in FIG. 39, “1 hour” is calculated as a required time of the inspection of concern.

Next, the appointment screen generating unit 201 uses the symptom table 3900 to calculate an approximate fee with respect to the inspection of concern (S5902). For example, if the inspection of concern is “decline in cooler function”, since “5,000 yen” is registered as a “basic fee” in the symptom table 3900 shown in FIG. 39, “5,000 yen” is calculated as an approximate fee of the inspection of concern.

Subsequently, the appointment screen generating unit 201 displays the symptom confirmation screen 1500 on the display unit 209 (S5903).

Next, the appointment screen generating unit 201 enters a standby state for a selection operation by the user (S5904).

When the inspection button 1506 is tapped and “perform inspection” is selected by the user (yes in S5905), the appointment screen generating unit 201 executes a display process of the inspection date selection screen 1600 (S5908).

In addition, when the symptom selection button 1507 is tapped and “select another symptom” is selected by the user (no in S5905 and yes in S5906), the appointment screen generating unit 201 displays the symptom selection screen 2700 on the display unit 209 (S5909).

Furthermore, when the top button 1501 is tapped and “top” is selected by the user (no in S5906 and yes in S5807), the appointment screen generating unit 201 executes a display process of the top screen 3000 (S5910). Moreover, when all of S5905, S5906, and S5907 are no or, in other words, when no operation is input by the user, the process is returned to S5904 and the standby state for a selection operation by the user is maintained.

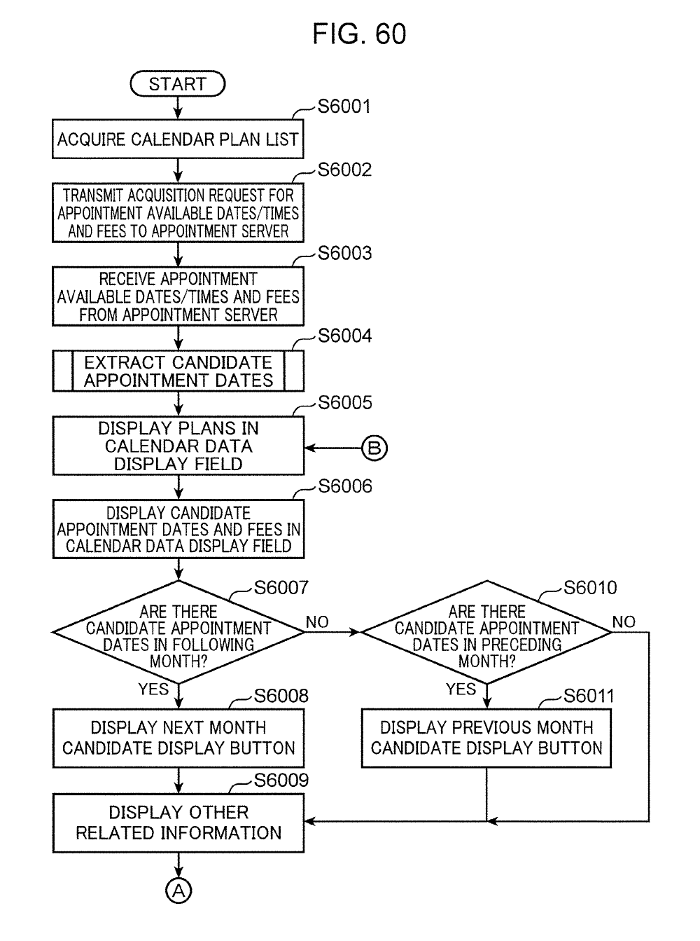

FIG. 60 is a flow chart showing a first example of a display process of the inspection date selection screen 1600 (S5703 in FIG. 57 and S5908 in FIG. 59). The flow chart corresponds to process sequences S1-1, S1-3, and S2-1 in which the appointment terminal 200 performs an extraction process of a candidate appointment date.

First, the appointment screen generating unit 201 of the appointment terminal 200 acquires the calendar plan list 4000 from the appointment server 100, the calendar server 500, or the appointment terminal 200 (S6001). In the process sequence S1-1, since the calendar plan list 4000 is managed by the appointment terminal 200, the appointment screen generating unit 201 may acquire the calendar plan list 4000 from the calendar data storing unit 207. In the process sequence S1-3, since the calendar plan list 4000 is managed by the appointment server 100, the appointment screen generating unit 201 may acquire the calendar plan list 4000 from the appointment server 100. In the process sequence S2-1, since the calendar plan list 4000 is managed by the calendar server 500, the appointment screen generating unit 201 may acquire the calendar plan list 4000 from the calendar server 500.

Next, the appointment screen generating unit 201 transmits an acquisition request for appointment available dates/times and fees to the appointment server 100 (S6002).

Subsequently, the appointment screen generating unit 201 receives appointment available dates/times and fees from the appointment server 100 (S6003).

Next, the candidate appointment date selecting unit 202 executes an extraction process of a candidate appointment date (S6004).

Subsequently, the appointment screen generating unit 201 displays plans of the user in the calendar data display field 1604 (S6005). In this case, the appointment screen generating unit 201 displays the schedule icon 1607 in the box 1605 corresponding to an appointment available date/time on which a plan of the user is registered in the calendar plan list 4000. At this point, the appointment screen generating unit 201 may describe the text that is registered in “plan contents” in the calendar plan list 4000 on the schedule icon 1607.

Next, using an extraction result of a candidate appointment date, the appointment screen generating unit 201 displays a candidate appointment date and a fee for an inspection in the calendar data display field 1604 (S6006). In this case, the appointment screen generating unit 201 displays the candidate symbol 1606 or the candidate appointment time 1901 in the box 1605 corresponding to an appointment available date/time for which “candidate” is registered as the “candidate appointment” in the candidate appointment date list 4200 that is obtained by the extraction process. In addition, the appointment screen generating unit 201 displays a fee in the corresponding box 1605 using a fee calculated from the “fee” registered in the candidate appointment date list 4200.

Subsequently, if there is a candidate appointment date in the month following the month of the inspection date selection screen 1600 that is currently being displayed (yes in S6007), the appointment screen generating unit 201 displays the next month candidate display button 1701 on the inspection date selection screen 1600 (S6008). On the other hand, if there is a candidate appointment date in the month preceding the month of the inspection date selection screen 1600 that is currently being displayed (no in S6007 and yes in S6010), the appointment screen generating unit 201 displays the previous month candidate display button 1801 on the inspection date selection screen 1600 (S6011). If there are no candidate appointment dates in the previous month (no in S6010), the process advances to S6009.

Next, the appointment screen generating unit 201 displays other related information on the inspection date selection screen 1600 (S6009) and advances the process to “A” in FIG. 63. In this case, related information includes screen components such as the return button 1602, the detail button 1603, and headings.

In S6301 subsequent to “A” in FIG. 63, the appointment screen generating unit 201 enters a standby state for an input of a selection operation by the user. Next, when the box 1605 corresponding to a candidate appointment date is tapped and a candidate appointment date is selected by the user (yes in S6302), the appointment screen generating unit 201 displays the inspection time selection screen 2100 on the display unit 209 (S6303). Moreover, when the candidate appointment date is selected by the user by tapping the candidate appointment time 1901 in a case where the inspection date selection screen 1600 displaying the candidate appointment time 1901 is adopted, the inspection time selection screen 2100 is displayed on which a time slot that is indicated by the tapped candidate appointment time 1901 is selected by default.

In addition, when the detail button 1603 is tapped and “detail” is selected by the user on the inspection date selection screen 1600 (no in S6302 and yes in S6304), the appointment screen generating unit 201 displays the inspection detail confirmation screen 2600 on the display unit 209 (S6305).

Furthermore, when the return button 1602 is tapped and “return” is selected by the user on the inspection date selection screen 1600 (no in S6304 and yes in S6306), the appointment screen generating unit 201 executes a display process of the symptom confirmation screen 1500 (FIG. 54) (S6307).

Next, when the candidate appointment time 1901 is tapped and a candidate appointment time is selected by the user (no in S6306 and yes in S6308), the appointment screen generating unit 201 displays the appointment content confirmation screen 2300 on the display unit 209 (S6311). S6311 is the same as S5705 in FIG. 57 and the process returns to FIG. 57. Moreover, when the inspection date selection screen 1600 displaying the candidate symbol 1606 is adopted, S6308 is omitted because the candidate appointment time 1901 is not displayed.

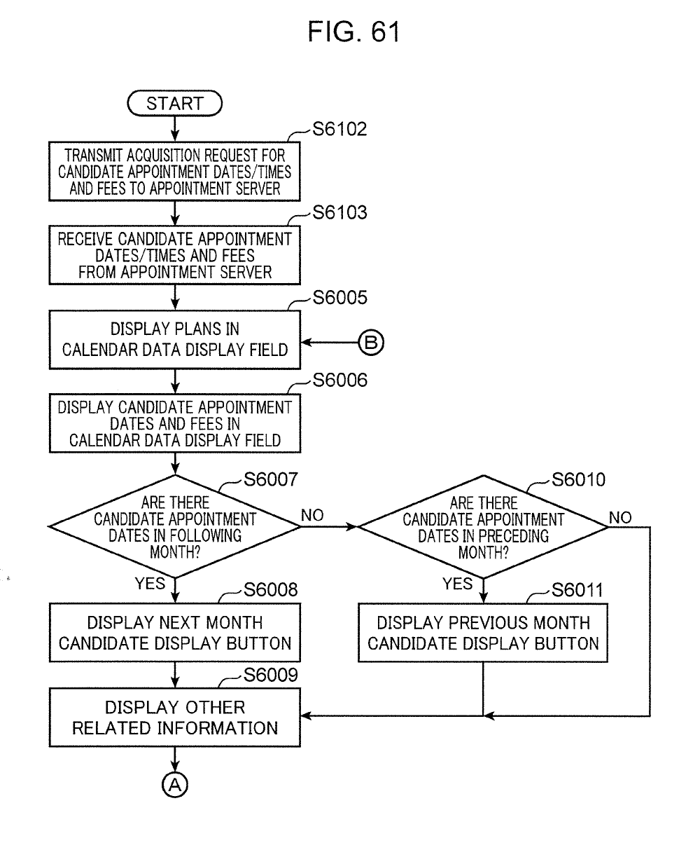

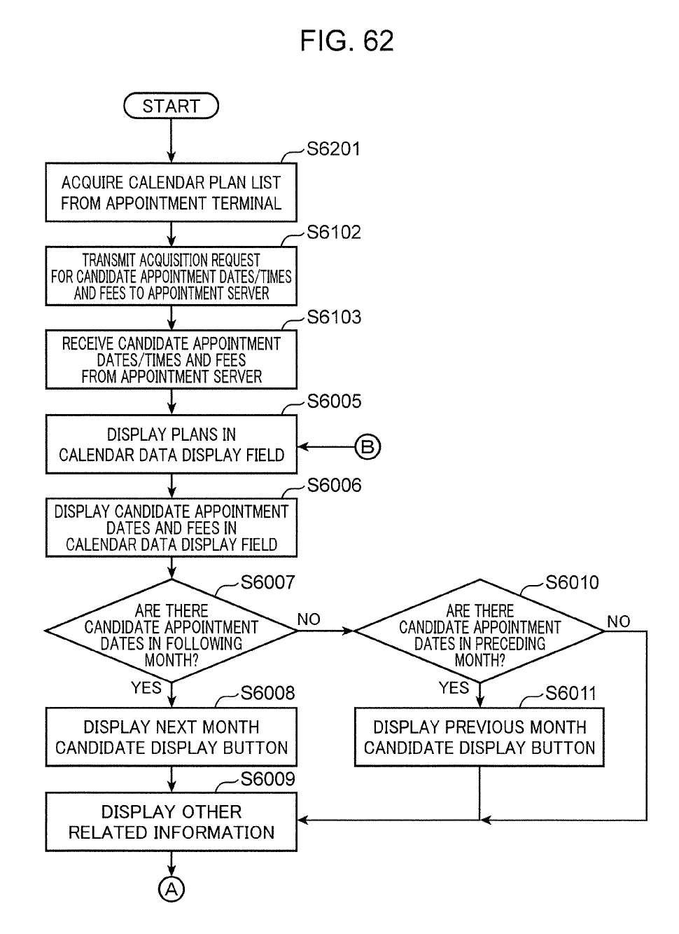

Subsequently, when the next month candidate display button 1701 is tapped (selected) (no in S6308 and yes in S6309), the process advances to “B” in FIG. 60, FIG. 61, or FIG. 62. In addition, when the previous month candidate display button 1801 is tapped (selected) (no in S6309 and yes in S6310), the process advances to “B”. On the other hand, when no operation is input by the user on the inspection date selection screen 1600 (no in S6310), the process is returned to S6301 and the standby state for a selection operation by the user is maintained.

FIG. 61 is a flow chart showing a second example of a display process of the inspection date selection screen 1600 (S5703 in FIG. 57 and S5908 in FIG. 59). This flow chart corresponds to process sequences S1-4 and S2-2 in which the appointment server 100 performs an extraction process of a candidate appointment date.

FIG. 61 differs from FIG. 60 in that processes corresponding to S6001 and S6004 in FIG. 60 have been omitted and S6102 and S6103 are provided in place of S6002 and S6003. This is due to the fact that acquisition of the calendar plan list 4000 is performed by the appointment server 100 and an extraction process of a candidate appointment date is also performed by the appointment server 100. Otherwise, FIG. 61 is the same as FIG. 60.

In S6102, the appointment screen generating unit 201 transmits an acquisition request for candidate appointment dates/times and fees to the appointment server 100.

In S6103, the appointment screen generating unit 201 receives candidate appointment dates/times and fees from the appointment server 100.

FIG. 62 is a flow chart showing a third example of a display process of the inspection date selection screen 1600 (S5703 in FIG. 57 and S5908 in FIG. 59). This flow chart corresponds to the process sequence S1-2 in which the appointment server 100 performs an extraction process of a candidate appointment date and the appointment terminal 200 manages the calendar plan list 4000.

First, the appointment screen generating unit 201 acquires the calendar plan list 4000 from the storing unit 203 (S6201). Subsequent processes are the same as in FIG. 61. However, in S6102, the appointment terminal 200 transmits the calendar plan list 4000 acquired in S6201 together with an acquisition request.

FIG. 64 is a flow chart showing a display process of the inspection appointment completion screen 2400 (S5706 in FIG. 57). First, the appointment terminal 200 transmits an appointment request to the appointment server 100 (S6401). In this case, the appointment terminal 200 transmits the appointment request as the appointment button 2306 is tapped on the appointment content confirmation screen 2300. The appointment request includes, for example, a user ID, a name of the device 300 that is an inspection object, a symptom of the device 300 that is the inspection object, and candidate appointment dates/times.

Next, the appointment server 100 receives the appointment request (S6411). Subsequently, the appointment server 100 executes a process of making an appointment (S6412). At this point, the appointment server 100 may register information such as candidate appointment dates that are included in the appointment request in association with, for example, appointment available dates/times of concern that are registered in the appointment available date list 4100. Accordingly, the candidate appointment dates/times specified by the appointment request are registered as visit dates/times in the appointment server 100.

Subsequently, the appointment server 100 transmits an appointment result to the appointment terminal 200 (S6413). In this case, the appointment result includes information such as a name of the device 300 that is an inspection object, a symptom of the device 300 that is the inspection object, and visit dates/times.

Next, the appointment terminal 200 receives the appointment result from the appointment server 100 (S6402). Subsequently, the appointment terminal 200 registers the appointment result in the calendar plan list 4000 (S6403).

In this case, when the appointment system adopts the process sequences S1-1 and S1-2, the appointment terminal 200 registers the appointment result in the calendar plan list 4000 that is managed by the appointment terminal 200 itself. In addition, when the appointment system adopts the process sequences S1-3 and S1-4, the appointment terminal 200 transmits the appointment result to the appointment server 100 and causes the appointment result to be registered in the calendar plan list 4000 that is managed by the appointment server 100. Furthermore, when the appointment system adopts the process sequences S2-1 and S2-2, the appointment terminal 200 transmits the appointment result to the calendar server 500 and causes the appointment result to be registered in the calendar plan list 4000 that is managed by the calendar server 500.

Next, the appointment terminal 200 displays the schedule icon 1607 representing a plan of the user in the calendar data display field 1604 on the inspection appointment completion screen 2400 (S6404).

Subsequently, the appointment terminal 200 displays a visit date/time for which an appointment has been made in the calendar data display field 1604 on the inspection appointment completion screen 2400 (S6405).

Next, the appointment terminal 200 displays other related information on the inspection appointment completion screen 2400 (S6406).

Subsequently, the appointment terminal 200 enters a standby state for a selection operation by the user on the inspection appointment completion screen 2400 (S6407).

Next, when the top button 2401 is tapped and “top” is selected by the user (yes in S6408), the appointment terminal 200 executes a display process of the top screen 3000 (S6409).

On the other hand, when no operation is input by the user on the inspection appointment completion screen 2400 (no in S6408), the process is returned to S6407 and the standby state is maintained.

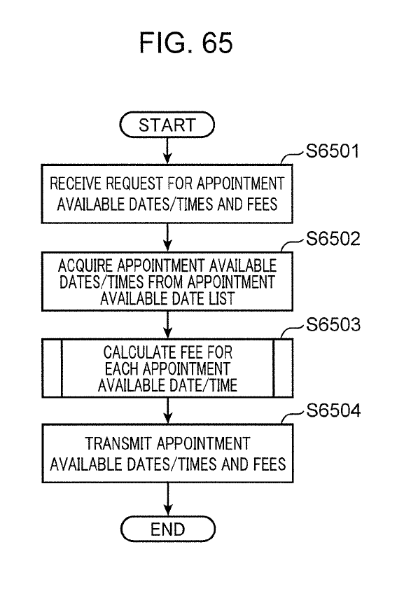

FIG. 65 is a flow chart showing a process of a first example of the appointment server 100. Moreover, this flow chart shows a process in a case where the appointment system adopts the process sequences S1-1, S1-3, and S2-1. First, the appointment server 100 receives an acquisition request for appointment available dates/times and fees from the appointment terminal 200 (S6501). Subsequently, the appointment server 100 acquires appointment available dates/times from the appointment available date list 4100 (S6502). In this case, for example, the appointment server 100 may acquire appointment available dates/times in a month including the present day and a following month among the appointment available dates/times registered in the appointment available date list 4100.

Next, the appointment server 100 calculates a fee for each of the acquired appointment available dates/times (S6503). Subsequently, the appointment server 100 transmits the appointment available dates/times and the fees to the appointment terminal 200 (S6504).

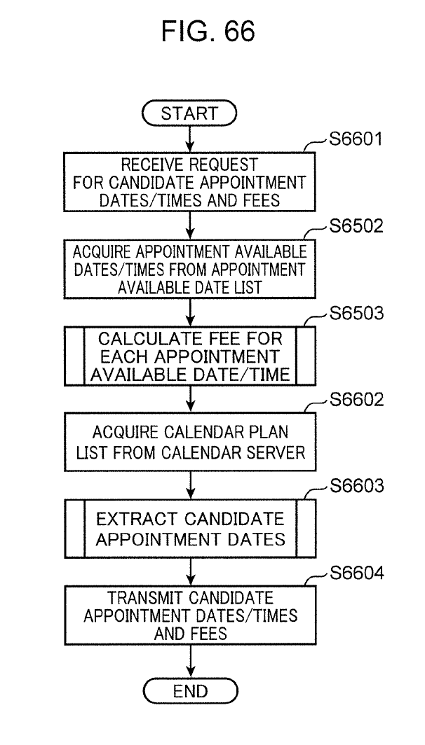

FIG. 66 is a flow chart showing a process of a second example of the appointment server 100. Moreover, this flow chart shows a process in a case where the appointment system adopts the process sequences S1-4 and S2-2. In this flow chart, the calendar plan list 4000 is managed by the calendar server 500. Therefore, a process in which the appointment server 100 acquires the calendar plan list 4000 is added in S6602. In addition, in the flow chart, an extraction process of candidate appointment dates is performed by the appointment server 100. To this end, a process of receiving an acquisition request for candidate appointment dates/times and fees is provided in S6601, an extraction process of candidate appointment dates is provided in S6603, and a process of transmitting the candidate appointment dates/times and fees is added in S6604. Otherwise, FIG. 66 is the same as FIG. 65.

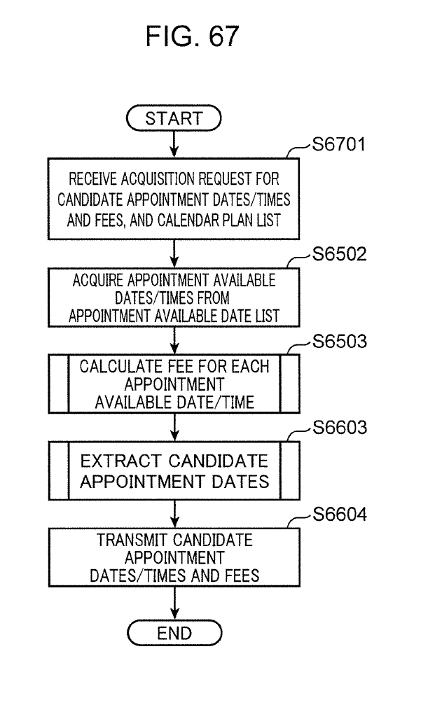

FIG. 67 is a flow chart showing a process of a third example of the appointment server 100. Moreover, this flow chart shows a process in a case where the appointment system adopts the process sequence S1-2. In this flow chart, the calendar plan list 4000 is managed by the appointment terminal 200. Therefore, in S6701, the appointment server 100 receives the calendar plan list 4000 in addition to an acquisition request for candidate appointment dates/times and fees.

In addition, in the flow chart, an extraction process of candidate appointment dates is performed by the appointment server 100. To this end, an extraction process of candidate appointment dates is provided in S6603 and a transmission process of the candidate appointment dates/times and fees is provided in S6604. Otherwise, FIG. 67 is the same as FIG. 65.

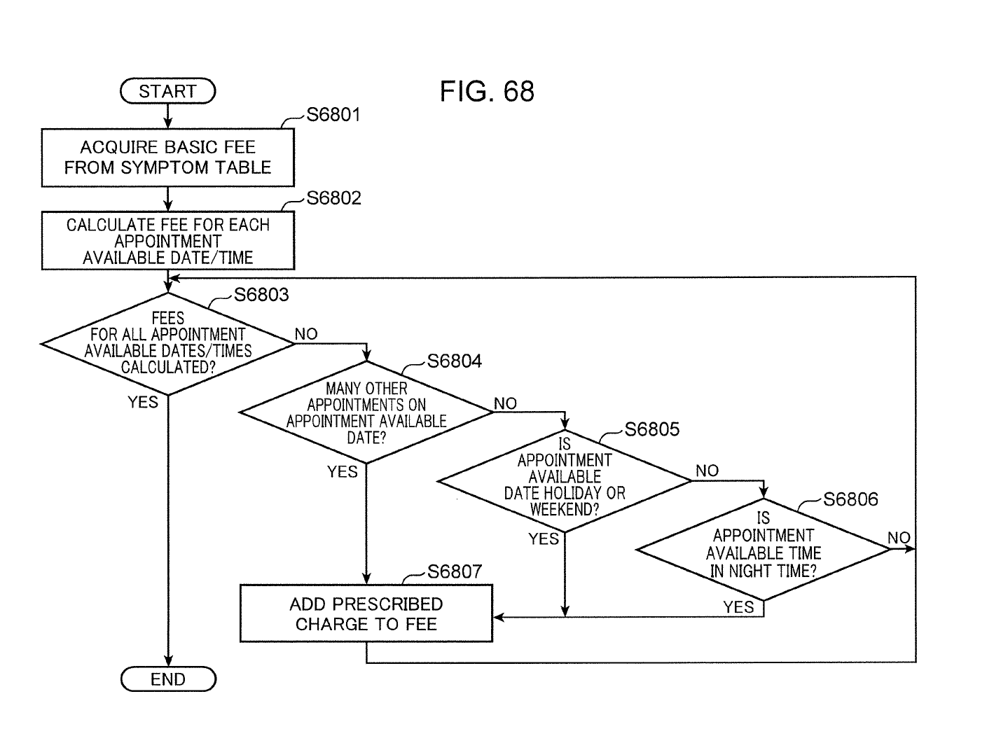

FIG. 68 is a flow chart showing an example of a process of calculating a fee for each appointment available date/time in S6503. First, the appointment server 100 acquires a basic fee with respect to each inspection from the symptom table 3900 (S6801). Next, the appointment server 100 calculates a fee for each appointment available date/time using the acquired basic fee (S6802). At this point, a basic fee is calculated for each of the respective appointment available dates/times acquired in S6502.

Next, when the calculation of fees with respect to all appointment available dates/times is completed (yes in S6803), the appointment server 100 ends the process. On the other hand, when the calculation of fees with respect to all appointment available dates/times is not completed (no in S6803), the appointment server 100 decides an appointment available date/time to be a fee calculation object and determines whether or not there is a large number of other appointments on an appointment available date to which the decided appointment available date/time belongs (S6804). At this point, when the number of appointments on the appointment available date of concern is equal to or larger than a specified value, the appointment server 100 may make a determination of yes in S6804, and when the number of appointments is smaller than the specified value, the appointment server 100 may make a determination of no in S6804.

In S6805, a determination is made on whether or not the appointment available date of concern corresponds to a holiday or a weekend. In this case, for example, a Sunday or a public holiday is adopted as the holiday. In addition, for example, a Saturday is adopted as the weekend.

The appointment server 100 makes a determination of yes in S6805 when the appointment available date of concern is a holiday or a weekend and makes a determination of no in S6805 when the appointment available date of concern is not a holiday or a weekend. When a determination of no is made in S6805, the process advances to S6806.

In S6806, a determination is made on whether or not the appointment available date/time of concern is in the night time (S6806). When the appointment available date/time of concern is in the night time (yes in S6806), the process is advanced to S6807, and when the appointment available date/time of concern is not in the night time (no in S6806), the process is returned to S6803. In addition, in S6803, a next appointment available date/time is decided as a fee calculation object and subsequent processes are to be performed. In this case, for example, 18:00 and thereafter or 19:00 and thereafter correspond to the night time.

In S6807, the appointment server 100 adds a prescribed charge to the fee calculated in S6802 with respect to the appointment available date/time of concern and returns the process to S6803. In this case, for example, the appointment server 100 may add addition values respectively determined in advance for each of a case where yes is determined in S6804, a case where yes is determined in S6805, and a case where yes is determined in S6806 to the fee calculated in S6802.

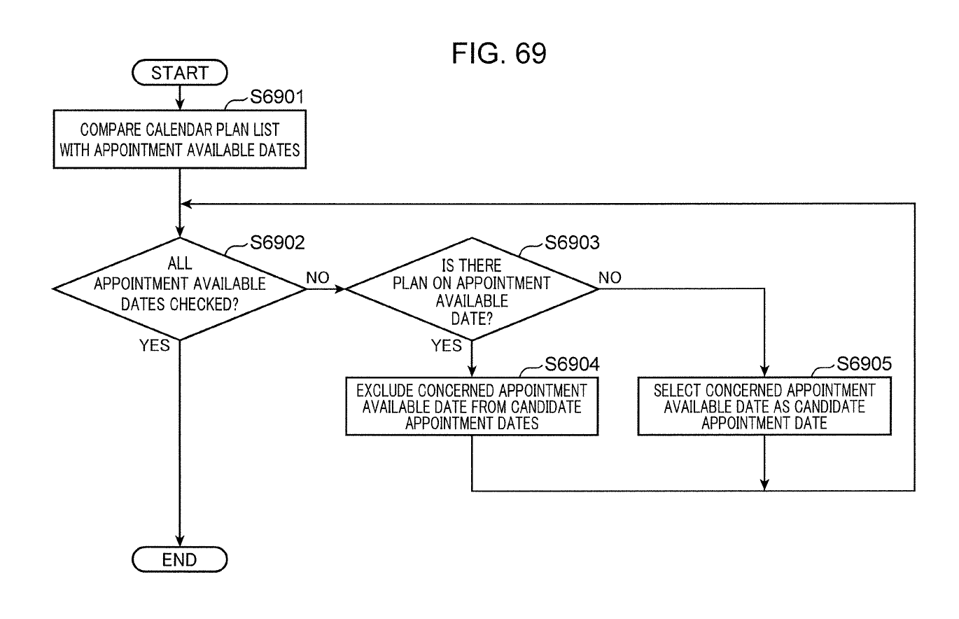

FIG. 69 is a flow chart showing a first example of an extraction process of a candidate appointment date by the appointment server 100 or the appointment terminal 200. A processing entity of the flow chart is the candidate appointment date selecting unit 106 when the process is executed by the appointment server 100 and the candidate appointment date selecting unit 202 when the process is executed by the appointment terminal 200.

First, the calendar plan list 4000 and appointment available dates are compared with each other (S6901). In this case, appointment available dates refer to the appointment available dates to which the appointment available dates/times acquired in S6003 or S6502 belong.

When all appointment available dates are checked (yes in S6902), the process is ended, and when all appointment available dates are not checked (no in S6902), the process advances to S6903.

In S6903, a determination is made on whether or not there is a plan of the user on an appointment available date. When there is a plan of the user (yes in S6903), the appointment available date of concern is excluded from candidate appointment dates (S6904) and the process is returned to S6902. In S6902, a next appointment available date is decided as a processing object.

When there are no plans of the user on the appointment available date (no in S6903), the appointment available date of concern is selected as a candidate appointment date (S6905) and the process is returned to S6902.

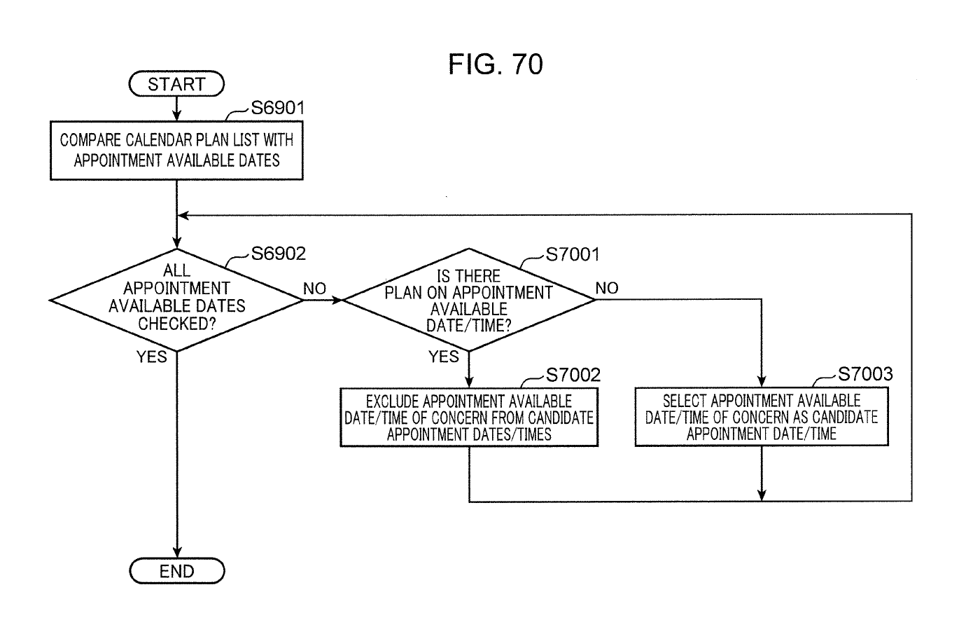

FIG. 70 is a flow chart showing a second example of the extraction process of a candidate appointment date by the appointment server 100 or the appointment terminal 200.

In the extraction process of a candidate appointment date according to the second example, S7001, S7002, and S7003 are provided in place of S6903, S6904, and S6905 in FIG. 69. In S7001, a determination is made on whether or not there is a plan of the user on an appointment available date/time belonging to the appointment available date. When there is a plan of the user on an appointment available date/time (yes in S7001), the appointment available date/time of concern is excluded from the candidate appointment dates/times (S7002). On the other hand, when there are no plans of the user on the appointment available date/time (no in S7001), the appointment available date/time of concern is selected as a candidate appointment date/time (S7003) and the process is returned to S6902.

In other words, in S7001 to S7003, even when there is a plan of the user on an appointment available date, as long as an appointment available date/time does not overlap with a time slot that includes a plan of the user, the appointment available date/time is extracted as a candidate appointment date/time.

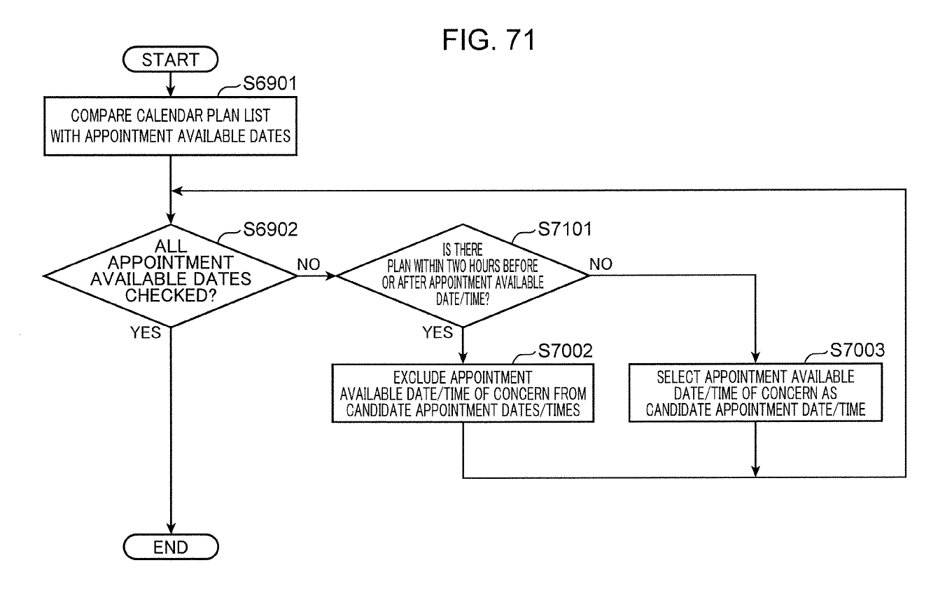

FIG. 71 is a flow chart showing a third example of the extraction process of a candidate appointment date by the appointment server 100 or the appointment terminal 200. In the extraction process of a candidate appointment date according to the third example, S7101 is provided in place of S7001 in FIG. 70.

In S7101, a determination is made on whether or not there is a plan of the user within two hours before or after an appointment available date/time. When there is a plan of the user within two hours before or after an appointment available date/time, a determination of yes is made in S7101 and the process advances to S7002. On the other hand, when there are no plans of the user within two hours before or after an appointment available date/time, a determination of no is made in S7101 and the process advances to S7003.

In other words, in S7101, a candidate appointment date/time is selected by providing the plans of the user with a margin. In this case, for example, assuming that a start time of an appointment available date/time is 13:00 and an end time thereof is 14:00, the two hours from 11:00 to 13:00 and the two hours from 14:00 to 16:00 correspond to the two hours before or after the appointment available date/time.

While two preceding or subsequent hours have been adopted in this case, alternatively, a value set in advance by the appointment system may be adopted or a preferred value set by the user may be adopted.

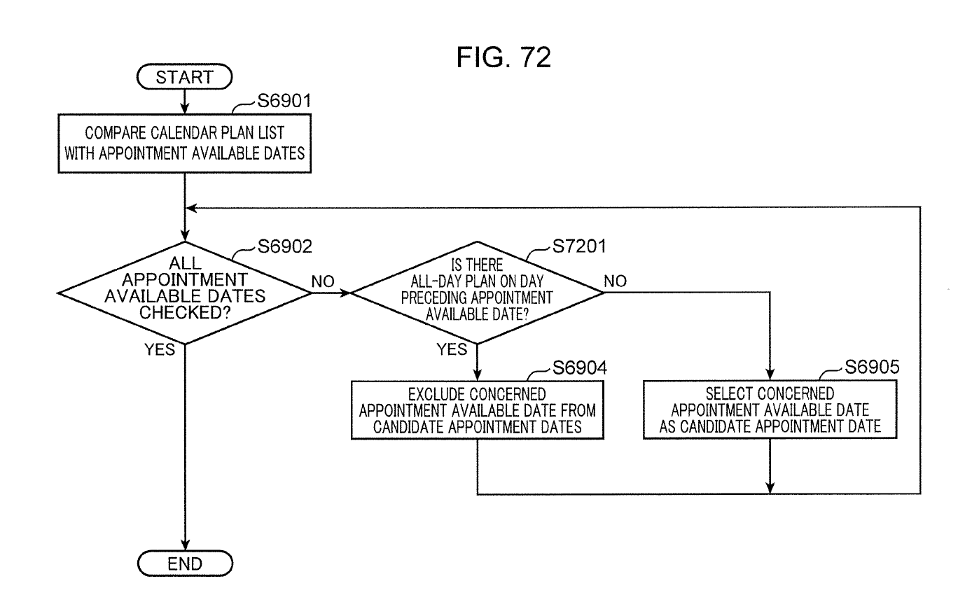

FIG. 72 is a flow chart showing a fourth example of the extraction process of a candidate appointment date by the appointment server 100 or the appointment terminal 200. In the extraction process of a candidate appointment date according to the fourth example, S7201 is provided in place of S6903 in FIG. 69.

In S7201, a determination is made on whether or not there is an all-day plan on the day preceding an appointment available date. When there is an all-day plan on the day preceding the appointment available date, a determination of yes is made in S7201 and the process advances to S6904. On the other hand, when there is no all-day plan on the day preceding the appointment available date, a determination of no is made in S7201 and the process advances to S6905.

In this case, for example, a plan whose time slot is from 0:00 to 24:00 and which extends over a plurality of days such as a trip corresponds to an all-day plan. When there is an all-day plan on the previous day, the user may still feel tired on the following day. It is unlikely that the user would select such a day as a visit date. Therefore, in the present example, such dates that are unlikely to be selected as a visit date of the user are excluded from candidate appointment dates.

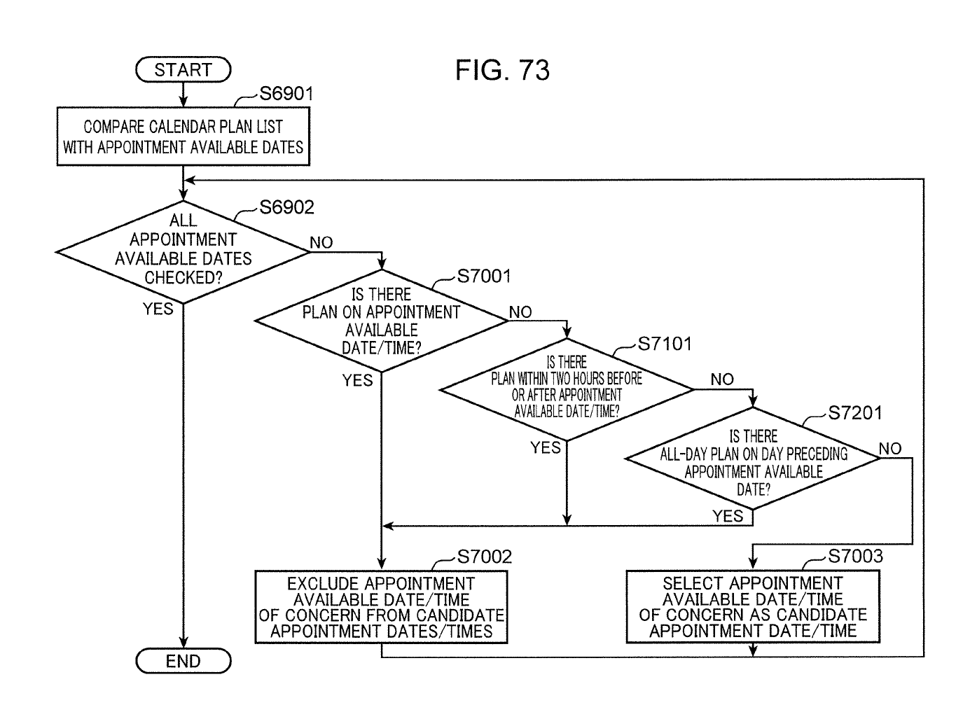

FIG. 73 is a flow chart showing a fifth example of the extraction process of a candidate appointment date by the appointment server 100 or the appointment terminal 200. In the extraction process of a candidate appointment date according to the fifth example, S7101 and S7201 are added to FIG. 70. In other words, the fifth example combines the second to fourth examples.

First, in S7001, a determination is made on whether or not there is a plan on an appointment available date/time. When there are no plans (no in S7001), the process advances to S7101, and when there is a plan (yes in S7001), the process advances to S7002. In S7101, a determination is made on whether or not there is a plan within two hours before or after the appointment available date/time. When there are no plans (no in S7101), the process advances to S7201, and when there is a plan (yes in S7101), the process advances to S7002. In S7201, a determination is made on whether or not there is an all-day plan on the day preceding the appointment available date. When there are no plans (no in S7201), the process advances to S7003, and when there is a plan (yes in S7201), the process advances to S7002.

### INDUSTRIAL APPLICABILITY

The present disclosure is useful in a cloud system that manages plans of a user and appointment available dates of a service person.

1. A method for controlling a communication device which includes a display and which is connectable to an information management system that makes, via a network, a visit appointment with a service person who performs maintenance or an inspection of an electric appliance,
the communication device storing schedule information of a user of the communication device,
the method causing a computer of the communication device to:
display display data which is generated using the stored schedule information and which includes a calendar representing each day on a per month or per week basis, on the display;
access the information management system via the network to acquire candidate data indicating possible visit dates/times of the service person from the information management system, for a visit appointment with the service person;
determine candidate visit dates/times of the service person by excluding dates/times on which plans of the user are included in the schedule information, from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;
display each display representing each of the determined candidate visit times within each region corresponding to each day in the calendar; and
when selection of one region which corresponds to one candidate visit time is detected in the calendar, display on the display an appointment screen which sets one candidate visit date/time as a visit date/time of the service person.

2. The method according to claim 1, further causing the computer of the communication device to:
transmit an appointment request indicating the one candidate visit date/time to the information management system via the network based on the appointment screen, to register the one candidate visit date/time as the visit date/time of the service person in the information management system.

3. The method according to claim 2, further causing the computer of the communication device to:
display in the calendar the visit date/time of the service person for which the registration in the information management system has been completed.

4. The method according to claim 2, further causing the computer of the communication device to:
display on the display information indicating that the registration has been completed, in association with a display of the calendar.

5. The method according to claim 1, wherein
the information management system collects and manages log information of the electric appliance associated with the user of the communication device via the network, and
when the information management system determines that the maintenance or the inspection is required for the electric appliance based on the log information, the computer of the communication device is caused to receive a notice indicating that the maintenance or the inspection is required for the electric appliance, from the information management system via the network.

6. The method according to claim 1, wherein
the information management system collects and manages log information of the electric appliance associated with the user of the communication device via the network, and
in a case which the information management system receives an inquiry signal for the visit appointment with the service person from the communication device, the computer of the communication device is caused to receive, from the information management system via the network, state information which indicates whether or not the maintenance or the inspection is required for the electric appliance based on the log information, and to display the state information on the display.

7. The method according to claim 1, wherein
when, using the display data including the calendar that represents each day of a concerned month, displaying each display representing each of the candidate visit times of the service person within each corresponding region in the calendar, and
when the display representing the candidate visit times are included in respective displays of the concerned month and a following month,
the computer of the communication device is caused to display information indicating that the display representing the candidate visit times is displayed in a region corresponding to any of the days included in the display of the following month, in the display data that includes calendar representing each day of the concerned month.

8. The method according to claim 1, wherein
when, using the display data including the calendar that represents each day of a concerned week, displaying each display representing each of the candidate visit times of the service person within each corresponding region in the calendar, and
when the display representing the candidate visit times are included in respective displays of the concerned week and a following week,
the computer of the communication device is caused to display information indicating that the display representing the candidate visit times is displayed in a region corresponding to any of the days included in the display of the following week, in the display data that includes calendar representing each day of the concerned week.

9. The method according to claim 1, further causing the computer of the communication device to:
display a first region corresponding to a first day which is represented in the calendar and which includes a plan of the user, in a first display color; and
display a second region corresponding to a second day which is represented in the calendar and which includes a display representing the candidate visit times of the service person, in a second display color that differs from the first display color.

10. The method according to claim 1, further causing the computer of the communication device to, when displaying each display representing each of the candidate visit times within each region corresponding to each day in the calendar, display each fee related to the maintenance or the inspection of the electric appliance within each region corresponding to each day in the calendar.

11. The method according to claim 1, further causing the computer of the communication device to, when all of the displays representing candidate visit times corresponding to a given day cannot not be displayed in a region corresponding to the given day, display a mark indicating one candidate visit date of the service person in the region corresponding to the given day, without displaying all of the displays representing the candidate visit times corresponding to the given day.

12. The method according to claim 1, wherein
each of the plans of the user is displayed within each region corresponding to each day in the calendar.

13. A non-transitory computer-readable recording medium which stores a program to be executed by a communication device which includes a display and which is connectable to an information management system that makes, via a network, a visit appointment with a service person who performs maintenance or an inspection of an electric appliance,
the communication device storing schedule information of a user of the communication device,
the program causing a computer of the communication device to:
display display data which is generated using the stored schedule information and which includes a calendar representing each day on a per month or per week basis, on the display;
access the information management system via the network to acquire candidate data indicating possible visit dates/times of the service person from the information management system, for a visit appointment with the service person;
determine candidate visit dates/times of the service person by excluding dates/times on which plans of the user are included in the schedule information, from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;
display each display representing each of the determined candidate visit times within each region corresponding to each day in the calendar; and
when selection of one region which corresponds to one candidate visit time is detected in the calendar, display on the display an appointment screen which sets one candidate visit date/time as a visit date/time of the service person.

14. A method of providing information in an information management system that makes, via a network, a visit appointment with a service person who performs maintenance or an inspection of an electric appliance, the method comprising:
receiving, from a communication device of an authenticated user via the network, i) an inquiry signal for making an appointment for a visit by the service person and ii) schedule information of the user, the schedule information of the user being stored in the communication device;
acquiring, based on the inquiry signal, first candidate data indicating possible visit dates/times of the service person from a database that stores the possible visit dates/times of the service person;
determining candidate visit dates/times of the service person by excluding dates/times on which plans of the user are included in the schedule information, from the acquired possible visit dates/times of the service person using the acquired first candidate data and the received schedule information, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;
transmitting second candidate data indicating the determined candidate visit dates/times to the communication device via the network, to display at the communication device display each display representing each of candidate visit times indicated by the second candidate data within each region corresponding to each day in calendar; and
when selection of one region which corresponds to one candidate visit time is detected in a region corresponding to any of days in the calendar in the communication device and when an appointment request indicating a selected candidate visit date/time is received from the communication device via the network, registering the selected candidate visit date/time indicated by the appointment request in the information management system as a visit date/time of the service person.

15. The method according to claim 14, wherein
the visit date/time of the service person for which registration in the information management system has been completed is displayed within the calendar, at the communication device.

16. The method according to claim 14, wherein
the information management system collects and manages log information of the electric appliance associated with the user of the communication device via the network, and
when the information management system determines that the maintenance or the inspection is required for the electric appliance based on the log information, the information management system transmits to the communication device via the network a notice indicating that the maintenance or the inspection is required for the electric appliance.

17. The method according to claim 14, wherein
the information management system collects and manages log information of the electric appliance associated with the user of the communication device via the network, and
in a case which the information management system receives an inquiry signal for making the visit appointment with the service person from the communication device, the information management system transmits to the communication device via the network state information which indicates whether or not the maintenance or the inspection is required for the electric appliance based on the log information.

18. A method for controlling a communication device which includes a display and which is connectable to an information management system that makes, via a network, a visit appointment with a service person who performs maintenance or an inspection of an electric appliance,
the information management system managing schedule information of a user of the communication device,
the method causing a computer of the communication device to:
access the information management system via the network to acquire i) schedule information of the user of the communication device and ii) candidate data indicating possible visit dates/times of the service person from the information management system for a visit appointment with the service person;
display display data which is generated using the received schedule information and which includes calendar representing each day on a per month or per week basis, on the display;
determining candidate visit dates/times of the service person by excluding dates/times on which plans of the user are included in the schedule information from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;
display each display representing each of the candidate visit dates/times within each region corresponding to each day in the calendar; and
when selection of one region which corresponds to one candidate visit time is detected in the calendar, display on the display an appointment screen which sets one candidate visit date/time as a visit date/time of the service person.

19. The method according to claim 18, further causing the computer of the communication device to:
transmit an appointment request indicating the one candidate visit date/time to the information management system via the network based on the appointment screen, to register the one candidate visit date/time as the visit date/time of the service person in the information management system.

20. The method according to claim 18, further causing the computer of the communication device to:
display in the calendar the visit date/time of the service person for which the registration in the information management system has been completed, within the one region corresponding to the visit dates/times.

21. The method according to claim 18, further causing the computer of the communication device to:
display on the display information indicating that the registration has been completed, in association with a display of the calendar.

22. The method according to claim 18, wherein
the information management system collects and manages log information of the electric appliances associated with the user of the communication device via the network, and
when the information management system determines that the maintenance or the inspection is required for the electric appliance based on the log information, the computer of the communication device is caused to receive a notice indicating that the maintenance or the inspection is required for the electric appliance, from the information management system via the network.

23. The method according to claim 18, further causing the computer of the communication device to, when all of the displays representing candidate visit times corresponding to a given day cannot not be displayed in a region corresponding to the given day, display a mark indicating one candidate visit date of the service person in the region corresponding to the given day, without displaying all of the displays representing the candidate visit times corresponding to the given day.

24. The method according to claim 18, wherein
each of the plans of the user is displayed with in each region corresponding to each day in the calendar.

25. A non-transitory computer-readable recording medium which stores a program to be executed by a communication device which includes a display and connectable to an information management system that makes, via a network, a visit appointment with a service person who performs maintenance or an inspection of an electric appliance,
the information management system managing schedule information of a user of the communication device,
the program causing a computer of the communication device to:
access the information management system via the network to acquire i) schedule information of the user of the communication device and ii) candidate data indicating possible visit dates/times of the service person from the information management system for a visit appointment with the service person;
display display data which is generated using the received schedule information and which includes calendar representing each day on a per month or per week basis, on the display;
determining candidate visit dates/times of the service person by excluding dates/times on which plans of the user are included in the schedule information from the acquired possible visit dates/times of the service person, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;
display each display representing each of the candidate visit dates/times within each region corresponding to each day in the calendar; and
when selection of one region which corresponds to one candidate visit time is detected in the calendar, display on the display an appointment screen which sets one candidate visit date/time as a visit date/time of the service person.

26. A method of providing information in an information management system that makes, via a network, a visit appointment with a service person who performs maintenance or an inspection of an electric appliance, the method comprising:
receiving, from a communication device of an authenticated user via the network, an inquiry signal for making an appointment for a visit by the service person;
acquiring, based on the inquiry signal, schedule information of the user of the communication device from a first database that stores the schedule information of the user of the communication device;
acquiring, based on the inquiry signal, first candidate data indicating possible visit dates/times of the service person from a second database that stores the possible visit dates/times of the service person;
determining candidate visit dates/times of the service person by excluding dates/times on which plans of the user are included in the acquired schedule information from the acquired possible visit dates/times of the service person using the acquired schedule information and the first candidate data, wherein, when an interval between i) one of the acquired possible visit date/times of the service person and ii) the date/time on which the plan of the user is included in the schedule information is shorter than a specified value, the one of the acquired possible visit date/time is excluded from the determined candidate visit dates/times of the service person;
transmitting second candidate data indicating the determined candidate visit dates/times to the communication device via the network, to display at the communication device each display representing each of the candidate visit times indicated by the second candidate data within each region corresponding to each day in calendar; and
when selection of one region which corresponds to one candidate visit time is detected in a region corresponding to any of days included in the calendar in the communication device and an appointment request indicating a selected candidate visit date/time is received from the communication device via the network, registering the selected candidate visit date/time indicated by the appointment request in the information management system as a visit date/time of the service person.

27. The method according to claim 26, wherein
the visit date/time of the service person for which registration in the information management system has been completed is displayed within the calendar at the communication device.

28. The method according to claim 26, wherein
the information management system collects and manages log information of the electric appliance associated with the user of the communication device via the network, and
when the information management system determines that any the maintenance or the inspection is required for the electric appliance based on the log information, the information management system transmits to communication device via the network a notice indicating the maintenance or the inspection is required for the electric appliance.

29. The method according to claim 26, wherein
the information management system collects and manages log information of the electric appliance associated with the user of the communication device via the network, and
in a case which the information management system receives an inquiry signal for making a visit appointment with the service person from the communication device, the information management system transmits to the communication device via the network state information which indicates whether or not the maintenance or the inspection is required for the electric appliance based on the log information.
